(19) United States
(12) Patent Application Publication
(10) Pub. No.: US 2004/0043790 A1
(43) Pub. Date: Mar. 4, 2004

(54) Selectable functionality communication systems and methodologies

(75) Inventors: Amihay Ben-David, Tel Aviv (IL); Roni Raviv, Nes - Ziona (IL); Ehud Moshe Levy, Tel Aviv (IL); Douglas York Malawsky, Ramat Gan (IL)

Correspondence Address: Ladas & Parry, 26 West 61 Street, New York, NY, 10023, US

(73) Assignee: KI-BI MOBILE TECHNOLOGIES LTD

(21) Appl. No.: 10/367,603

(22) Filed: Feb. 14, 2003

(30) Foreign Application Priority Data
Sep. 2, 2002 (IL) 151573

(51) Int. Cl. H04M 1/00

(52) U.S. Cl. 455/558

(57) ABSTRACT

A user-interface card for use with an interactive communications device, the user-interface card including a plurality of user-actuable contact locations, a plurality of information modules selectably accessible in response to actuation by a user of the plurality of user-actuable contact locations and a communications interface providing communication of the information modules to the interactive communications device in response to the actuation and a system including a user-selectable function operative device and the user-interface card.

### FIELD OF THE INVENTION

The present invention relates to selectable functionality mobile communication systems generally and to user interfaces and user interface cards for use therein.

### BACKGROUND OF THE INVENTION

The following U.S. patents and published U.S. patent applications are believed to represent the current state of the art:

U.S. Pat. Nos. 6,434,648 and 6,037,933;

Published U.S. patent applications Ser. Nos. 09/860,660; 09/725,713; 09/773,091; 09/908,213 and 10/087,098.

### SUMMARY OF THE INVENTION

The present invention seeks to provide an improved selectable functionality mobile communication system, user interfaces and user interface cards for use therein.

There is thus provided in accordance with a preferred embodiment of the present invention a user-interface card for use with an interactive communications device, the user-interface card including a plurality of user-actuable contact locations, a plurality of information modules selectably accessible in response to actuation by a user of the plurality of user-actuable contact locations and a communications interface providing communication of the information modules to the interactive communications device in response to the actuation.

There is also provided in accordance with another preferred embodiment of the present invention a user-interface subsystem for use with an interactive communications device, the user-interface subsystem including a user-interface card including a plurality of user-actuable contact locations, a plurality of information modules selectably accessible in response to actuation by a user of the plurality of user-actuable contact locations and a communications interface providing communication of the information modules to the interactive communications device in response to the actuation and a user-interface card intermediary operative to communicate with the communications interface of the user-interface card and with the interactive communications device.

There is further provided in accordance with yet another preferred embodiment of the present invention a physical hyperlink system including a user-selectable function operative device and a user-interface card including a plurality of user-actuable contact locations, a plurality of information modules selectably accessible in response to actuation by a user of the plurality of user-actuable contact locations and a communications interface providing communication of the information modules to the user-selectable function operative device in response to the actuation.

In accordance with another preferred embodiment of the present invention, the communications interface includes a plurality of ports. Additionally, a first one of the plurality of ports communicates contact location actuation data and a second one of the plurality of ports communicates information module data.

Preferably, the user-interface card also includes a contact location actuation data processor which provides information module selection inputs operative to cause communication of selected information modules via the communications interface. Additionally or alternatively, the user-interface card also includes contact location actuation feedback functionality operative to provide feedback to the user in response to the actuation of at least one of the plurality of user-actuable contact locations. Preferably, the contact location actuation feedback functionality includes tactile feedback functionality associated with at least some of the plurality of user-actuable contact locations.

In accordance with yet another preferred embodiment of the present invention the user-interface card also includes at least one visually sensible information module indicator associated with each of the plurality of user-actuable contact locations.

Preferably, the plurality of information modules includes at least one information string. Alternatively, the plurality of information modules includes video content. In accordance with another preferred embodiment the plurality of information modules includes audio content. Additionally or alternatively, the plurality of information modules includes computer programs. Preferably, the plurality of information modules includes games. In accordance with still another preferred embodiment the plurality of information modules includes entertainment content. Alternatively, the plurality of information modules includes security information. In accordance with yet another preferred embodiment the plurality of information modules includes gaming programs. In accordance with another preferred embodiment the plurality of information modules includes a message. In accordance with still another preferred embodiment the plurality of information modules includes transactional information. Additionally, the plurality of information modules includes a request to be sent by a mobile device to a remote server to download information from the server. Alternatively, the plurality of information modules includes mobile commerce data.

In accordance with another preferred embodiment of the present invention the user-interface card does not contain a source of electrical power.

In accordance with yet another preferred embodiment of the present invention the user-interface card also includes user actuable programming functionality. Alternatively, the user-interface card also includes user actuable personalization functionality.

In accordance with still another preferred embodiment of the present invention the user-interface card also includes functionality which limits the number of times at least one of a plurality of information modules are accessible in response to user actuation of a corresponding at least one of the plurality of user-actuable contact locations. Additionally, the user-interface card also includes functionality which changes information modules which are accessible in response to user actuation of at least one of the plurality of user-actuable contact locations. Alternatively, the user-interface card also includes functionality which changes the content of at least one of the plurality of information modules in response to user actuation of at least one of the plurality of user-actuable contact locations.

In accordance with yet another preferred embodiment of the present invention the device is a television set-top box. Additionally, the communications interface providing communication in response to the actuation also provides communication to another interactive communications device operating as a back-channel communicator.

In accordance with another preferred embodiment of the present invention the intermediary includes an information module receiver operative to receive the information modules from the user-interface card and an information module transmitter operative to transmit received information modules to the device. Additionally, the intermediary also includes an information module processor for processing at least some of the received information modules.

In accordance with still another preferred embodiment of the present invention the intermediary includes an information receiver operative to receive information from the device and an information transmitter operative to transmit received information to the user-interface card. Additionally, the user-interface card intermediary also includes an information processor for processing at least some of the received information.

In accordance with yet another preferred embodiment of the present invention the intermediary includes at least one wireless communications link. Additionally or alternatively, the intermediary includes a plurality of intermediary ports. Preferably, a first one of the plurality of intermediary ports communicates contact location actuation data and a second one of the plurality of intermediary ports communicates information module data. Additionally, the at least one wireless link interconnects the intermediary and the device.

In accordance with still another preferred embodiment of the present invention the physical hyperlink system also includes an intermediary for communicating with the user-interface card and with the user-selectable function operative device.

Preferably, the user-selectable function operative device is operative in response to user actuation of at least one of the plurality of user-actuable contact locations on the user-interface card to cause information to be downloaded to the user-selectable function operative device. Additionally, the information to be downloaded is downloaded from the user-interface card. Alternatively, the information to be downloaded is downloaded from an external information source.

In accordance with a preferred embodiment of the present invention the user-selectable function operative device includes a communicator. Alternatively, the user-selectable function operative device includes a game device. In accordance with still another preferred embodiment of the present invention the user-selectable function operative device includes a television and associated set-top box. Alternatively, the user-selectable function operative device includes a communicator connected to a communications network.

There is still further provided in accordance with still another preferred embodiment of the present invention a selectable functionality mobile communication system including a function actuation card, a function actuation card/mobile device intermediary and a function selectable mobile device, the function actuation card containing at least one audio-visual information module which interacts with at least one of the intermediary and the mobile device.

There is also provided in accordance with yet another preferred embodiment of the present invention a selectable functionality mobile communication system including a function actuation card, a function actuation card/mobile device intermediary and a function selectable mobile device, the function actuation card containing at least one information module which interacts with at least one of the intermediary and the mobile device and causes the at least one of the intermediary and the mobile device to download information from an external source.

There is even further provided in accordance with still another preferred embodiment of the present invention a selectable functionality mobile communication system including a function actuation card, a function actuation card/mobile device intermediary and a television set-top box, the function actuation card containing at least one information module which interacts with at least one of the intermediary and the set-top box and causes the at least one of the intermediary and the set-top box to download information from an external source.

Preferably, the function actuation card includes a plurality of user-actuable contact locations, a plurality of information modules selectably accessible in response to actuation by a user of the plurality of user-actuable contact locations and a communications interface providing communication of the information modules to the function selectable mobile device in response to the actuation.

In accordance with another preferred embodiment of the present invention, the intermediary and the mobile device communicate with each other in a wireless manner. Additionally or alternatively, the intermediary and the mobile device communicate with each other in a bi-directional communications manner.

In accordance with still another preferred embodiment of the present invention the at least one information module is modifiable through communication between the function actuation card and at least one of the intermediary and the mobile device.

Preferably, the intermediary includes a user interface. In accordance with a preferred embodiment the user interface includes selection buttons. Alternatively or additionally, the user interface includes a ringer. Additionally or alternatively, the user interface includes an LED.

In accordance with another preferred embodiment of the present invention the intermediary includes an information module receiver operative to receive the information modules from the function actuation card and an information module transmitter operative to transmit received information modules to the function selectable mobile device. Additionally, the intermediary also includes an information module processor for processing at least some of the received information modules.

In accordance with still another preferred embodiment of the present invention the intermediary includes an information receiver operative to receive information from the function selectable mobile device and an information transmitter operative to transmit received information to the function actuation card. Additionally, the user-interface card intermediary also includes an information processor for processing at least some of the received information.

In accordance with another preferred embodiment of the present invention, the communications interface includes a plurality of ports. Additionally, a first one of the plurality of ports communicates contact location actuation data and a second one of the plurality of ports communicates information module data.

Preferably, the function actuation card also includes a contact location actuation data processor which provides information module selection inputs operative to cause communication of selected information modules via the communications interface. Additionally or alternatively, the function actuation card also includes contact location actuation feedback functionality operative to provide feedback to the user in response to the actuation of at least one of the plurality of user-actuable contact locations. Preferably, the contact location actuation feedback functionality includes tactile feedback functionality associated with at least some of the plurality of user-actuable contact locations.

In accordance with yet another preferred embodiment of the present invention the function actuation card also includes at least one visually sensible information module indicator associated with each of the plurality of user-actuable contact locations.

Preferably, the plurality of information modules includes at least one information string. Alternatively, the plurality of information modules includes video content. In accordance with another preferred embodiment the plurality of information modules includes audio content. Additionally or alternatively, the plurality of information modules includes computer programs. Preferably, the plurality of information modules includes games. In accordance with still another preferred embodiment the plurality of information modules includes entertainment content. Alternatively, the plurality of information modules includes security information. In accordance with yet another preferred embodiment the plurality of information modules includes gaming programs. In accordance with another preferred embodiment the plurality of information modules includes a message. In accordance with still another preferred embodiment the plurality of information modules includes transactional information. Additionally, the plurality of information modules includes a request to be sent by a mobile device to a remote server to download information from the server. Alternatively, the plurality of information modules includes mobile commerce data.

In accordance with a preferred embodiment of the present invention the function actuation card does not contain a source of electrical power. Alternatively, the function actuation card contains at least one information module providing electrical power.

In accordance with yet another preferred embodiment of the present invention the function actuation card also includes user actuable programming functionality. Alternatively, the function actuation card also includes user actuable personalization functionality.

In accordance with yet another preferred embodiment of the present invention the intermediary includes at least one wireless communications link. Additionally or alternatively, the intermediary includes a plurality of intermediary ports. Preferably, a first one of the plurality of intermediary ports communicates contact location actuation data and a second one of the plurality of intermediary ports communicates information module data. Additionally, the at least one wireless link interconnects the intermediary and the function selectable mobile device.

In accordance with still another preferred embodiment of the present invention the function actuation card also includes functionality which limits the number of times at least one of a plurality of information modules are accessible in response to user actuation of a corresponding at least one of the plurality of user-actuable contact locations. Additionally, the function actuation card also includes functionality which changes information modules which are accessible in response to user actuation of at least one of the plurality of user-actuable contact locations. Alternatively, the function actuation card also includes functionality which changes the content of at least one of the plurality of information modules in response to user actuation of at least one of the plurality of user-actuable contact locations.

In accordance with another preferred embodiment of the present invention the function actuation card contains at least one information module actuating functionality of the mobile device. Alternatively or additionally, the function actuation card contains at least one information module providing a mobile device ring tone.

In accordance with yet another preferred embodiment of the present invention the function actuation card also contains at least one information module which interacts with a communications device providing back-channel functionality in association with the set-top box.

There is further provided in accordance with another preferred embodiment of the present invention a communication method including providing a user-selectable function operative device and a user-interface card including a plurality of user-actuable contact locations and a plurality of information modules, actuating, by user selection, at least one of the plurality of user-actuable contact locations and communicating at least one of the plurality of information modules from the user interface card to the user-selectable function operative device.

There is even further provided in accordance with still another preferred embodiment of the present invention a selectable functionality mobile communication method including providing a function selectable mobile device, a function actuation card/mobile device intermediary and a function actuation card containing at least one audio-visual information module and communicating information from the at least one audio-visual information module to at least one of the intermediary and the mobile device.

There is still further provided in accordance with yet another preferred embodiment of the present invention a selectable functionality mobile communication method including providing a function selectable mobile device, a function actuation card/mobile device intermediary and a function actuation card containing at least one information module, communicating information from the at least one information module to at least one of the intermediary and the mobile device; and downloading information from an external source to the at least one of the intermediary and the mobile device, in response to the communicating.

There is yet further provided in accordance with still another preferred embodiment of the present invention a selectable functionality mobile communication method including providing a television set-top box, a function actuation card/mobile device intermediary and a function actuation card containing at least one information module, communicating information from the at least one information module to at least one of the intermediary and the set-top box and downloading information from an external source to the at least one of the intermediary and the set-top box, in response to the communicating.

In accordance with another preferred embodiment of the present invention the communication method also includes communicating information between the card and the device. Additionally or alternatively, the method also includes downloading information to the device. Preferably, the downloading includes downloading information from the card. Additionally or alternatively, the downloading includes downloading information from an external information source.

In accordance with yet another preferred embodiment of the present invention the communicating includes receiving the at least one of the plurality of information modules from the user-interface card and transmitting received information modules to the user-selectable function operative device. Additionally, the communicating also includes processing at least some of the received information modules.

In accordance with still another preferred embodiment of the present invention the communicating information includes receiving information from the user-selectable function operative device and transmitting received information to the user-interface card. Additionally, the communicating information also includes processing at least some of the received information.

In accordance with another preferred embodiment of the present invention the communicating includes communicating contact location actuation data and communicating information module data.

Preferably, the method also includes providing feedback to a user in response to the actuating. Additionally, the providing feedback includes providing tactile feedback.

In accordance with yet another preferred embodiment of the present invention the communicating includes communicating via a wireless communications link.

In accordance with still another preferred embodiment the method also includes limiting the number of times at least one of the plurality of information modules are accessible in response to user actuation of a corresponding at least one of the plurality of user-actuable contact locations. Additionally or alternatively, the method also includes changing information modules which are accessible in response to the actuating. Additionally or alternatively, the method also includes changing the content of at least one of the plurality of information modules in response to the actuating.

In accordance with another preferred embodiment of the present invention the communicating also includes communicating to another user-selectable function operating device operating as a back-channel communicator.

In accordance with another preferred embodiment of the present invention the communicating also includes communicating to a user-selectable function operating device operating as a back-channel communicator.

### BRIEF DESCRIPTION OF THE DRAWINGS

The present invention will be understood and appreciated more fully from the following detailed description, taken in conjunction with the drawings in which:

FIGS. 1A, 1B, 1C and 1D are, taken together, a simplified pictorial illustration of operation of a selectable functionality mobile communication system constructed and operative in accordance with a preferred embodiment of the present invention;

FIGS. 2A and 2B are, taken together, a simplified pictorial illustration of operation of a selectable functionality mobile communication system constructed and operative in accordance with another preferred embodiment of the present invention;

FIGS. 3A, 3B and 3C are, taken together, a simplified pictorial illustration of operation of a selectable functionality mobile communication system constructed and operative in accordance with yet another preferred embodiment of the present invention;

FIGS. 4A, 4B, 4C, 4D and 4E are, taken together, a simplified pictorial illustration of operation of a selectable functionality mobile communication system constructed and operative in accordance with still another preferred embodiment of the present invention;

FIGS. 5A, 5B and 5C are, taken together, a simplified pictorial illustration of operation of a selectable functionality mobile communication system constructed and operative in accordance with yet another preferred embodiment of the present invention;

FIGS. 6A and 6B are, taken together, a simplified pictorial illustration of operation of a selectable functionality mobile communication system constructed and operative in accordance with still another preferred embodiment of the present invention;

FIGS. 7A, 7B and 7C are, taken together, a simplified pictorial illustration of operation of a selectable functionality mobile communication system constructed and operative in accordance with yet another preferred embodiment of the present invention;

FIGS. 8A and 8B are, taken together, a simplified pictorial illustration of operation of a selectable functionality mobile communication system constructed and operative in accordance with still another preferred embodiment of the present invention;

FIGS. 9A, 9B, 9C and 9D are, taken together, a simplified pictorial illustration of operation of a selectable functionality mobile communication system constructed and operative in accordance with still another preferred embodiment of the present invention;

FIGS. 10A, 10B, 10C, 10D and 10E are, taken together, a simplified pictorial illustration of operation of a selectable functionality mobile communication system constructed and operative in accordance with still another preferred embodiment of the present invention;

FIGS. 11A, 11B and 11C are, taken together, a simplified generalized information flow diagram illustration of operation of the selectable functionality mobile communication system of FIGS. 1A-1D;

FIG. 12 is a simplified generalized information flow diagram illustration of operation of the selectable functionality mobile communication system of FIGS. 2A and 2B;

FIGS. 13A and 13B are, taken together, a simplified generalized information flow diagram illustration of operation of the selectable functionality mobile communication system of FIGS. 3A-3C;

FIGS. 14A, 14B and 14C are, taken together, a simplified generalized information flow diagram illustration of operation of the selectable functionality mobile communication system of FIGS. 4A-4E;

FIGS. 15A and 15B are, taken together, a simplified generalized information flow diagram illustration of operation of the selectable functionality mobile communication system of FIGS. 5A-5C;

FIGS. 16A and 16B are, taken together, a simplified generalized information flow diagram illustration of operation of the selectable functionality mobile communication system of FIGS. 6A and 6B;

FIGS. 17A and 17B are, taken together, a simplified generalized information flow diagram illustration of operation of the selectable functionality mobile communication system of FIGS. 7A-7C;

FIG. 18 is a simplified generalized information flow diagram illustration of operation of the selectable functionality mobile communication system of FIGS. 8A 8B; 8B;

FIGS. 19A and 19B are, taken together, a simplified generalized information flow diagram illustration of operation of the selectable functionality mobile communication system of FIGS. 9A-9D;

FIGS. 20A, 20B and 20C are, taken together, a simplified generalized information flow diagram illustration of operation of the selectable functionality mobile communication system of FIGS. 10A-10E;

FIGS. 21A and 21B are, taken together, a simplified generalized functional block diagram illustration of operation of the selectable functionality mobile communication system of FIGS. 1A-1D;

FIG. 22 is a simplified generalized functional block diagram illustration of operation of the selectable functionality mobile communication system of FIGS. 2A and 2B;

FIG. 23 is a simplified generalized functional block diagram illustration of operation of the selectable functionality mobile communication system of FIGS. 3A-3C;

FIGS. 24A, 24B and 24C are, taken together, a simplified generalized functional block diagram illustration of operation of the selectable functionality mobile communication system of FIGS. 4A-4E;

FIGS. 25A and 25B are, taken together, a simplified generalized functional block diagram illustration of operation of the selectable functionality mobile communication system of FIGS. 5A-5C;

FIG. 26 is a simplified generalized functional block diagram illustration of operation of the selectable functionality mobile communication system of FIGS. 6A and 6B;

FIGS. 27 is a simplified generalized functional block diagram illustration of operation of the selectable functionality mobile communication system of FIGS. 7A-7C;

FIG. 28 is a simplified generalized functional block diagram illustration of operation of the selectable functionality mobile communication system of FIGS. 8A-8B;

FIGS. 29A and 29B are, taken together, a simplified generalized functional block diagram illustration of operation of the selectable functionality mobile communication system of FIGS. 9A-9D;

FIGS. 30A, 30B and 30C are, taken together, a simplified generalized functional block diagram illustration of operation of the selectable functionality mobile communication system of FIGS. 10A-10E;

FIG. 31 is a simplified illustration of a user interface card constructed and operative in accordance with a preferred embodiment of the present invention.

FIG. 32 is an exploded view illustrating four layers of the interface card of FIG. 31;

FIG. 33 is a diagram illustrating the organization of information in the card of FIGS. 31 & 32;

FIG. 34 is a simplified illustration of a user-interface card intermediary constructed and operative in accordance with a preferred embodiment of the present invention;

FIG. 35 is an exploded view illustrating the user-interface card intermediary of FIG. 34 in association with the interface card of FIGS. 31 and 32;

FIGS. 36A, 36B, 36C, 36D, 36E and 36F are drawings of the electrical circuitry in the card of FIGS. 31 & 32 and the intermediary of FIGS. 34 & 35; and

FIG. 37 is a simplified flow chart illustrating the functionality of software incorporated in the circuitry of FIGS. 36A-36F.

### DETAILED DESCRIPTION OF PREFERRED EMBODIMENTS

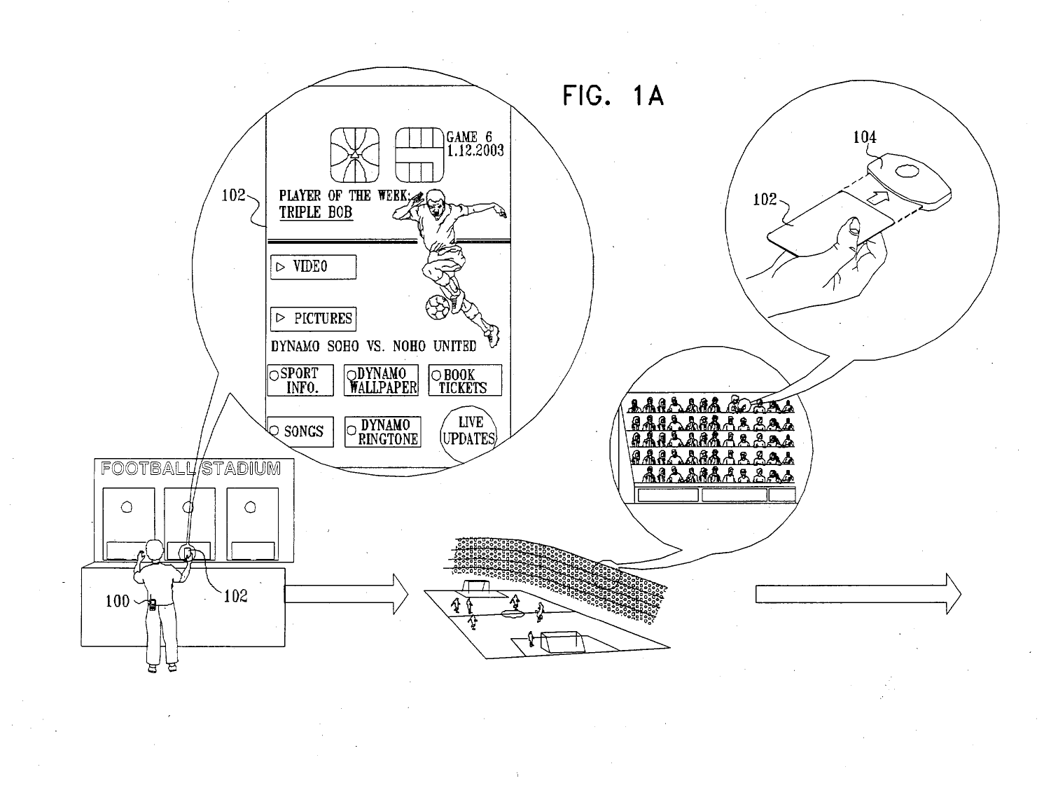

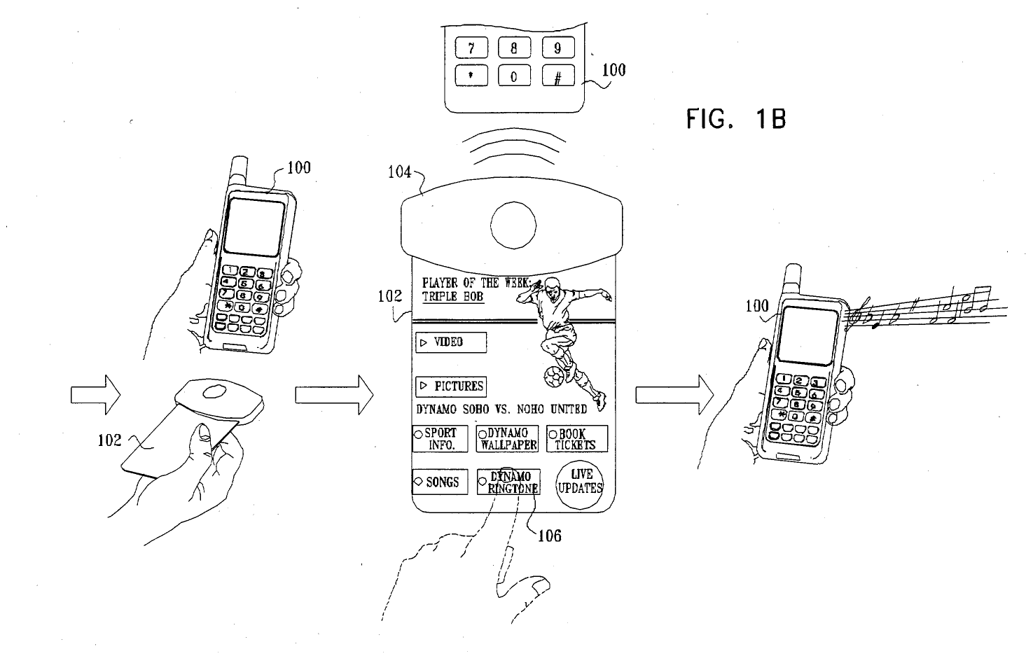

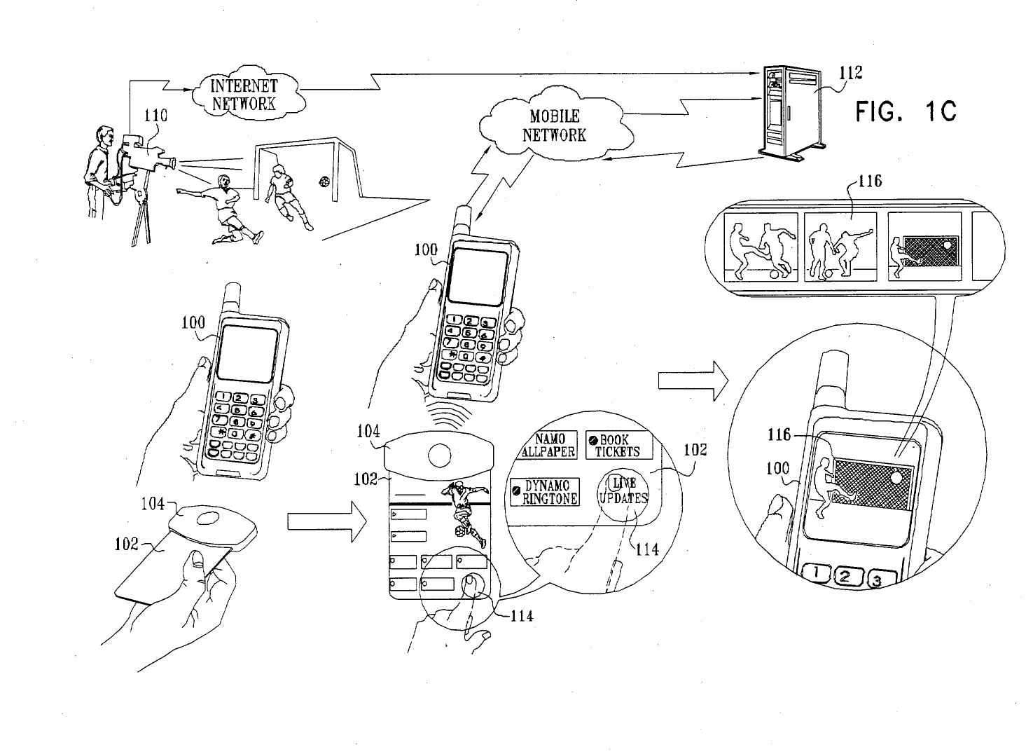

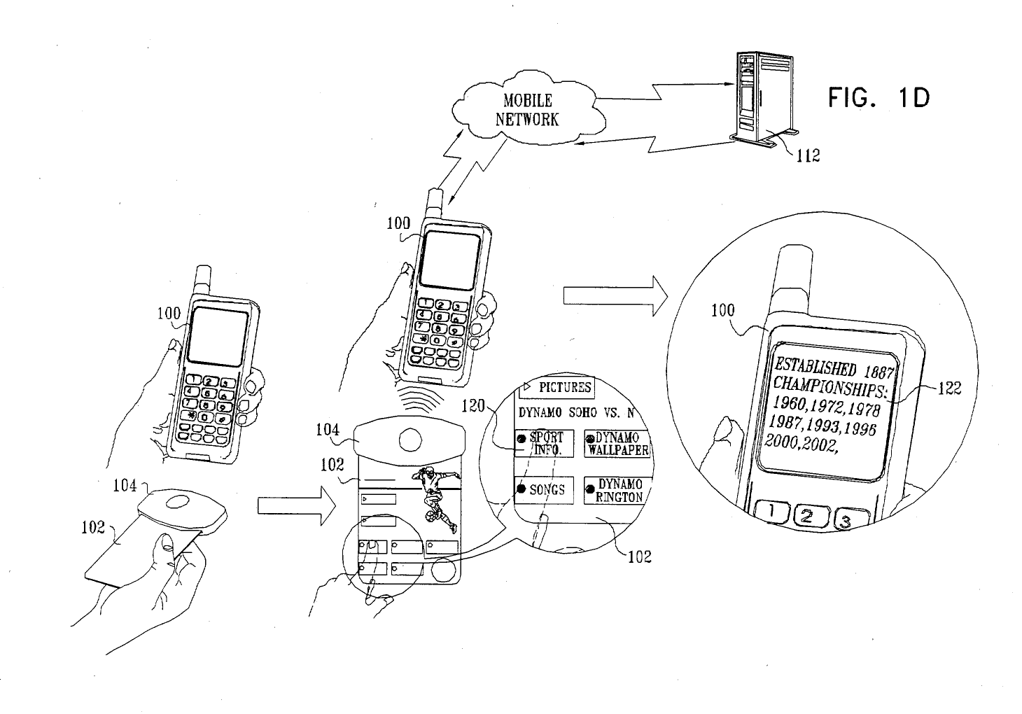

Reference is now made to FIGS. 1A, 1B, 1C and 1D, which are, taken together, a simplified pictorial illustration of operation of a selectable functionality mobile communication system constructed and operative in accordance with a preferred embodiment of the present invention. As seen in FIG. 1A, a typical scenario begins with a sports fan, carrying a mobile telephone 100, purchasing a mobile communication system user interface card 102, at a ticket window or other retail outlet.

Although the illustrated embodiments show a generally rectangular, two-dimensional, user interface card 102, it is appreciated that the user interface card 102 may be of any shape, such as circular or a geometrically irregular shape, such as a beverage bottle or car. It is further appreciated that the user interface cards described in all of the embodiments contained hereinbelow may also be of any shape.

At any appropriate time thereafter, such as during a game, while seated in the stands, the sports fan may insert the card 102 into an interface card/mobile telephone communication facilitator 104, a suitably equipped computer or mobile communicator, or any other suitable user-interface card intermediary. The sports fan may employ the card 102 and the facilitator 104 in one of a number of different functional contexts, three examples of which are described hereinbelow with reference to FIGS. 1B, 1C and 1D respectively.

Turning to FIG. 1B, it is seen that the sports fan, or any other user, may upload a selected ring tone onto his telephone 100 by pressing on a “RINGTONE” button 106 on card 102, causing a ring tone information module to be communicated from card 102 to or through facilitator 104 and enabling facilitator 104 to communicate the ring tone to the telephone 100, typically in a wireless manner, as shown, in order to enable playing of the ring tone. In the illustrated embodiment, IR communication is employed, it being understood that any other suitable type of communication between the card 102 and the telephone 100 may be employed.

FIG. 1C shows use of the card 102, the facilitator 104 and the telephone 100 to download a real-time video clip of sports action to the sport fan's telephone. The sports action is photographed, typically in real time, by a camera 110, such as a webcam, and is transmitted, typically via the Internet, to a server 112. The sports fan presses on a “LIVE UPDATES” button 114 on card 102, typically causing an information module containing a live update request to be communicated from card 102 to or through facilitator 104 and enabling facilitator 104 to communicate the request to the telephone 100. The telephone 100, in turn, communicates, via a mobile network, with server 112 and obtains the requested live update, which is displayed on the telephone 100, as designated by reference number 116.

Turning to FIG. 1D, it is seen that card 102, facilitator 104 and telephone 100 may be employed to download sports information to the sport fan's telephone. The sports information may be stored in server 112 in a real-time accessible manner. The sports fan presses on a “SPORTS INFO” button 120 on card 102, typically causing an information module containing a sports information request to be communicated from card 102 to or through facilitator 104 and enabling facilitator 104 to communicate the request to the telephone 100. The telephone 100, in turn, communicates, via a mobile network, with server 112 and obtains the requested sports information, which is displayed on the telephone 100, as designated by reference number 122.

It is noted that in an environment wherein an external server is involved, such as in the embodiments of FIGS. 1C and 1D and other embodiments described hereinbelow, the interaction with the server may be employed additionally to effect payment for functionalities actuated via the function actuation card of the present invention. Thus, for example, in such an environment, the card could be distributed for free or a nominal cost and some or all of the user actuable functionalities could be billable through a network-based billing system, preferably a mobile operator or television satellite or cable operator billing system.

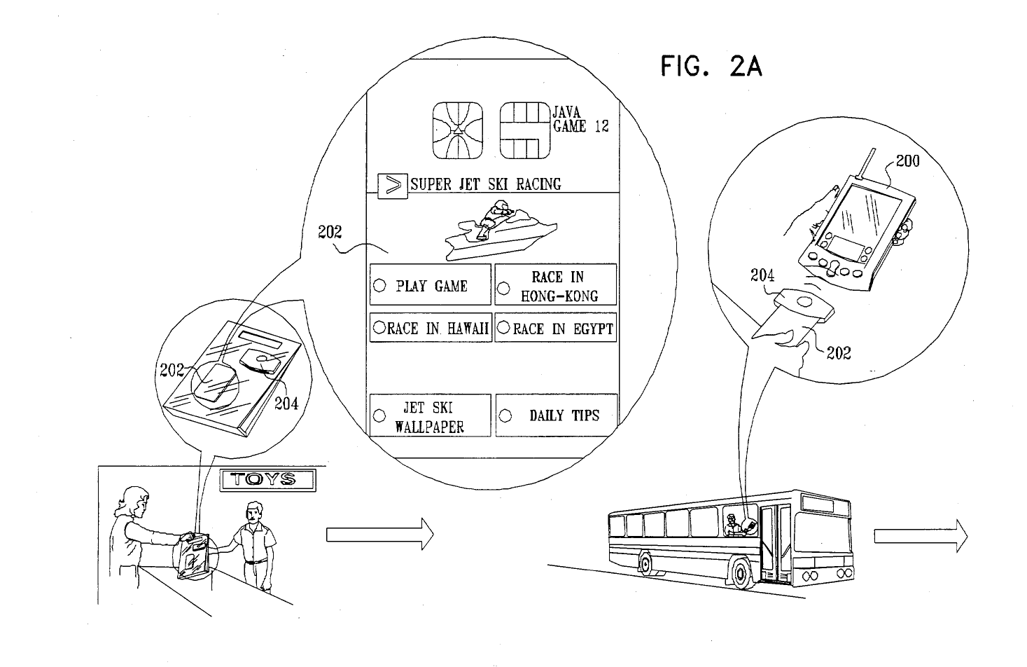

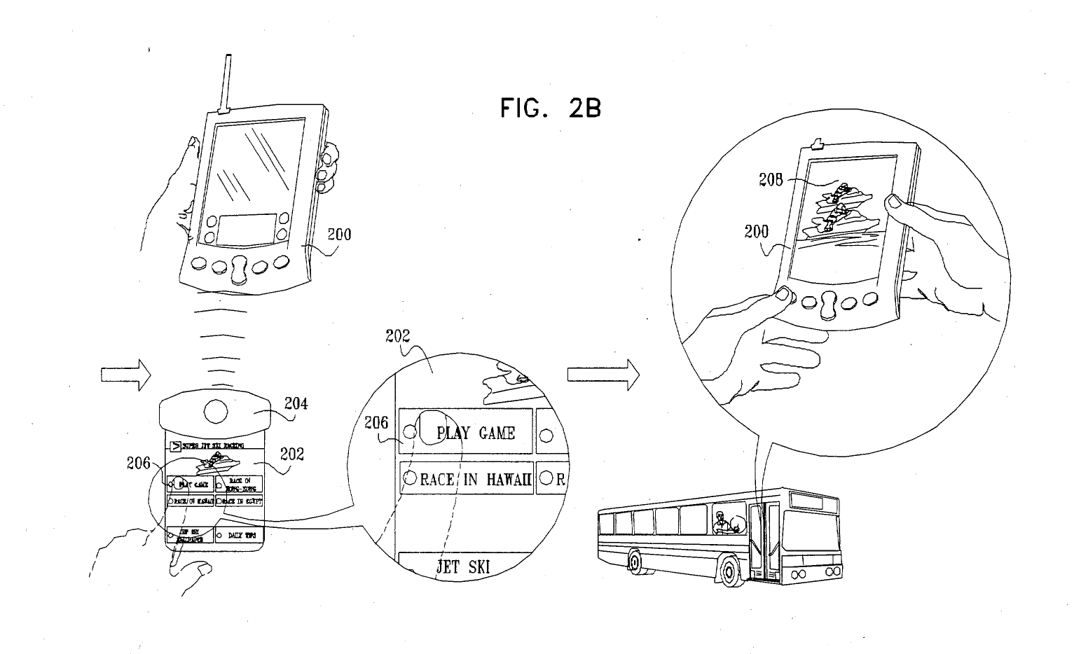

Reference is now made to FIGS. 2A and 2B, which are, taken together, a simplified pictorial illustration of operation of a selectable functionality mobile communication system constructed and operative in accordance with a preferred embodiment of the present invention. As seen in FIG. 2A, a typical scenario begins with a child purchasing a mobile communication system kit for use with a PDA (Personal Digital Assistant) 200, which kit preferably includes a user interface card 202 and an interface card/mobile telephone communication facilitator 204 or any other suitable user-interface card intermediary at a toy shop or other retail outlet.

At any appropriate time thereafter, such as during a bus ride, the child may insert the card 202 into an interface card/mobile telephone communication facilitator 204 or any other suitable user-interface card intermediary. The child may employ the card 202 and the facilitator 204 to communicate with his PDA 200 in a number of different functional contexts, one of which is described hereinbelow with reference to FIG. 2B.

Turning to FIG. 2B, it is seen that the child, or any other user, may upload a selected game onto his PDA 200 by pressing on a “PLAY GAME” button 206 on card 202, causing a game information module to be communicated from card 202 to or through facilitator 204 and enabling facilitator 204 to communicate the request to the PDA 200, typically in a wireless manner, as shown, in order to play the requested game. In the illustrated embodiment, RF communication, or more specifically, a BlueTooth wireless data communication system is employed, it being understood that any other suitable type of communication between the card 202 and the PDA 200 may be employed. The requested game is played on the PDA screen, as designated by reference number 208.

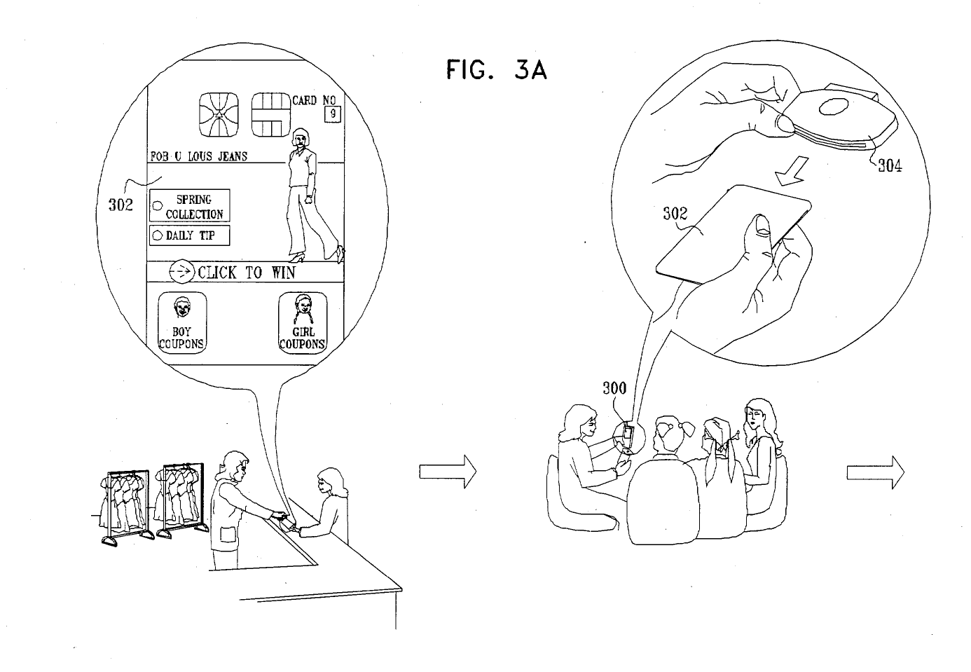

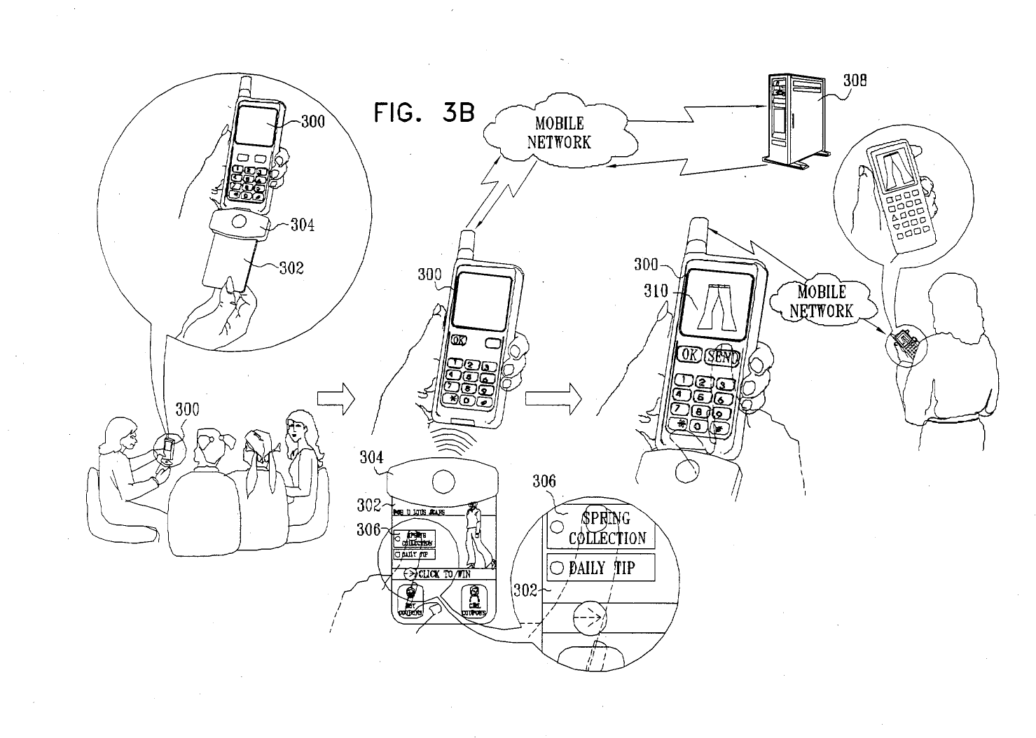

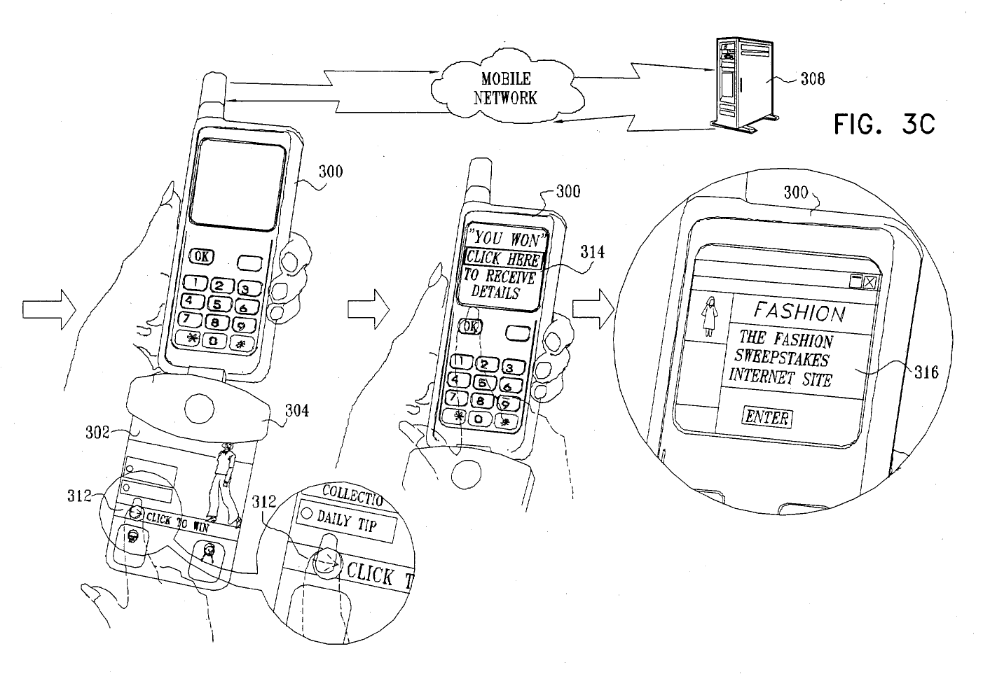

Reference is now made to FIGS. 3A, 3B and 3C which are, taken together, a simplified pictorial illustration of operation of a selectable functionality mobile communication system constructed and operative in accordance with yet another preferred embodiment of the present invention. As seen in FIG. 3A, a typical scenario begins with a teenage girl purchasing a mobile communication system user interface card 302 at a clothing store or other retail outlet for use with a mobile telephone 300.

At any appropriate time thereafter, such as during a get-together with girlfriends, the teenage girl may insert the card 302 into an interface card/mobile telephone communication facilitator 304 or any other suitable user-interface card intermediary to upload a selected feature onto her telephone 300. The teenage girl may employ the card 302 and the facilitator 304 in one of a number of different functional contexts, two examples of which are described hereinbelow with reference to FIGS. 3B and 3C respectively.

In FIG. 3B, it is seen that the teenage girl, or any other user, may view a selected display of fashion apparel, such as an item from the latest spring collection, on her telephone 300 by pressing on a “SPRING COLLECTION” button 306 on the card 302, causing a “SPRING COLLECTION” request information module to be communicated from the card 302 to or through the facilitator 304 and enabling the facilitator 304 to communicate the “SPRING COLLECTION” request to the telephone 300. The telephone 300, in turn, communicates, via a mobile network, with a server 308 and obtains a requested spring collection image, which is displayed on the telephone 300, as designated by reference number 310. As seen in FIG. 3B, the image 310 may then be transmitted via a mobile network, to another user for display, for example, on their mobile telephone.

Turning to FIG. 3C, it is seen that the card 302, the facilitator 304 and the telephone 300 may be employed to enter a fashion sweepstakes and link up to the fashion sweepstakes internet site. The sweepstakes internet site is linked to a server 308. The teenage girl presses on a “CLICK TO WIN” button 312 on the card 302, typically causing an information module containing a “CLICK TO WIN” request to be communicated from the card 302 to or through the facilitator 304 and enables the facilitator 304 to communicate the request to the telephone 300. The telephone 300, in turn, communicates, via a mobile network, with the server 308 and obtains the fashion sweepstakes entry response, which is displayed on the telephone 300 screen, as designated by reference number 314 and enables further browsing of the fashion sweepstakes internet site as displayed on the telephone 300 screen, designated by reference number 316.

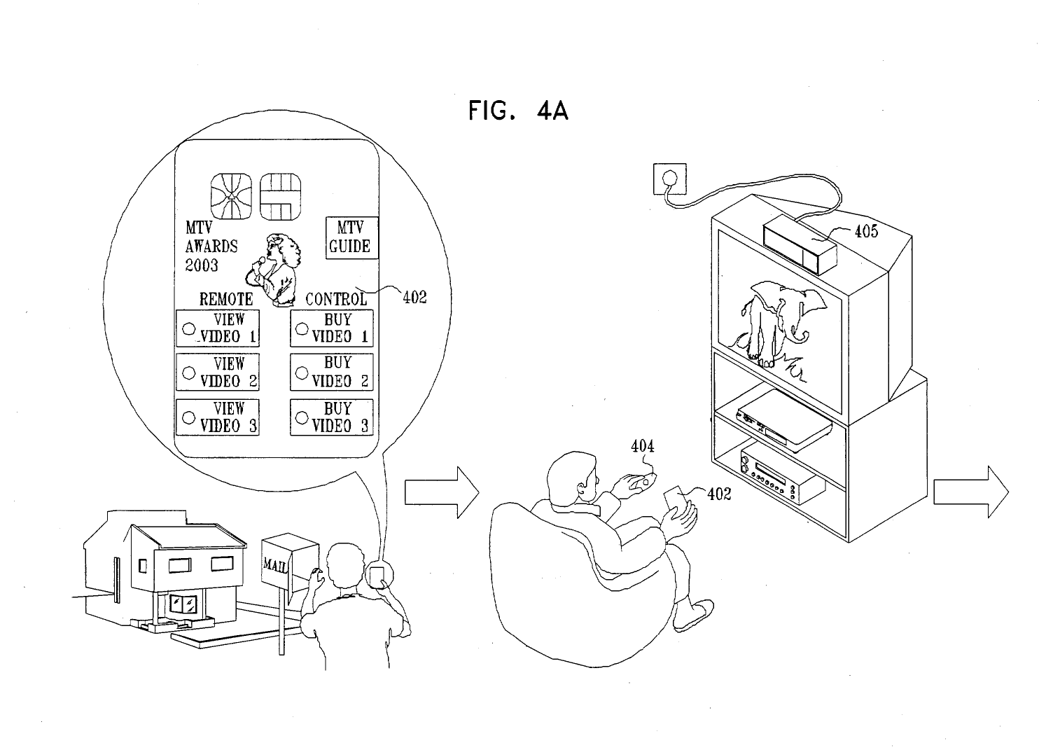

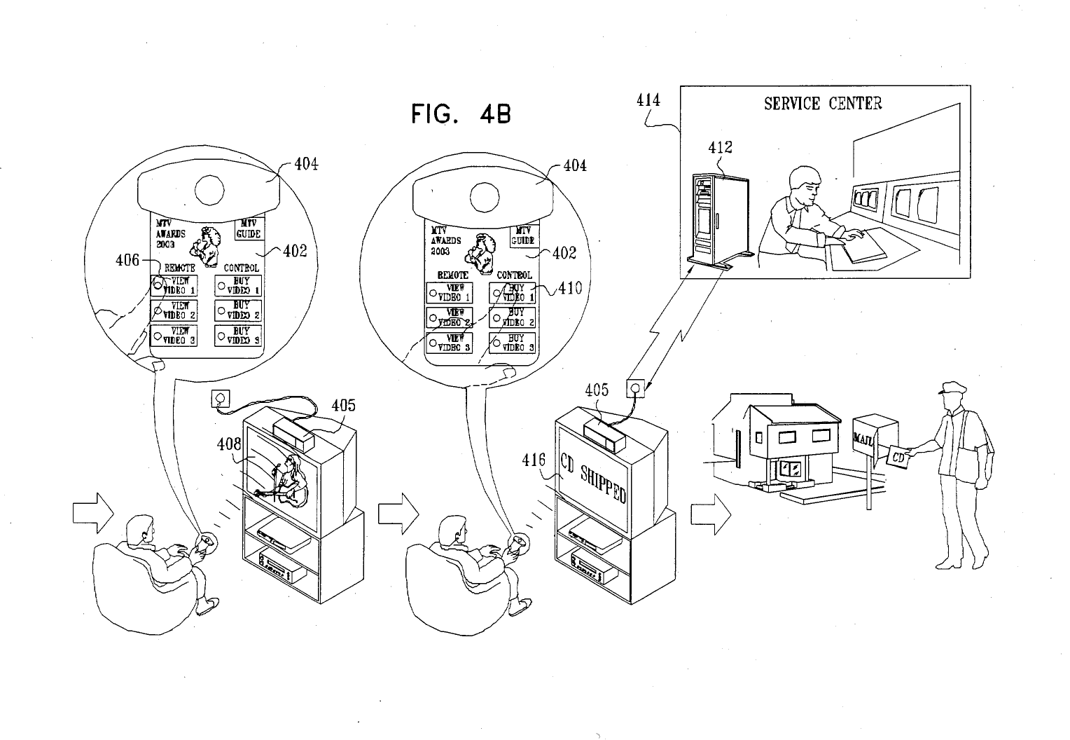

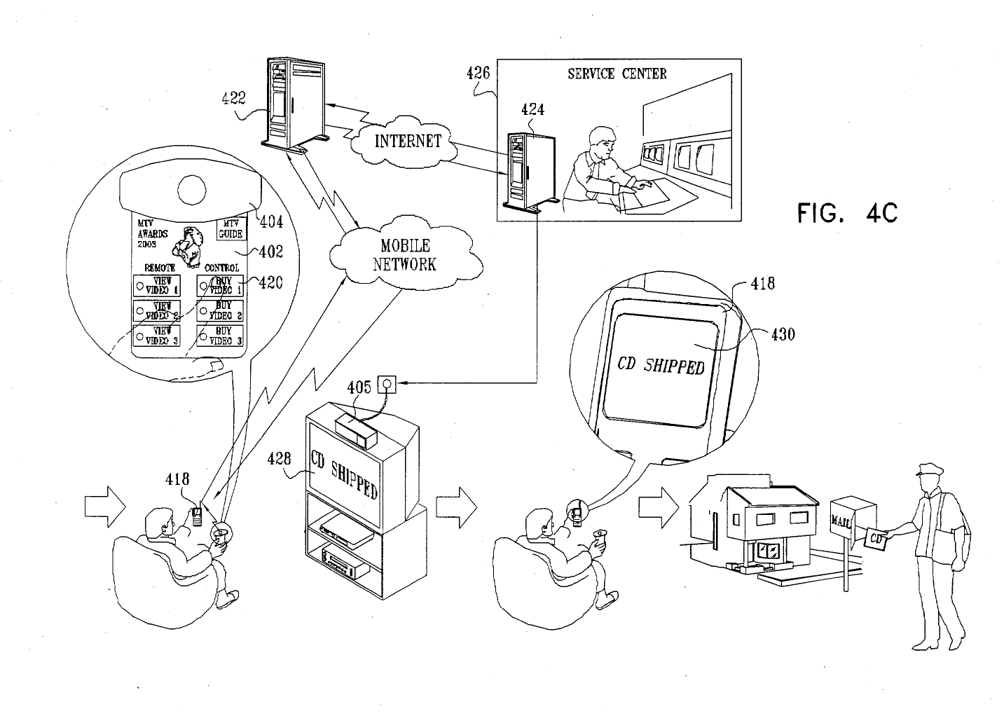

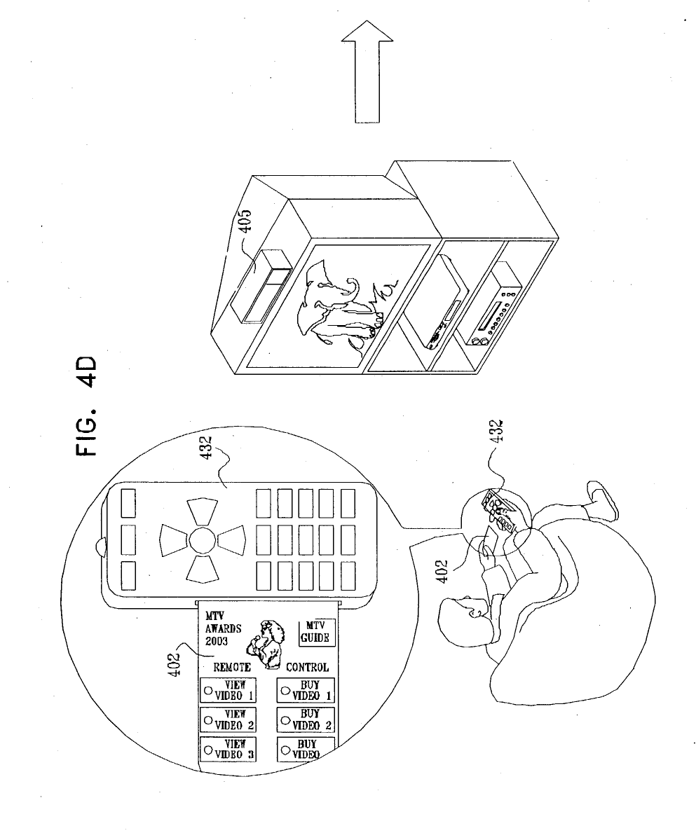

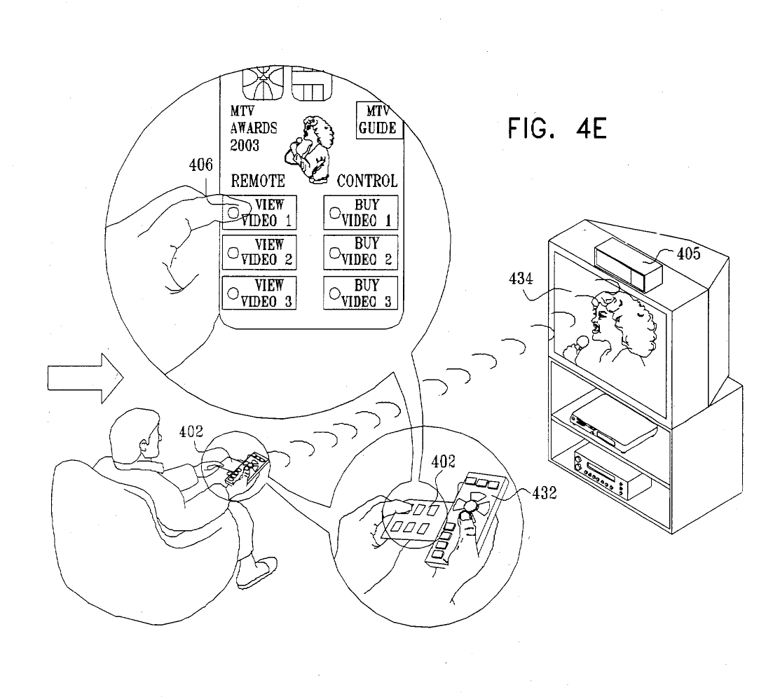

Reference is now made to FIGS. 4A, 4B and 4C, which are, taken together, a simplified pictorial illustration of operation of a selectable functionality mobile communication system constructed and operative in accordance with still another preferred embodiment of the present invention. As seen in FIG. 4A, a typical scenario begins with a consumer receiving a mobile communication system user interface card 402, via mail or any other means of delivery.

At any appropriate time thereafter, such as while watching a television program, the consumer may insert the card 402 into an interface card/mobile telephone communication facilitator 404 or any other suitable user-interface card intermediary to upload a selected feature onto his television set via an interactive television application, such as a set top box 405. The consumer may employ the card 402 and the facilitator 404 in one of a number of different functional contexts, three examples of which are described hereinbelow with reference to FIGS. 4B-4E.

In FIG. 4B, it is seen that the consumer, or any other user, may upload a selected music video clip to be displayed on his TV screen by pressing on a “VIEW VIDEO 1” button 406 on the card 402 causing a “VIEW VIDEO 1” information module to be communicated from the card 402 to or through the facilitator 404 and enabling the facilitator 404 to communicate the music video clip request to the set top box 405, typically in a wireless manner as shown. In the illustrated embodiment, infrared or RF communication is employed, it being understood that any other suitable type of communication between the card 402 and the set top box 405 may be employed. The set top box 405, in turn, switches to another broadcasting channel to display the requested music video clip on the television screen, as designated by reference number 408.

If the consumer wishes to purchase a compact disk of the music video clip, he orders a selected music video clip pressing on a “BUY VIDEO 1” button 410 on the card 402, causing a “BUY VIDEO 1” information module to be communicated from the card 402 to or through the facilitator 404 and enabling the facilitator 404 to communicate the music video clip compact disk purchase order to the set top box 405. The set top box 405, in turn, communicates, via a return channel network such as a cable network, with a TV network server 412, typically located at a service center 414. A confirmation of the order receipt may be displayed on the television screen, as designated by reference number 416. In response to a prompt from the TV network server 412 a service center representative arranges for the requested music video clip compact disk to be delivered to the consumer.

FIG. 4C shows use of the card 402, the facilitator 404 and a telephone 418 to order a music video compact disk. The consumer presses on a “BUY VIDEO 1” button 420 on the card 402, typically causing an information module containing a “BUY VIDEO 1” request to be communicated from the card 402 to or through the facilitator 404 and enabling the facilitator 404 to communicate the request to his mobile telephone 418, typically in a wireless manner as shown. In the illustrated embodiment, infrared communication is employed, it being understood that any other suitable type of communication between the card 402 and the telephone 418 may be employed. The telephone 418, in turn, communicates, via a mobile network, with a mobile server 422 and transmits the “BUY VIDEO 1” request. The mobile server 422, in turn, communicates, via Internet, with a TV network server 424, typically located at a service center 426. A confirmation of the order receipt is displayed on the television screen, as designated by reference number 428. When prompted by server 424 a service center representative arranges for the music video compact disk to be delivered to the consumer.

The mobile server 422, in turn, communicates, via Internet, with the TV network server 424. A confirmation of the order receipt may also be displayed on the telephone 418, as designated by reference number 430.

Reference is now made to FIGS. 4D and 4E, which are, taken together, a simplified pictorial illustration of operation of a selectable functionality mobile communication system constructed and operative in accordance with still another preferred embodiment of the present invention. As seen in FIG. 4D, a typical scenario begins with a consumer watching a television program.

At any appropriate time thereafter, the consumer may insert the mobile communication system user interface card 402 into a card enabled set top box remote controller 432 or any other suitable user-interface card intermediary to upload a selected feature onto his television set via an interactive set top box 405. The consumer may employ the card 402 in a number of different functional contexts, one examples of which is described hereinbelow with reference to FIG. 4E.

In FIG. 4E, it is seen that the consumer may upload a selected music video to be displayed on his TV screen by pressing on a “VIEW VIDEO 1” button 406 on the card 402 causing a “VIEW VIDEO 1” information module to be communicated from the card 402 to the set top box 405, typically in a wireless manner as shown. In the illustrated embodiment, infrared or RF communication is employed, it being understood that any other suitable type of communication between the card 402 and the set top box 405 may be employed. The set top box 405, in turn displays the requested music video clip on the television screen, as designated by reference number 434.

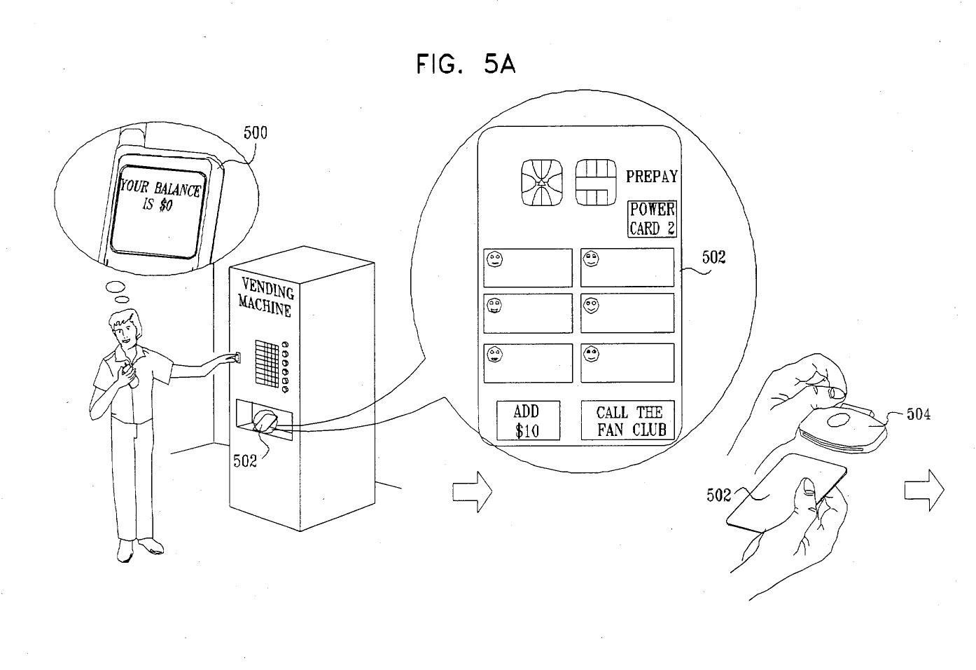

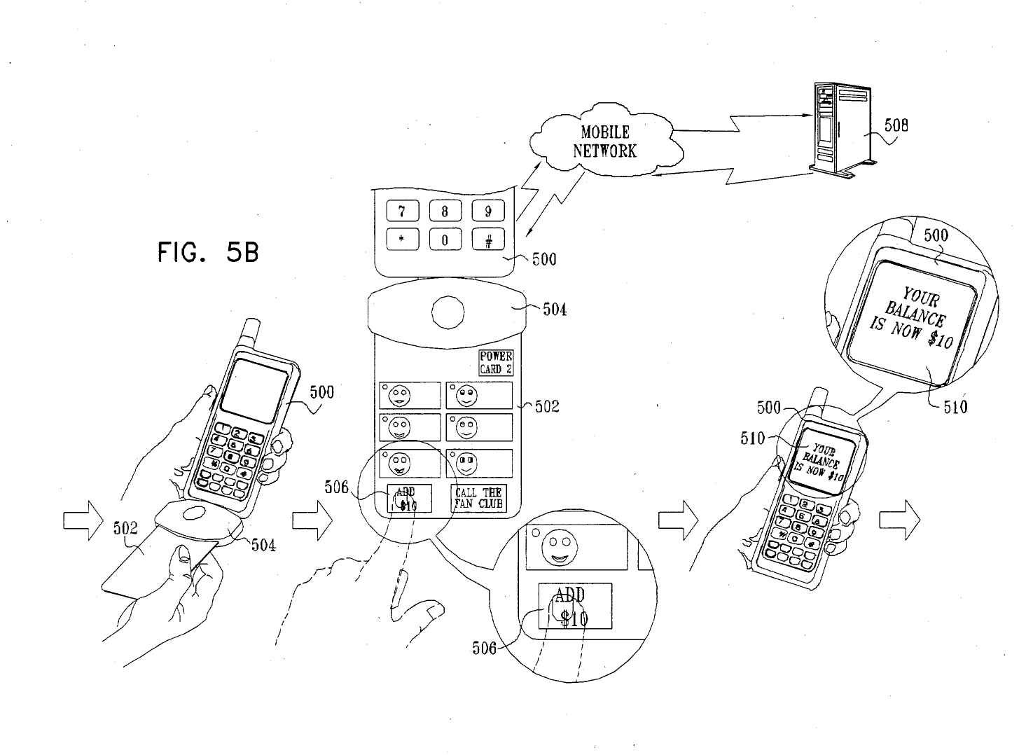

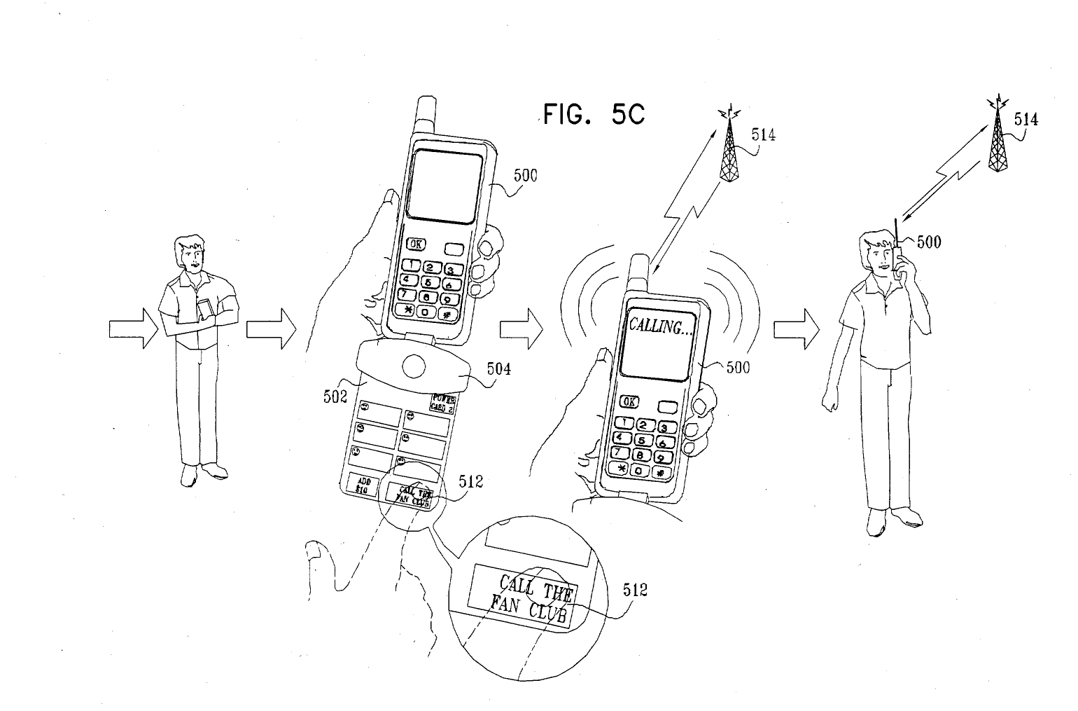

Reference is now made to FIGS. 5A, 5B and 5C, which are, taken together, a simplified pictorial illustration of operation of a selectable functionality mobile communication system constructed and operative in accordance with a preferred embodiment of the present invention. As seen in FIG. 5A, a typical scenario begins with a member of a fan club, carrying a mobile telephone 500, purchasing a user interface card 502, here functioning as a mobile communication system refill card, at a vending machine or other retail outlet.

At any appropriate time thereafter, the fan club member may insert the card 502 into an interface card/mobile telephone communication facilitator 504 or any other suitable user-interface card intermediary. The fan club member may employ the card 502 and the facilitator 504 in one of a number of different functional contexts, two examples of which are described hereinbelow with reference to FIGS. 5B and 5C, respectively.

In FIG. 5B, it is seen that the fan club member, or any other user, may increase the balance of his prepaid account by pressing on a “ADD $10” button 506 on card 502, causing a “ADD $10” information module containing a secret PIN number to be communicated from card 502 to or through facilitator 504 and enabling facilitator 504 to communicate the “ADD $10” request containing a secret PIN number to the telephone 500. In the illustrated embodiment, a wired connection is employed, it being understood that any other suitable type of communication between the card 502 and the telephone 500 may be employed. The telephone 500, in turn, communicates, via a mobile network, with a server 508 and transmits the request, to add $10 to his prepaid account, containing a secret PIN number. Increase of balance confirmation is displayed on the telephone 500, as designated by reference number 510.

Turning to FIG. 5C, it is seen that the fan club member, or any other user, may initiate a telephone call from the mobile telephone 500 by pressing on a “CALL THE FAN CLUB” button 512 on the card 502, causing a “CALL THE FAN CLUB” information module to be communicated from the card 502 to or through the facilitator 504 and enabling the facilitator 504 to communicate the “CALL THE FAN CLUB” request to the telephone 500. In the illustrated embodiment, a wired connection is employed, it being understood that any other suitable type of communication between the card 502 and the telephone 500 may be employed. The telephone 500, in turn, via a mobile network 514, dials a telephone number to place a telephone call to the fan club destination.

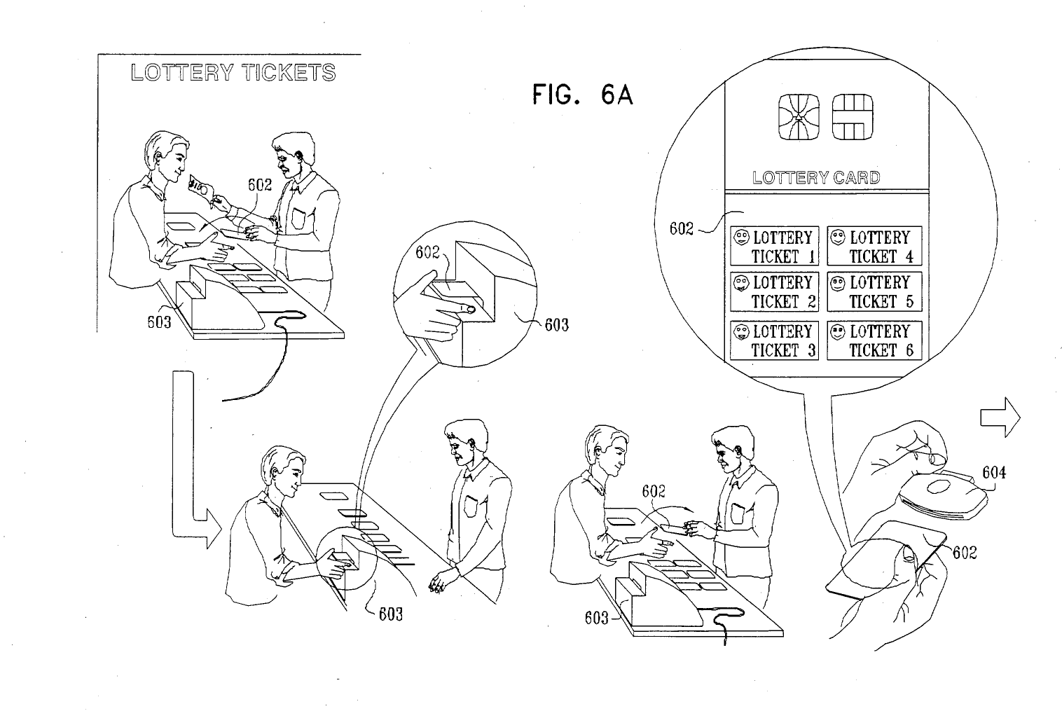

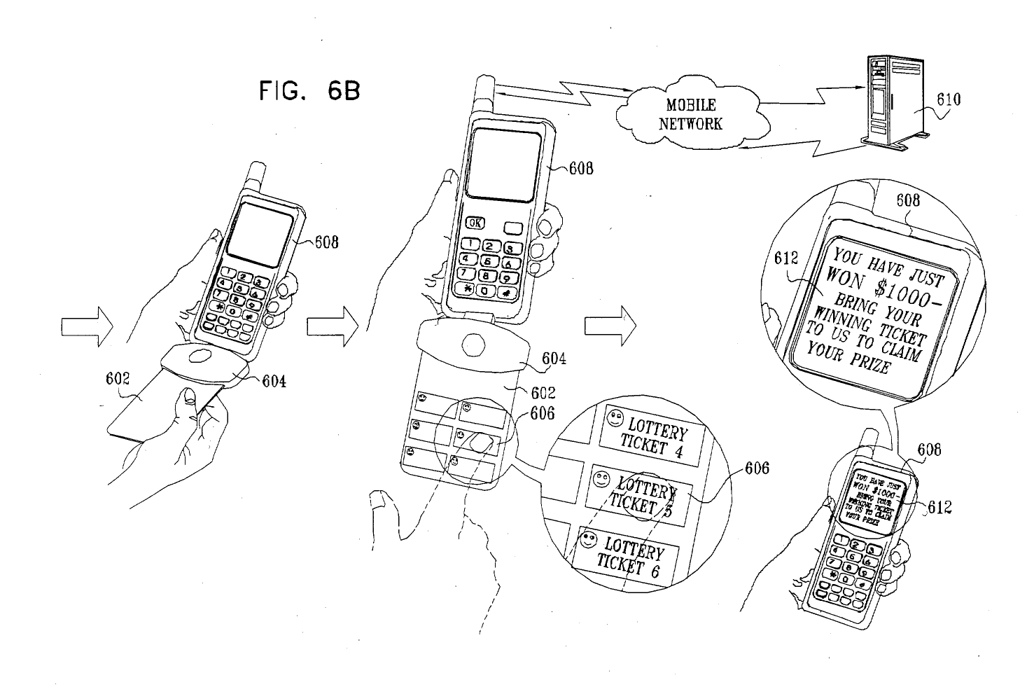

Reference is now made to FIGS. 6A and 6B, which are, taken together, a simplified pictorial illustration of operation of a selectable functionality mobile communication system constructed and operative in accordance with a preferred embodiment of the present invention. As seen in FIG. 6A, a typical scenario begins with a lottery player, purchasing a mobile communication system user interface card 602, here functioning as a lottery card, at a lottery ticket booth or other retail outlet. At the lottery ticket booth the lottery ticket card 602 is issued a secret number by the point-of-sale terminal 603.

At any appropriate time thereafter, the lottery player may insert the card 602 into an interface card/mobile telephone communication facilitator 604 or any other suitable user-interface card intermediary. The lottery player may employ the card 602 and the facilitator 604 in a number of different functional contexts, one of them described hereinbelow with reference to FIG. 6B.

Turning to FIG. 6B, it is seen that the lottery player, or any other user, may select a given lottery entry ticket by pressing on a “LOTTERY TICKET” button 606 on card 602, causing a “LOTTERY TICKET” information module containing a secret lottery number to be communicated from the card 602 to or through the facilitator 604 and enabling the facilitator 604 to communicate the lottery entry request containing a secret lottery number to the telephone 608. In the illustrated embodiment, a wired connection is employed, it being understood that any other suitable type of communication between the card 602 and the telephone 608 may be employed. The telephone 608, in turn, communicates, via a mobile network, with a server 610 and obtains the lottery entry request. The lottery results are displayed on the telephone 610, as designated by reference number 612.

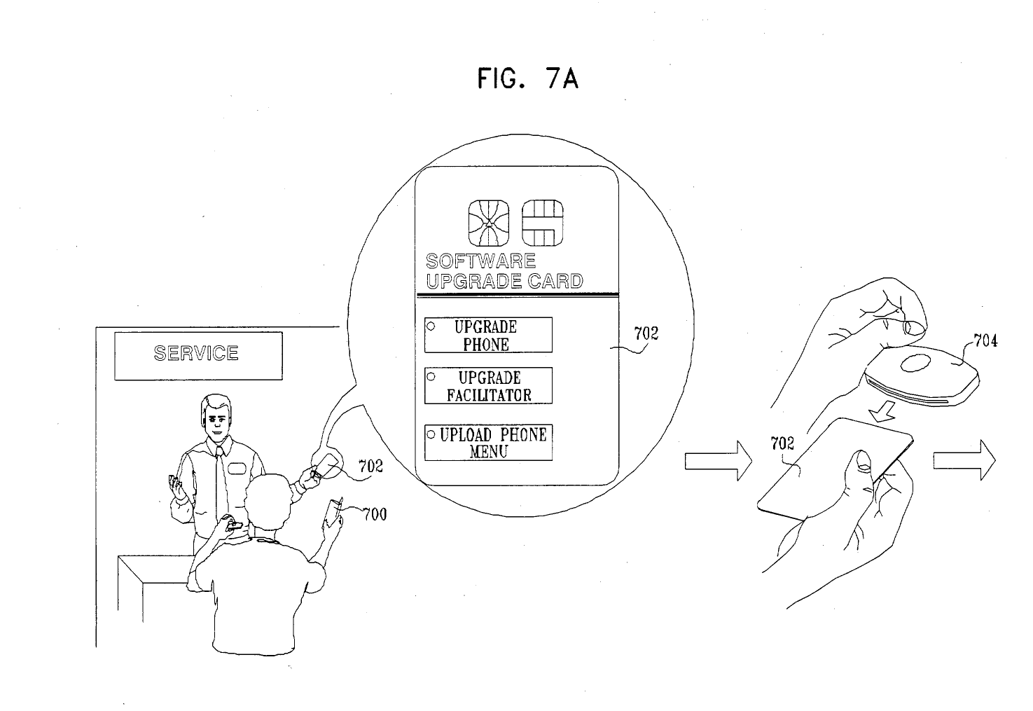

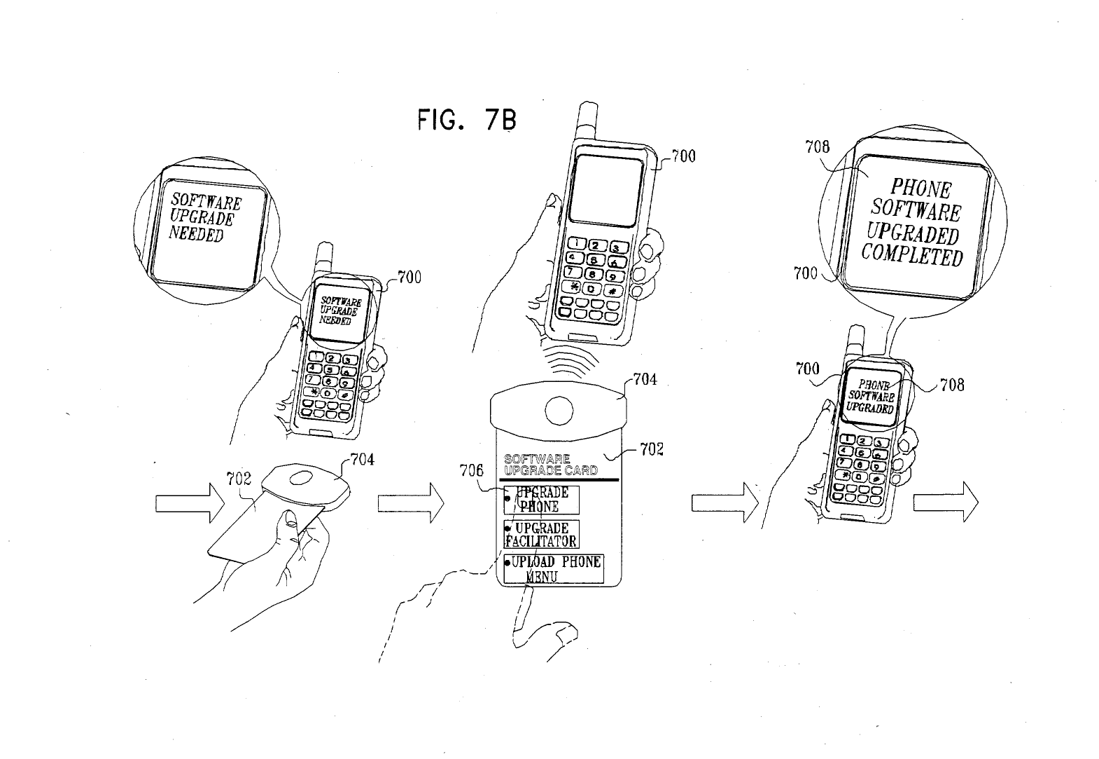

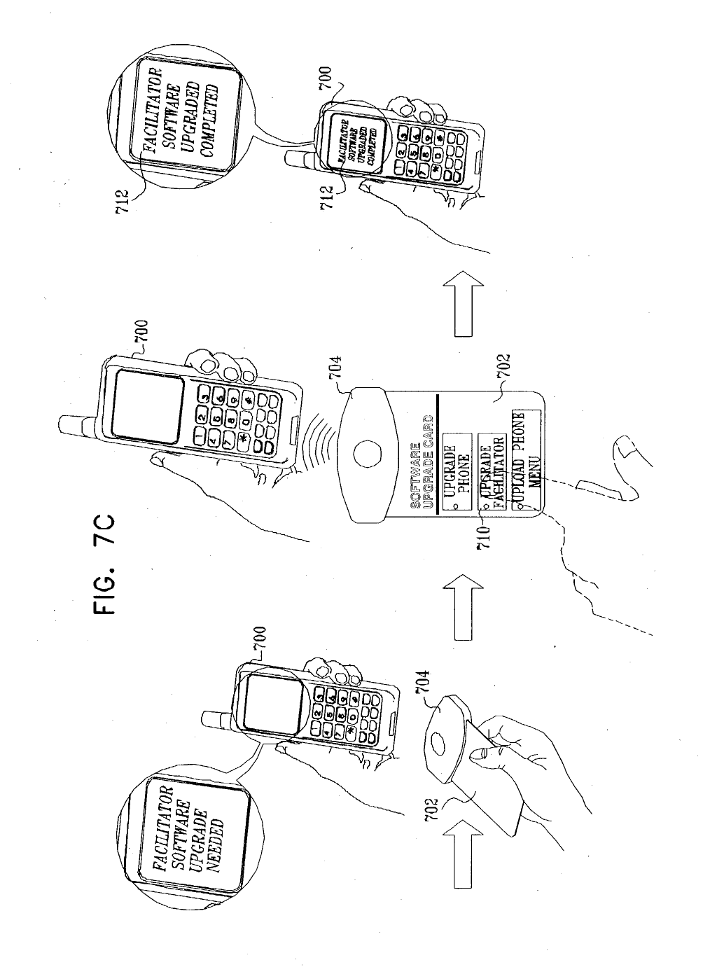

Reference is now made to FIGS. 7A, 7B, and 7C, which are, taken together, a simplified pictorial illustration of operation of a selectable functionality mobile communication system constructed and operative in accordance with a preferred embodiment of the present invention. As seen in FIG. 7A, a typical scenario begins with a customer, carrying a mobile telephone 700, purchasing a mobile communication system user interface card 702, at a facilitator sales/service location or other retail outlet.

At any appropriate time thereafter, the customer may insert the card 702 into an interface card/mobile telephone communication facilitator 704 or any other suitable user-interface card intermediary. The customer may employ the card 702 and the facilitator 704 in one of a number of different functional contexts, two examples of which are described hereinbelow with reference to FIGS. 7B and 7C, respectively.

Turning to FIG. 7B, it is seen that once a notice of required phone software upgrade is displayed on the telephone screen, the customer, or any other user, may upload a telephone software upgrade onto his telephone 700 by pressing on a “UPGRADE PHONE” button 706 on card 702 causing a telephone software upgrade information module to be communicated from card 702 to or through facilitator 704 and enabling facilitator 704 to communicate the selected telephone software upgrade to the telephone 700. In the illustrated embodiment, infrared communication is employed, it being understood that any other suitable type of communication between the card 702 and the telephone 700 may be employed. A confirmation of phone software upgrade is displayed on the telephone screen, as designated in reference number 708.

In FIG. 7C, it is seen that once a notice of required facilitator software upgrade is displayed on the telephone screen, the customer, or any other user may upload facilitator upgrade software, stored in the card 702, by pressing on an “UPGRADE FACILITATOR” button 710 on card onto facilitator 704 causing a facilitator software upgrade information module to be communicated from the card 702 to the facilitator 704. Upon completion of the facilitator software upgrade a facilitator upgrade confirmation is communicated from the card 702 to or through the facilitator 704 enabling communication of the facilitator upgrade confirmation to the telephone 700. In the illustrated embodiment, infrared communication is employed, it being understood that any other suitable type of communication between the card 702 and the telephone 700 may be employed. A facilitator software upgrade confirmation is displayed on the telephone screen, as designated in reference number 712.

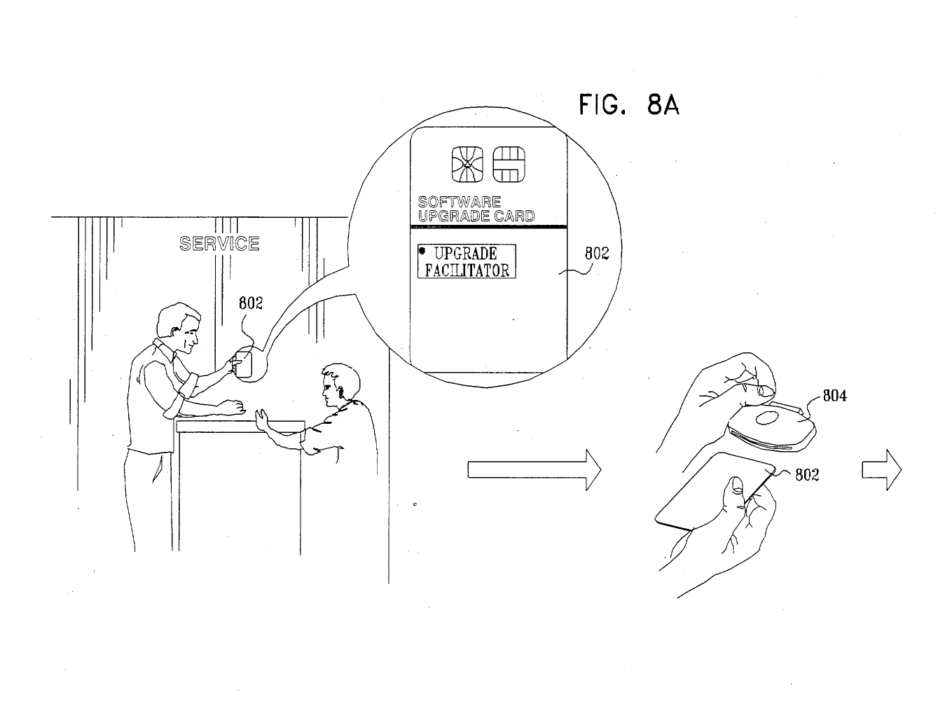

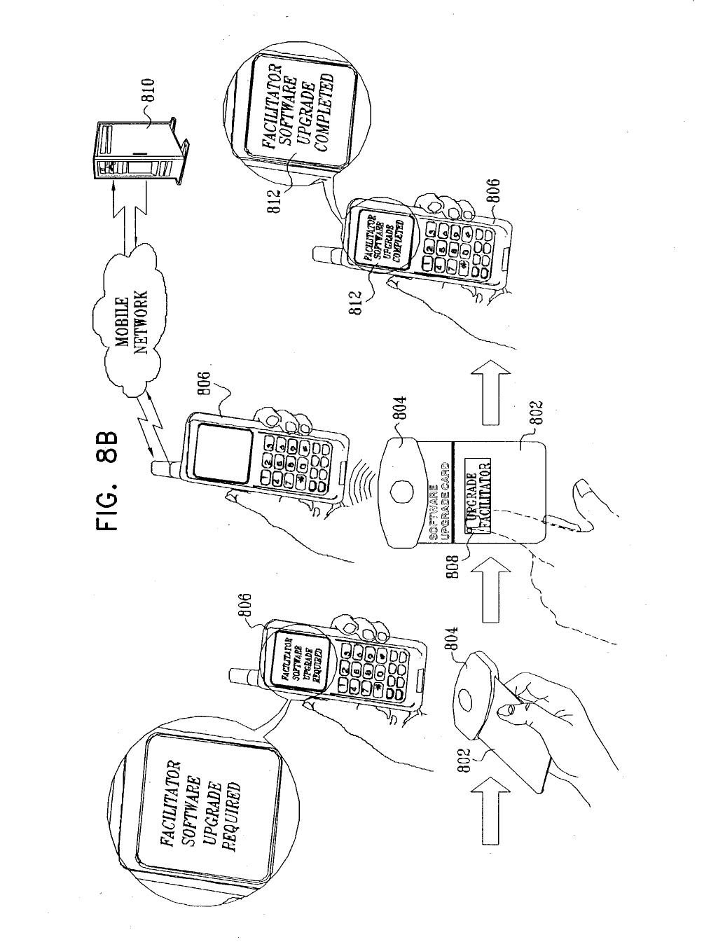

Reference is now made to FIGS. 8A and 8B, which are, taken together, a simplified pictorial illustration of operation of a selectable functionality mobile communication system constructed and operative in accordance with yet another preferred embodiment of the present invention. As seen in FIG. 8A, a typical scenario begins with a young customer, purchasing a mobile communication system user interface card 802 at a facilitator sales/service location or other retail outlet.

At any appropriate time thereafter, the young customer may insert the card 802 into an interface card/mobile telephone communication facilitator 804 or any other suitable user-interface card intermediary. The customer may employ the card 802 and the facilitator 804 in a number of different functional contexts, one of which is described hereinbelow with reference to FIG. 8B.

In FIG. 8B, it is seen that once a notice of required facilitator software upgrade is displayed on the telephone screen, the young customer, or any other user may upload a facilitator upgrade software onto the facilitator 804 by pressing on an “UPGRADE FACILITATOR” button the 808 on the card 802, causing a facilitator upgrade information module to be communicated from the card 802 to the facilitator 804 and enables the facilitator 804 to communicate the selected facilitator upgrade software to the telephone 806. In the illustrated embodiment, infrared communication is employed, it being understood that any other suitable type of communication between the card 802 and the telephone 806 may be employed. The telephone 806, in turn, communicates, via a mobile network, with a server 810 and obtains the “UPGRADE FACILITATOR” request. Upon completion of the facilitator software upgrade a facilitator upgrade confirmation is communicated from the card 802 to or through the facilitator 804 enabling the facilitator 804 to communicate the facilitator upgrade confirmation to the telephone 806. In the illustrated embodiment, infrared communication is employed, it being understood that any other suitable type of communication between the card 802 and the telephone 806 may be employed. A facilitator software upgrade confirmation is displayed on the telephone screen, as designated in reference number 812.

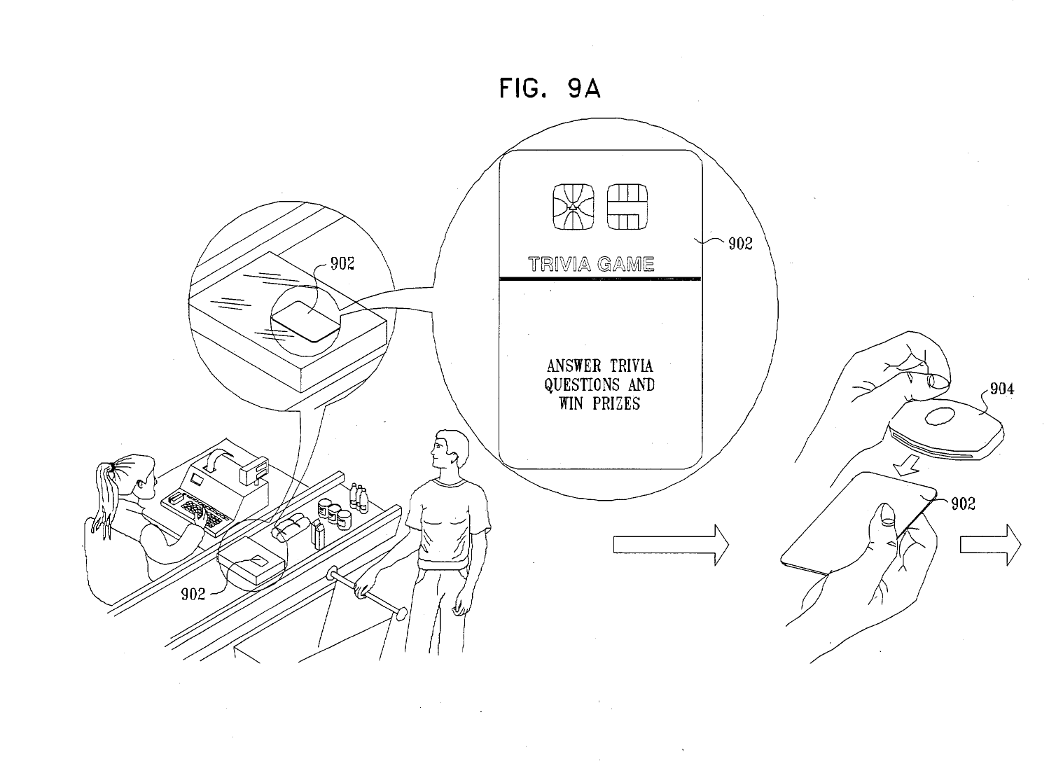

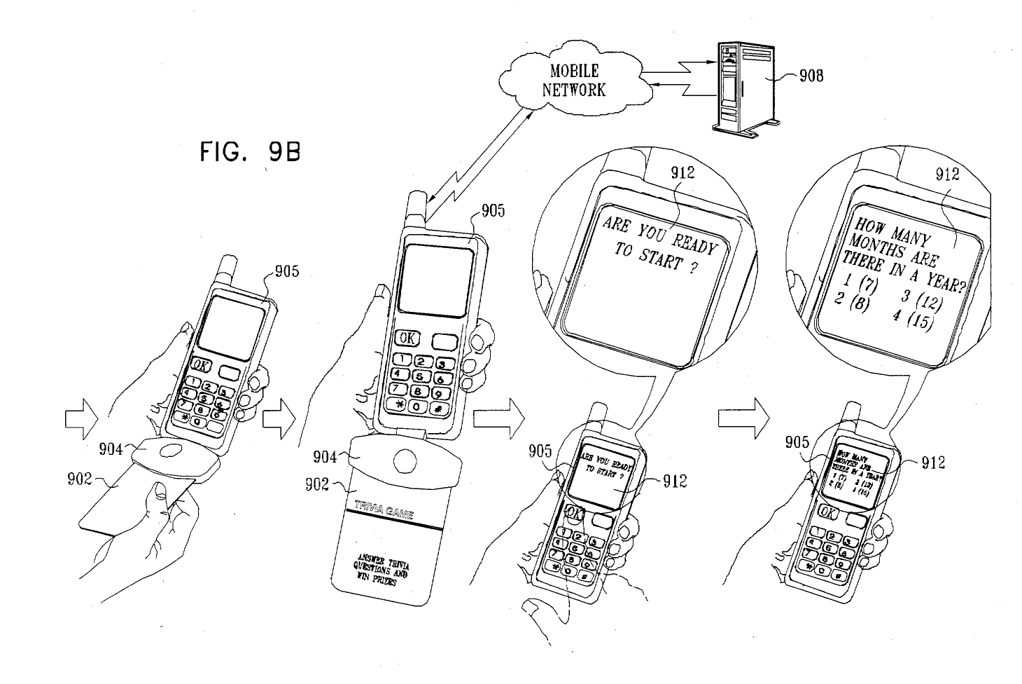

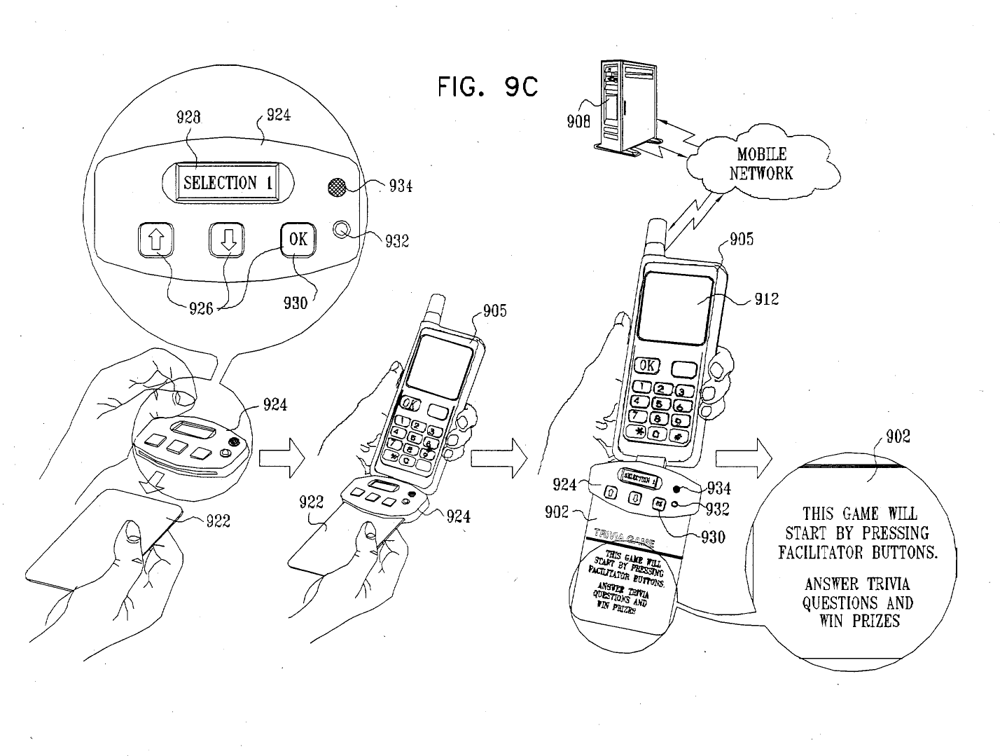

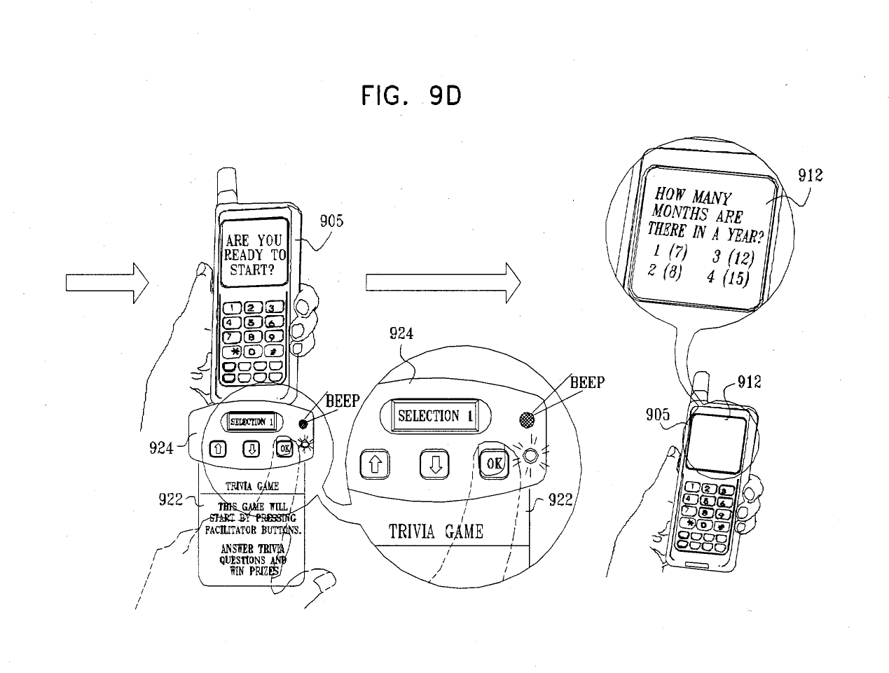

Reference is now made to FIGS. 9A, 9B, 9C and 9D, which are, taken together, a simplified pictorial illustration of operation of a selectable functionality mobile communication system constructed and operative in accordance with yet another preferred embodiment of the present invention. As seen in FIG. 9A, a typical scenario begins with a teenage boy, purchasing a mobile communication system user interface card 902, at a supermarket or other retail outlet.

At any appropriate time thereafter, the teenage boy may insert the card 902 into an interface card/mobile telephone communication facilitator 904 or any other suitable user-interface card intermediary. The teenage boy may employ the card 902 and the facilitator 904 in a number of different functional contexts, two of which are described hereinbelow with reference to FIGS. 9B, 9C and 9D.

In FIG. 9B, it is seen that the teenage boy, or any other user, may cause a trivia game to be downloaded to his mobile telephone 905 by inserting the card 902 into the facilitator 904 causing a “TRIVIA GAME” request information module to automatically be communicated from card 902 to or through facilitator 904 and enabling facilitator 904 to communicate the game request to the telephone 905. The telephone 905, in turn, communicates, via a mobile network, with server 908 and displays a subsequent message on a display 912 of the telephone 905 to start the game. By pressing the keypad of the telephone, the telephone 905 communicates, via a mobile network, with server 908 and enables playing of the requested game, which is displayed on the telephone display 912.

FIGS. 9C & 9D together show use of a card 922, a facilitator 924 and the telephone 905 to cause a trivia game to be downloaded to telephone 905. The teenage boy presses on selection buttons 926 on the facilitator 924. The buttons 926 are used to select from options that can be viewed on a display screen 928 on the facilitator 924. Pressing a select button 930 causes an information module containing a game request to be communicated from card 922 to facilitator 924 and enables facilitator 924 to communicate the request to the telephone 905. The telephone 905, in turn, communicates, via a mobile network, with server 908, downloads the requested game from server 908 and displays the requested game's introduction on the telephone display 912. Facilitator 924 may also include a LED 932 and/or a ringer 934, typically to provide confirmation to the user that his request is being processed. The user then receives a subsequent message on the telephone display 912 to start the game. By a user pressing the selection buttons on the facilitator 924, the facilitator 924, communicates, via a mobile network, with server 908 and enables playing of the requested game, which is displayed on the telephone display 912.

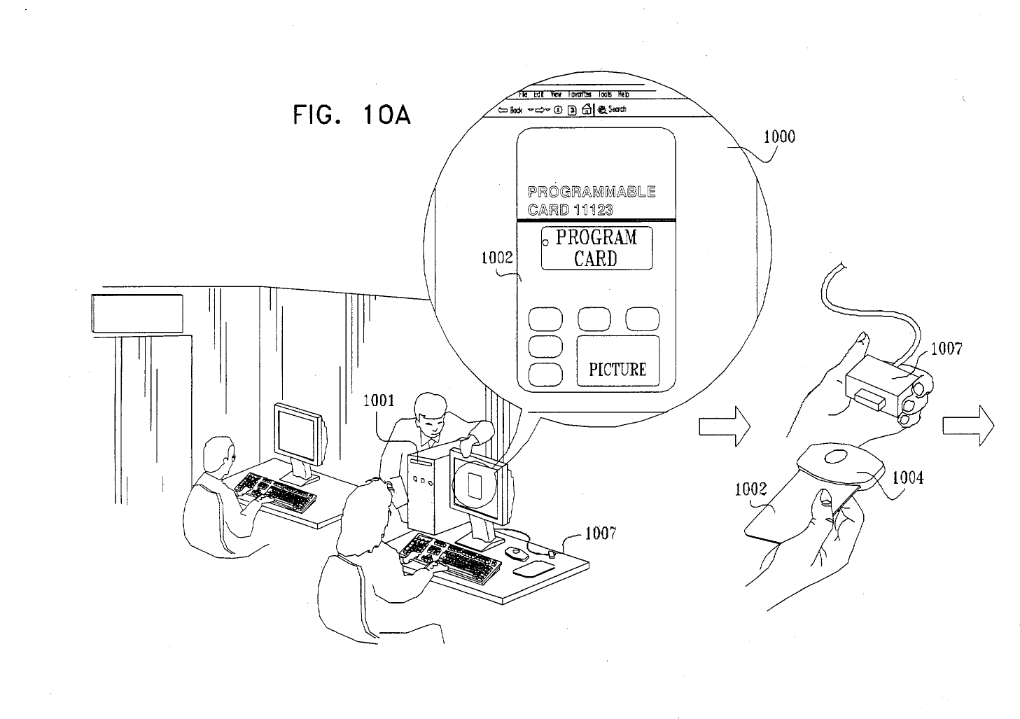

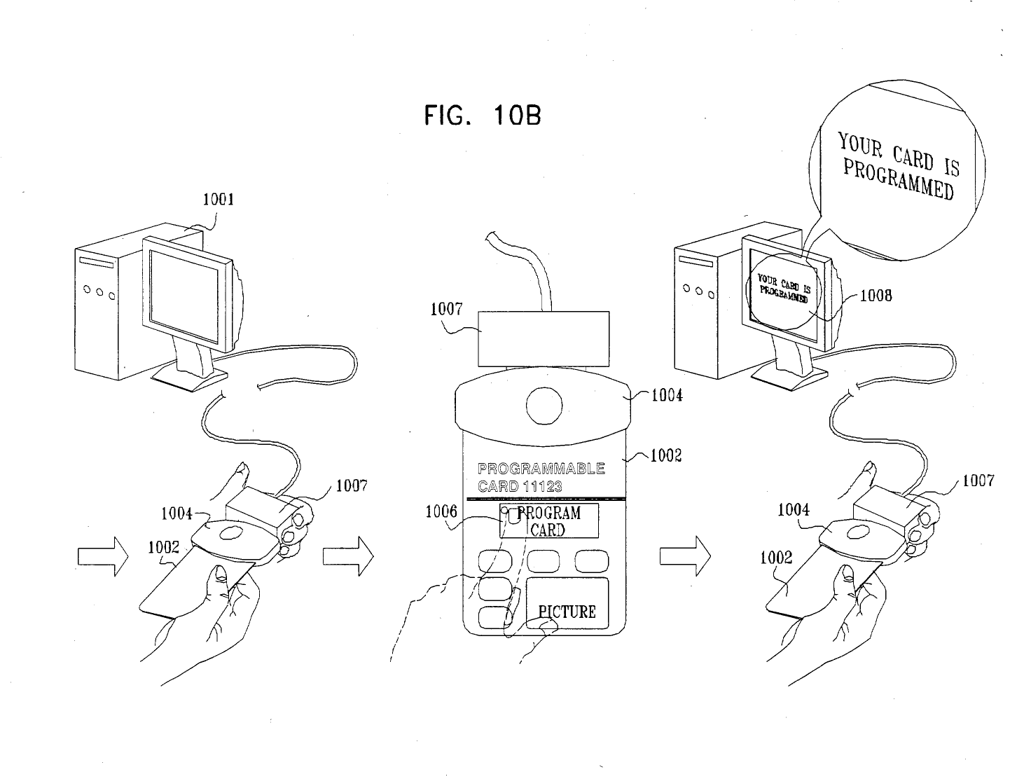

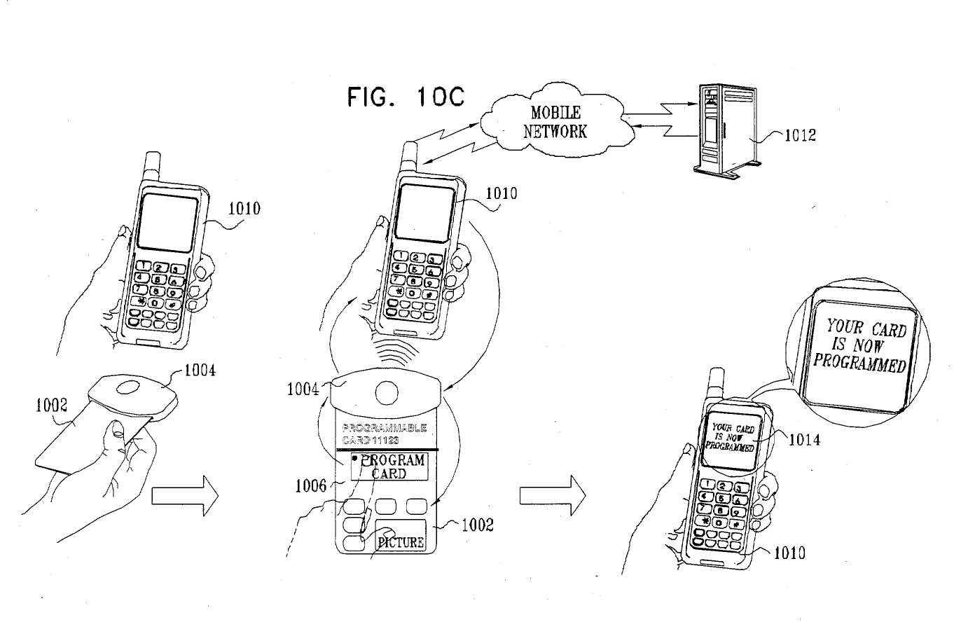

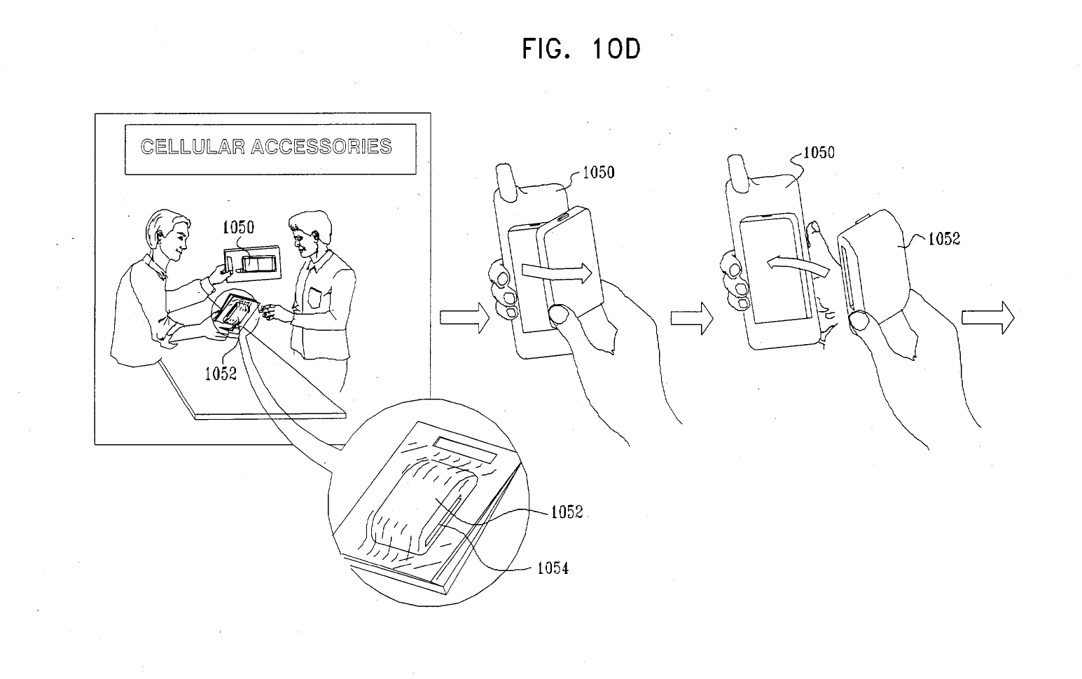

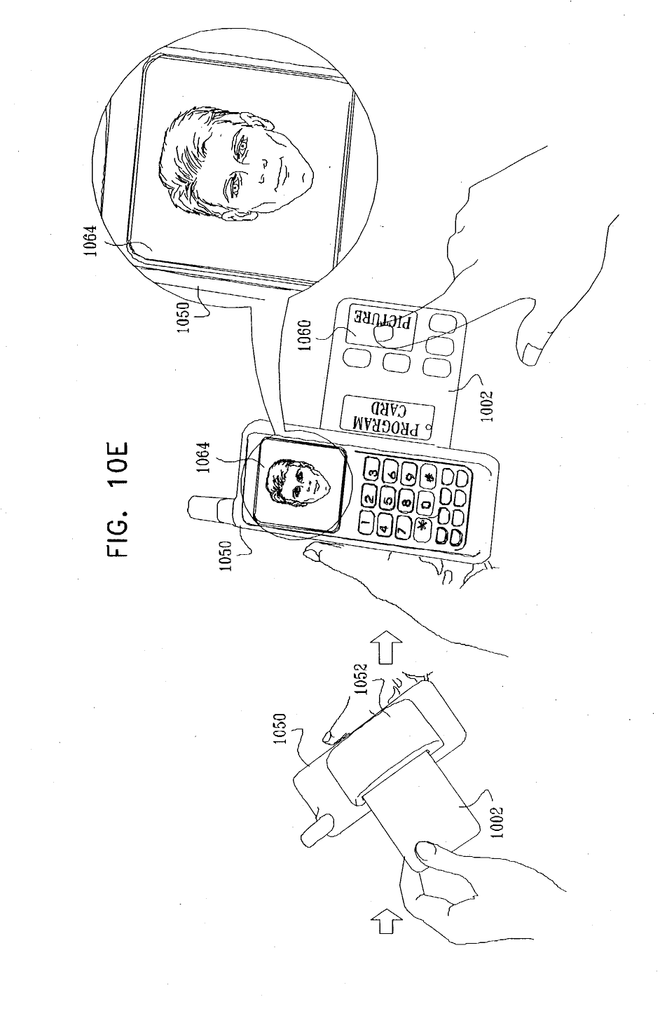

Reference is now made to FIGS. 10A, 10B and 10C, which are, taken together, a simplified pictorial illustration of operation of a selectable functionality communication system constructed and operative in accordance with a preferred embodiment of the present invention. As seen in FIG. 10A, a typical scenario begins with a PC user browsing through an Internet site 1000, displayed on a screen of a computer 1001, that presents simulated programmable cards that can be downloaded onto a user interface card 1002, and downloading a selected card.

At any appropriate time thereafter, the PC user may effect the download by inserting the user interface card 1002 into an interface card/mobile telephone communication facilitator 1004 or any other suitable user-interface card intermediary and connecting facilitator 1004, via a connector 1007, to the computer 1001. As seen in FIG. 10B, the PC user may download selected information modules onto her card 1002 by pressing on a “PROGRAM CARD” button 1006 on card 1002, causing a “PROGRAM CARD” request information module to be communicated from card 1002 to or through facilitator 1004 and enabling facilitator 1004 to communicate the request to the computer 1001. In the illustrated embodiment, connector 1007 is a wired connector, it being understood that any other suitable type of communication connector between the facilitator 1004 and the computer 1001 may be employed. In response to the “PROGRAM CARD” request, the computer 1001 downloads the desired information module, thus programming user interface card 1002. Upon completion of the programming 1001 displays a confirmation of programming completion on the screen of computer 1001, as designated in reference numeral 1008.

FIG. 10C shows use of the card 1002, the facilitator 1004 and a telephone 1010 to program a card 1002 with new information modules. The PC user presses on a “PROGRAM CARD” button 1006 on card 1002, typically causing an information module containing a “PROGRAM CARD” request to be communicated from the card 1002 to or through facilitator 1004 and enabling facilitator 1004 to communicate the request to the telephone 1010. The telephone 1010 in turn communicates, via a mobile network, with a server 1012 and obtains the requested new information modules, via the Internet. Upon completion of the programming the telephone 1010 displays a confirmation of completion of programming on the telephone screen, as designated by reference numeral 1014.

Reference is now made to FIGS. 10D and 10E, which together are a simplified pictorial illustration of operation of a selectable functionality mobile communication system constructed and operative in accordance with a preferred embodiment of the present invention. As seen in FIG. 10D, a typical scenario begins with the consumer obtaining a telephone 1050 having integral facilitator or other intermediary functionality. One example of such a telephone could be a Nokia Model 3510i of Nokia, U.S.A. having a removable back cover, which has been replaced by a back cover 1052 incorporating the functionality of a facilitator or other intermediary of the type described herein, as well as a battery. The facilitator functionality/telephone communication link is preferably hard wired inside the telephone.

The consumer may employ the telephone 1050 having facilitator functionality in a number of different functional contexts, one of which is described hereinbelow with reference to FIG. 10E.

Turning to FIG. 10E, it is seen that the consumer may upload a selected image onto her telephone 1050 by pressing on a “PICTURE” button 1060 on card 1002, causing a image information module to be communicated from card 1002 to the telephone 1050, typically by direct insertion of the card 1002 into a slot 1054 formed on the replacement back cover 1052, as shown, in order to display the image on the telephone screen, as designated in reference numeral 1064. In the illustrated embodiment, the card is inserted directly into the back cover of the telephone, it being understood that any other suitable type of operative engagement between the card 1002 and the telephone 1050 may be employed.

It is to be appreciated that the foregoing description and drawings present various examples of various features of systems and subsystems constructed and operative in accordance with a preferred embodiment of the present invention. Novel combinations of the features described hereinabove in various different contexts are within the scope of the present invention.

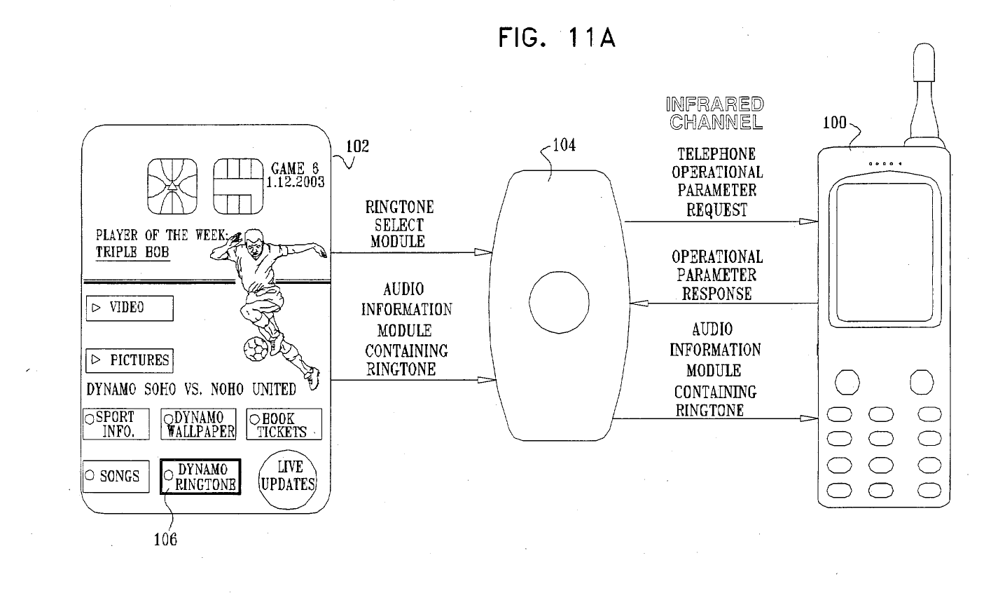

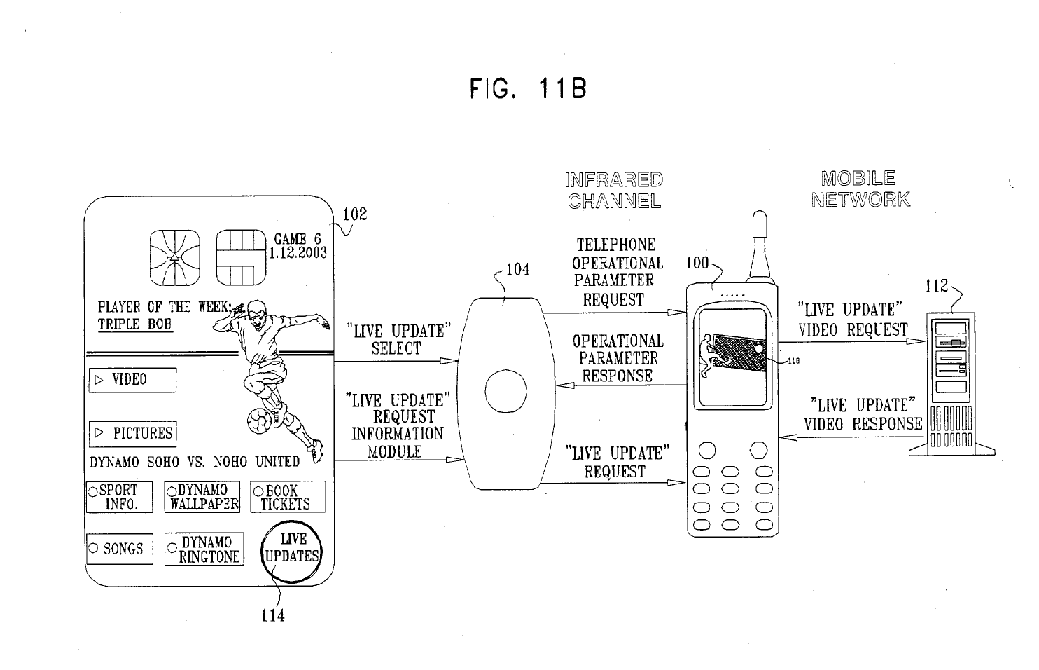

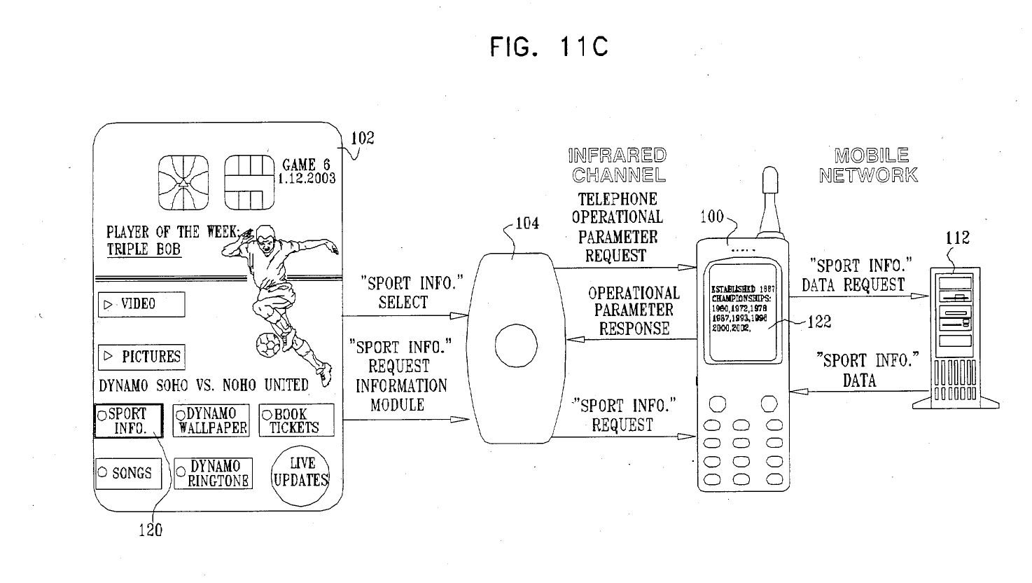

Reference is now made to FIGS. 11A, 11B and 11C, which are, taken together, a simplified generalized information flow diagram illustration of operation of the selectable functionality mobile communication system of FIGS. 1A-1D. As seen in FIG. 11A, which corresponds to FIG. 1B, in response to a user's pressing on the ringtone button 106, a ringtone select information module is transmitted from the card 102 to the facilitator 104, causing the facilitator 104 to pull from card 102, an audio information module containing the selected ringtone.

The facilitator 104, preferably communicating via an infrared channel with telephone 100, requests certain operational parameters regarding the telephone and receives suitable responses. Upon receipt of these responses, the facilitator 104 transmits audio information containing the selected ringtone in a format suitable for use by telephone 100. This audio information may be identical to that received from card 102 or may have undergone processing in the facilitator 104 in order to adapt it to telephone 100.

Turning to FIG. 11B, which corresponds to FIG. 1C, it is seen that in response to a user's pressing on the “LIVE UPDATE” button 114, a “LIVE UPDATE” select information module is transmitted from the card 102 to the facilitator 104, causing the facilitator 104 to pull from card 102, a “LIVE UPDATE” request information module.

The facilitator 104, preferably communicating via an infrared channel with telephone 100, requests certain operational parameters regarding the telephone and receives suitable responses. Upon receipt of these responses, the facilitator 104 transmits a “LIVE UPDATE” request to the telephone 100 in a format suitable for the telephone, causing the telephone 100, in turn, to communicate via a mobile network, a “LIVE UPDATE” video stream request to server 112. The server provides a requested “LIVE UPDATE” video stream, which is displayed on the telephone 100, as designated by reference number 116.

FIG. 11C, which corresponds to FIG. 1D, illustrates that in response to a user's pressing on the “SPORTS INFO” button 120, a “SPORTS INFO” select information module is transmitted from the card 102 to the facilitator 104, causing the facilitator 104 to pull from card 102, a “SPORTS INFO” request information module.

The facilitator 104, preferably communicating via an infrared channel with telephone 100, requests certain operational parameters regarding the telephone and receives suitable responses. Upon receipt of these responses, the facilitator 104 transmits a “SPORTS INFO” request to the telephone 100 in a format suitable for the telephone, causing the telephone 100, in turn, to communicates via a mobile network, “SPORTS INFO” data request to server 112. The server provides the requested “SPORTS INFO” data, which is displayed on the telephone 100, as designated by reference number 122.

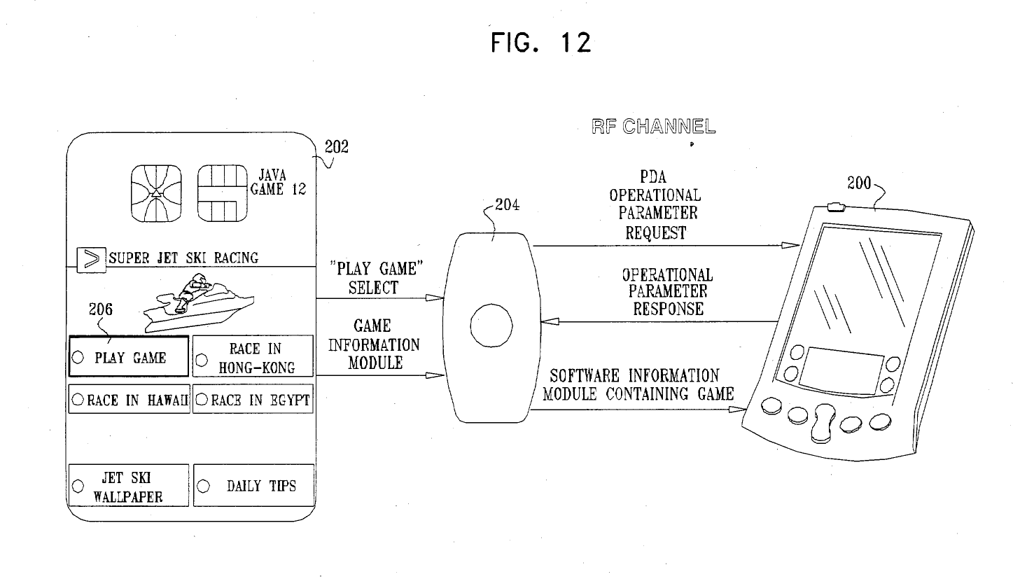

Reference is now made to FIG. 12, which is a simplified generalized information flow diagram illustration of operation of the selectable functionality mobile communication system of FIGS. 2A and 2B. As seen in FIG. 12, which corresponds to FIG. 2B, in response to a user's pressing on the “PLAY GAME” button 206, a game select information module is transmitted from the card 202 to the facilitator 204, causing the facilitator 204 to pull from card 202, an “PLAY GAME” information module containing the selected game.

The facilitator 204, preferably communicating via a RF channel or more specifically a BlueTooth channel, with the PDA 200, requests certain operational parameters regarding the PDA and receives suitable responses. Upon receipt of these responses, the facilitator 204 transmits software information containing the selected game in a format suitable for use by the PDA 200. This information may be identical to that received from card 202 or may have undergone processing in the facilitator 204 in order to adapt it to the PDA 200.

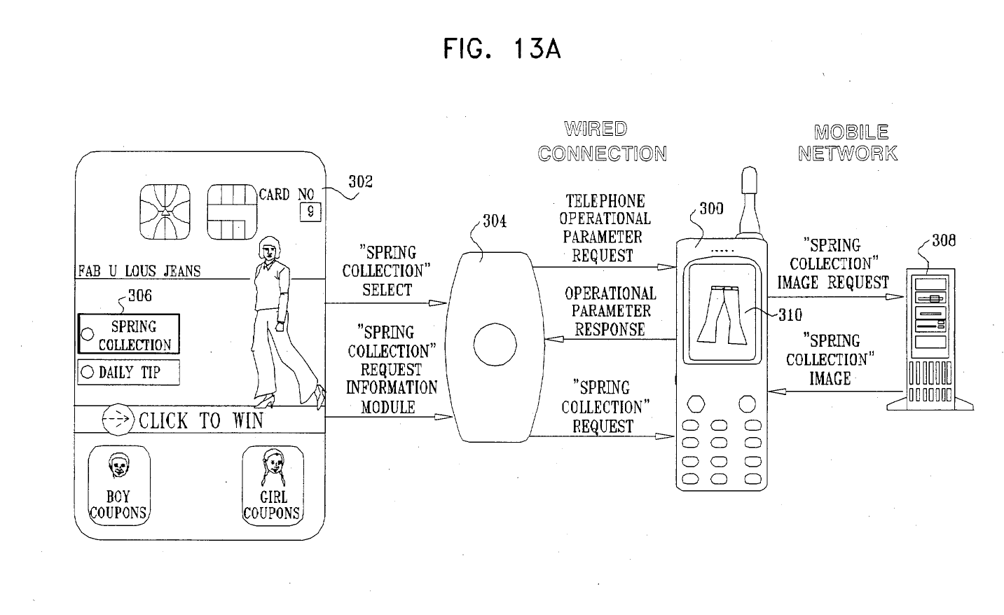

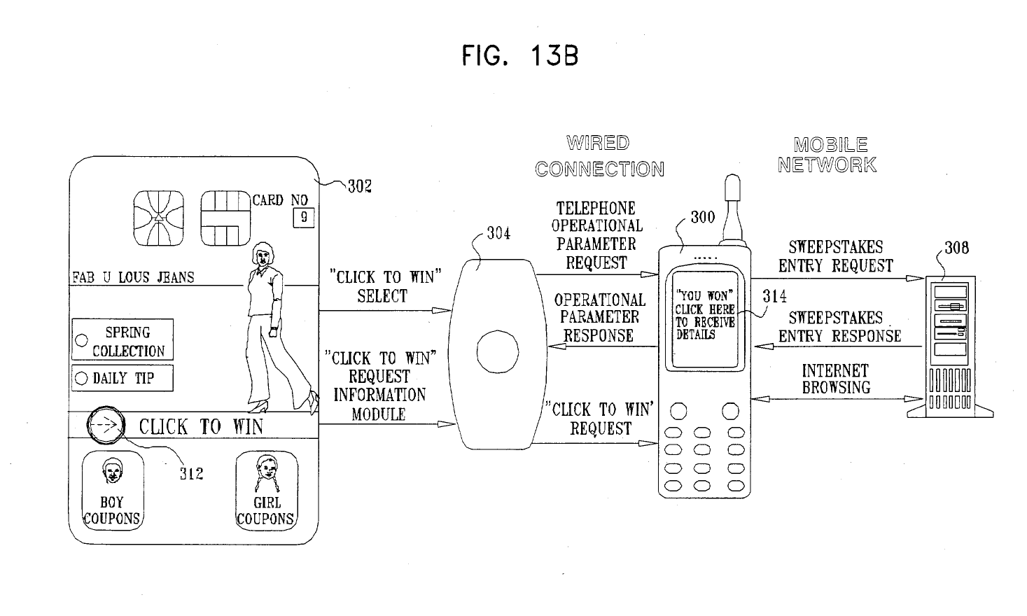

Reference is now made to FIGS. 13A and 13B, which are, taken together, a simplified generalized information flow diagram illustration of operation of the selectable functionality mobile communication system of FIGS. 3A-3C. Turning to FIG. 13A, which corresponds to FIG. 3B, it is seen that in response to a user's pressing on the “SPRING COLLECTION” image button 306, a “SPRING COLLECTION” select information module is transmitted from the card 302 to the facilitator 304, causing the facilitator 304 to pull from card 302, a “SPRING COLLECTION” request information module.

The facilitator 304, preferably communicating via a wired connection with telephone 300, requests certain operational parameters regarding the telephone and receives suitable responses. Upon receipt of these responses, the facilitator 304 transmits a “SPRING COLLECTION” request to the telephone 300 in a format suitable for the telephone, causing the telephone 300, in turn, to communicates via a mobile network, a “SPRING COLLECTION ” image request to server 308. The server provides the requested “SPRING COLLECTION” image, which is displayed on the telephone 300, as designated by reference number 310.

In FIG. 13B, which corresponds to FIG. 3C, it is seen that in response to a user's pressing on the CLICK TO WIN button 312, a CLICK TO WIN select information module is transmitted from the card 302 to the facilitator 304, causing the facilitator 304 to pull from card 302, a CLICK TO WIN request information module.

The facilitator 304, preferably communicating via wired connection with telephone 300, requests certain operational parameters regarding the telephone and receives suitable responses. Upon receipt of these responses, the facilitator 304 transmits a “CLICK TO WIN” draw entry request to the telephone 300 in a format suitable for the telephone 300, causing the telephone 300, in turn, to communicate via a mobile network, a “CLICK TO WIN” request to server 308. The server provides the requested “CLICK TO WIN” draw results, which are displayed on the telephone 300, as designated by reference number 314 and enables further browsing of fashion sweepstakes internet site.

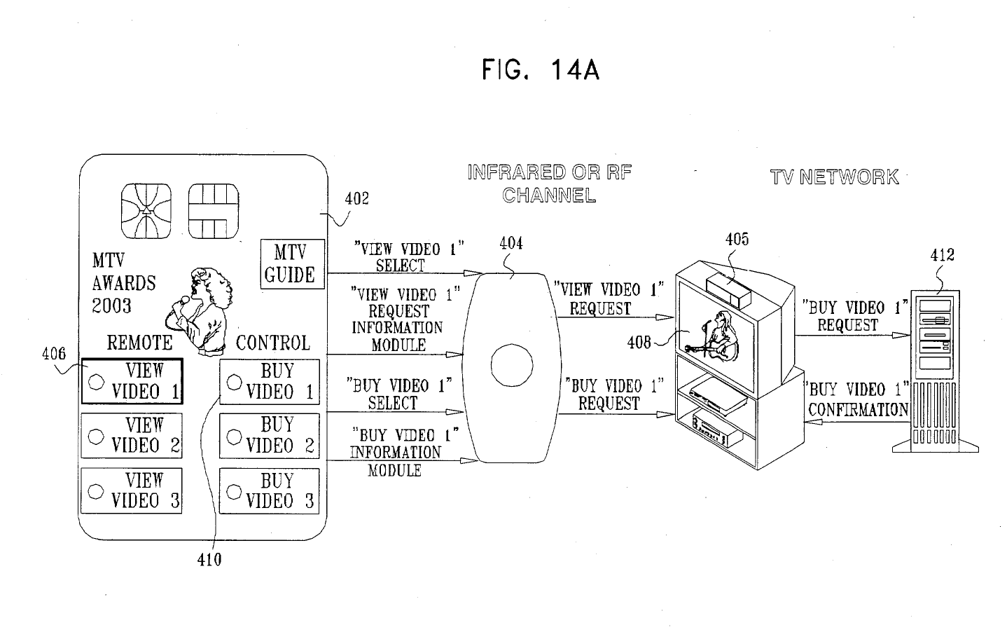

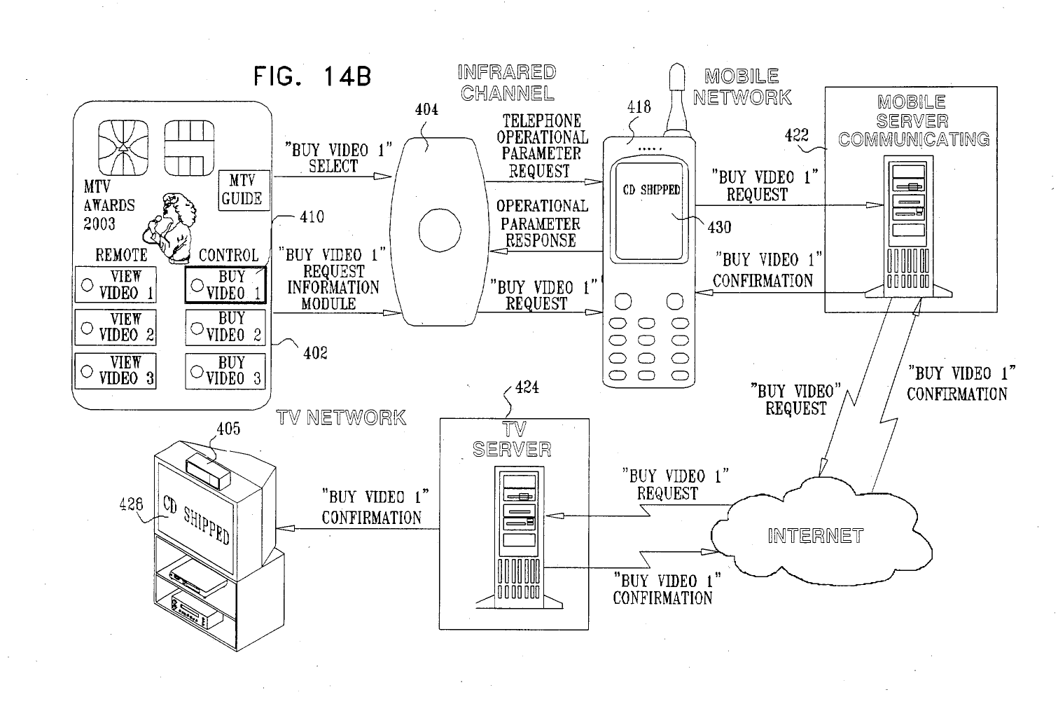

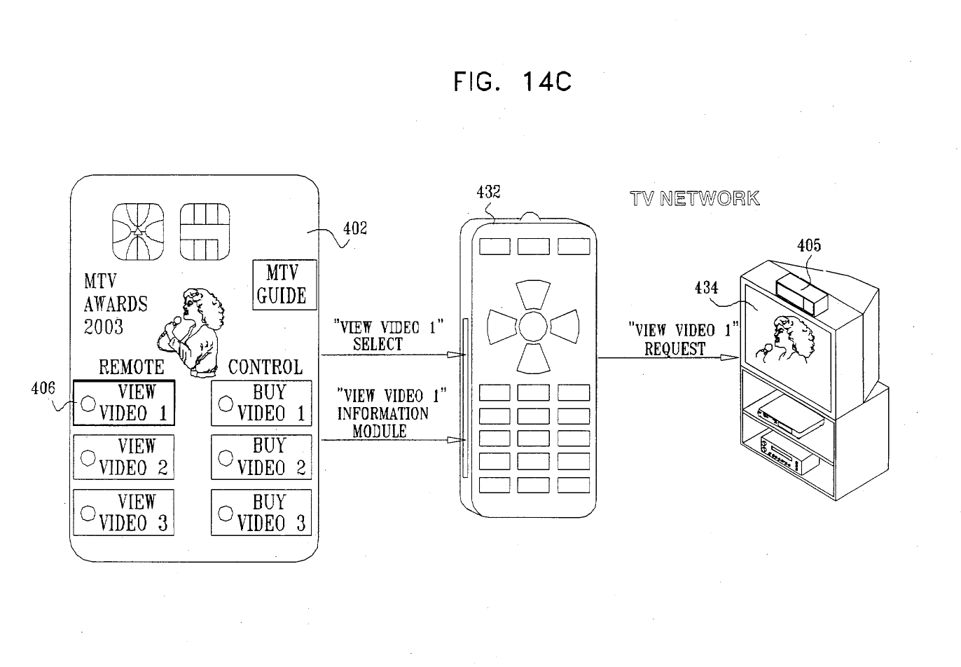

Reference is now made to FIGS. 14A and 14B, which are, taken together, a simplified generalized information flow diagram illustration of operation of the selectable functionality communication system of FIGS. 4A-4C. Turning to FIG. 14A, which corresponds to FIG. 4B, it is seen that in response to a user's pressing on the “VIEW VIDEO 1” button 406, a “VIEW VIDEO 1” select information module is transmitted from the card 402 to the facilitator 404, causing the facilitator 404 to pull from card 402 a “VIEW VIDEO 1” request information module.

The facilitator 404 preferably communicates via an infrared or RF channel with an interactive television device such as a set top box 405, which transmits a “VIEW VIDEO 1” request to a set top box 405. The set top box 405 displays the requested music video clip on the television screen, as designated by reference number 408.

It is also seen that in response to a user's pressing on the “BUY VIDEO 1” button 410 a “BUY VIDEO 1” select information module is transmitted from the card 402 to the facilitator 404, causing the facilitator 404 to pull from card 402 a “BUY VIDEO 1” request information module.

The facilitator 404, preferably communicating via infrared or RF channel with an interactive television device such as a set top box 405, transmits a “BUY VIDEO 1” video request to a set top box 405. The set top box 405, in turn, communicates via a cable or satellite TV network or any other suitable return channel, the “BUY VIDEO 1” request to TV network server 412, which in turn, transmits an order receipt confirmation that is displayed on the TV screen. A service center responds to the “BUY VIDEO 1” request transmitted by the server 412 and arranges for delivery of the music clip compact disk.

In FIG. 14B, which corresponds to FIG. 4C, it is seen that in response to a user's pressing on the “BUY VIDEO 1” button 412, a “BUY VIDEO 1” select information module is transmitted from the card 402 to the facilitator 404, causing the facilitator 404 to pull from card 402, a “BUY VIDEO 1” request information module.

The facilitator 404, preferably communicating via an infrared channel with telephone 418, requests certain operational parameters regarding the telephone and receives suitable responses. Upon receipt of these responses, the facilitator 404 transmits a “BUY VIDEO 1” request to the telephone 418 in a format suitable for the telephone, causing the telephone 418, in turn, to communicates via a mobile network, the “BUY VIDEO 1” request to mobile communications server 422 which communicates, via the Internet, with TV network server 4240. Server 420 communicates, via a cable or satellite TV network or any other return channel network with set top box 405 to communicate a “BUY VIDEO 1” video response, as designated by reference number 428.

The mobile communications server provides a “BUY VIDEO 1” request acknowledgement, which is displayed on the telephone 418, as designated by reference number 426.

Reference is now made to FIG. 14C, which is a simplified generalized information flow diagram illustration of operation of the selectable functionality communication system of FIGS. 4D and 4E. Turning to FIG. 14C, which corresponds to FIG. 4E, it is seen that in response to a user's pressing on the “VIEW VIDEO 1” button 406, a “VIEW VIDEO 1” select information module is transmitted from the card 402 to the television's card enabled set top box remote controller 432, causing the remote control 432 to pull from card 402 a “VIEW VIDEO 1 information module.

The card enabled set top box remote controller 432, preferably communicating, via an infrared or RF channel, with an interactive television device such as a set top box 405, which transmits a “VIEW VIDEO” video request to a set top box 405. The set top box 405 displays the requested video clip on the television screen, as designated by reference number 434.

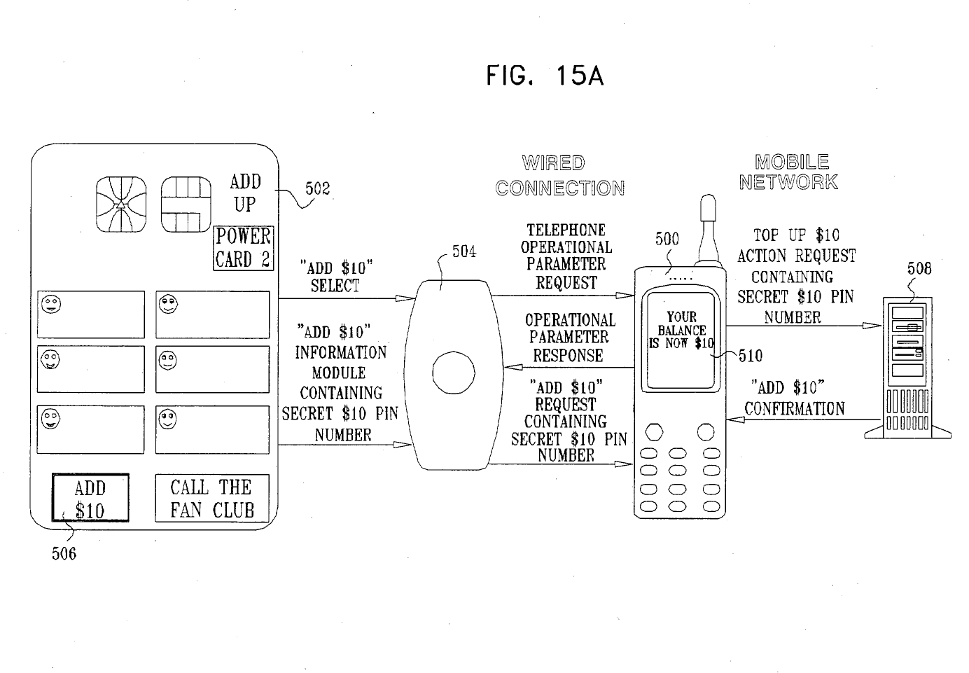

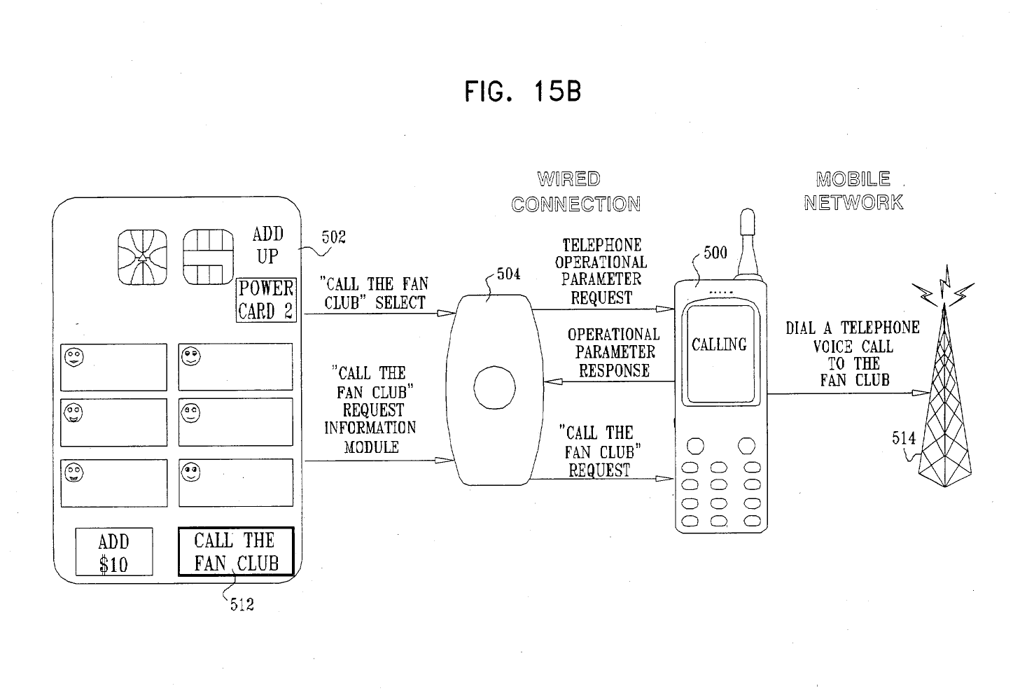

Reference is now made to FIGS. 15A and 15B, which are, taken together, a simplified generalized information flow diagram illustration of operation of the selectable functionality mobile communication system of FIGS. 5A-5C. Turning to FIG. 15A, which corresponds to FIG. 5B, it is seen that in response to a user's pressing on the “ADD $10” request button 506, an “ADD $10” request containing a secret PIN (Personal Identification Number) select information module is transmitted from the card 502 to the facilitator 504, causing the facilitator 504 to pull from card 502, an “ADD $ 10” information module containing the appropriate PIN.

The facilitator 504, preferably communicating via a wired connection with telephone 500, requests certain operational parameters regarding the telephone and receives suitable responses. Upon receipt of these responses, the facilitator 504 transmits an “ADD $10” request containing the corresponding secret “ADD $10” PIN number to the telephone 500 in a format suitable for the telephone, causing the telephone 500, in turn, to communicate via a mobile network, an “ADD $10” request and a corresponding “ADD $10” secret PIN number to server 508. The server provides credits the requested “ADD $10” crediting confirmation, which is displayed on the telephone 500, as designated by reference number 510.

In FIG. 15B, which corresponds to FIG. 5C, it is seen that in response to a user's pressing on the “CALL THE FAN CLUB” request button 512, a “CALL THE FAN CLUB” select information module is transmitted from the card 502 to the facilitator 504, causing the facilitator 504 to pull from card 502 a “CALL THE FAN CLUB” information module.

The facilitator 504, preferably communicating via wired connection with telephone 500, requests certain operational parameters regarding the telephone and receives suitable responses. Upon receipt of these responses, the facilitator 504 transmits a “CALL THE FAN CLUB” request to the telephone 500 in a format suitable for the telephone, causing the telephone 500, in turn, via a mobile network 514, to dial a voice call to the fan club destination.

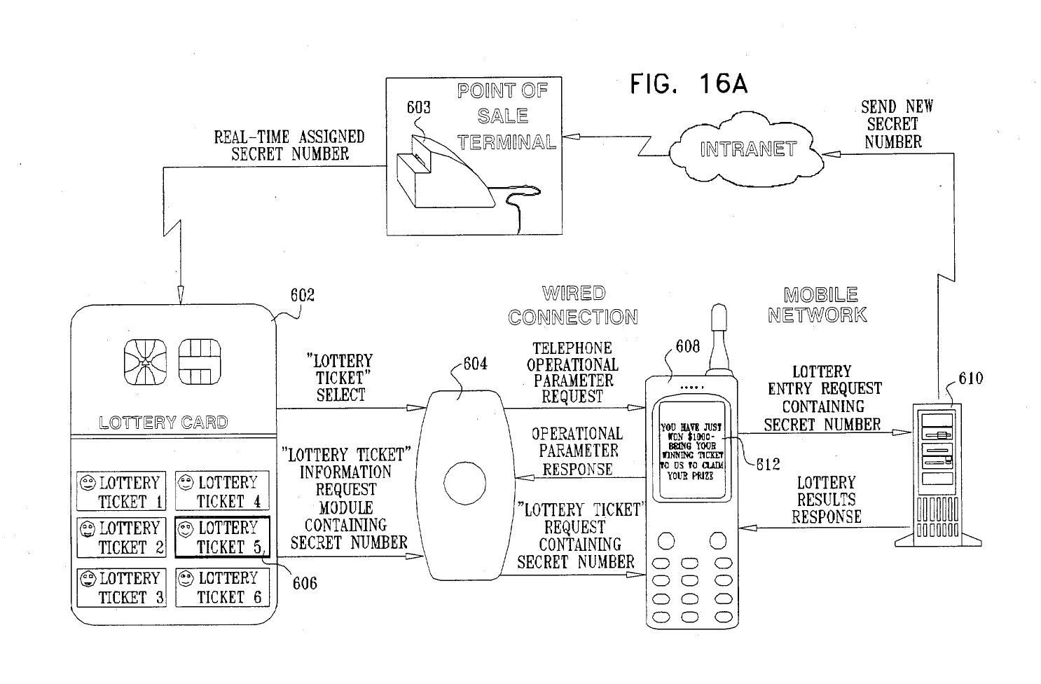

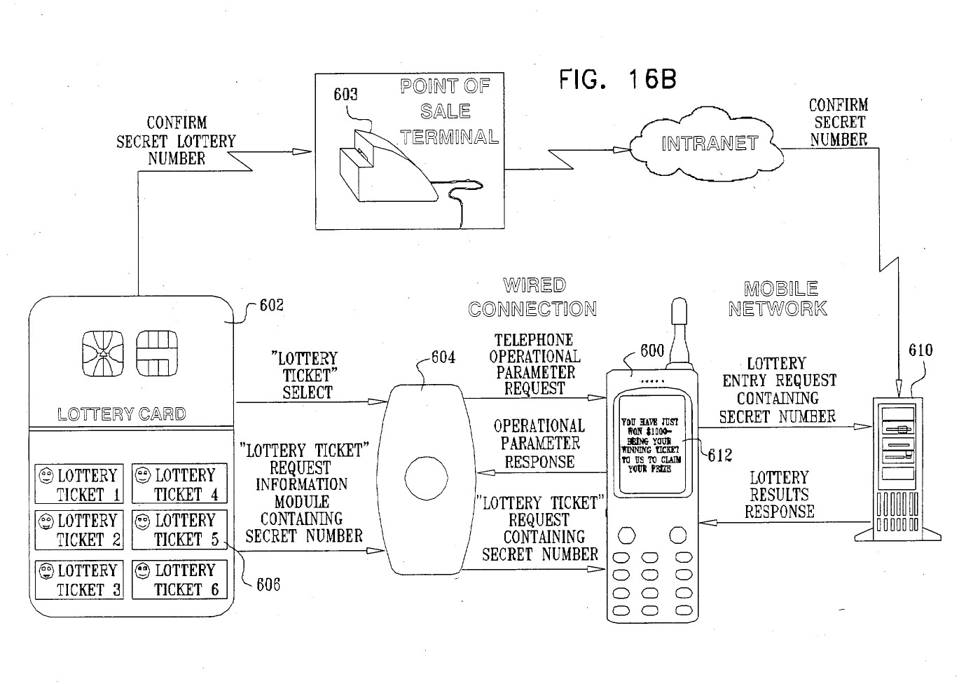

Reference is now made to FIGS. 16A and 16B which are together a simplified generalized information flow diagram illustration of operation of the selectable functionality mobile communication system of FIGS. 6A-6B. Turning to FIG. 16A, which corresponds to FIG. 6B, it is seen that the lottery ticket card 602 is issued a secret lottery number at the point-of-sale terminal 603. In response to a user's pressing on the “LOTTERY TICKET” button 606, a lottery ticket draw entry request select information module, containing a secret lottery number is transmitted from the card 602 to the facilitator 604, causing the facilitator 604 to pull from card 602, a lottery ticket draw entry request information module containing a secret lottery number.

The facilitator 604, preferably communicating via a wired connection with telephone 608, requests certain operational parameters regarding the telephone and receives suitable responses. Upon receipt of these responses, the facilitator 604 transmits a lottery ticket draw entry request containing a secret lottery number to the telephone 608 in a format suitable for the telephone, causing the telephone 608, in turn, to communicates via a mobile network, a lottery ticket draw entry request containing a secret lottery number to server 610. The server provides the requested lottery results, which are displayed on the telephone 608, as designated by reference number 612.The server 610 transmits a new secret lottery number to the point-of-sale terminal 603, via the intranet.

FIG. 16B is an alternative simplified generalized information flow diagram illustration of operation of the selectable functionality mobile communication system of FIGS. 6A-6B. In FIG. 16B it is seen that a lottery ticket, already containing a secret lottery number is confirmed and activated at a point-of-sale terminal 603. In response to a user, pressing on the “LOTTERY TICKET” button 606, a lottery ticket, which already contains a secret lottery number entry request select information module, containing a secret lottery number is transmitted from the card 602 to the facilitator 604, causing the facilitator 604 to pull from card 602, a lottery ticket draw entry request information module containing a secret lottery number.

The facilitator 604, preferably communicating via a wired connection with telephone 608, requests certain operational parameters regarding the telephone and receives suitable responses. Upon receipt of these responses, the facilitator 604 transmits a lottery ticket draw entry request containing a secret lottery number to the telephone 608 in a format suitable for the telephone, causing the telephone 608, in turn, to communicates via a mobile network, a lottery ticket entry request containing a secret lottery number to server 610. The server provides the requested lottery results, which are displayed on the telephone 608 screen, as designated by reference number 612.The point-of-sale 603 activates a new secret lottery number at the server 610.

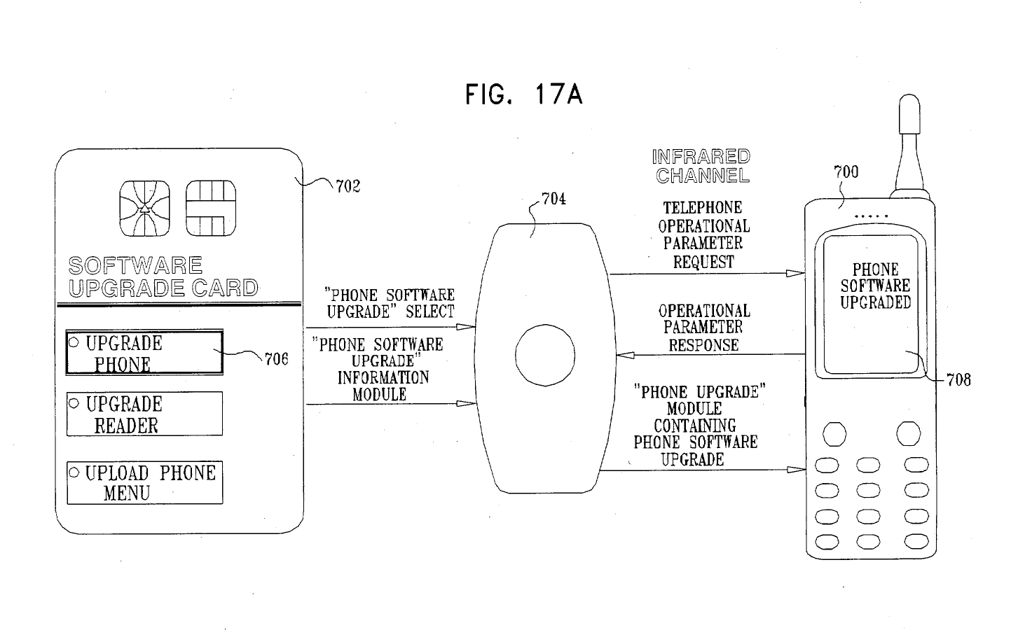

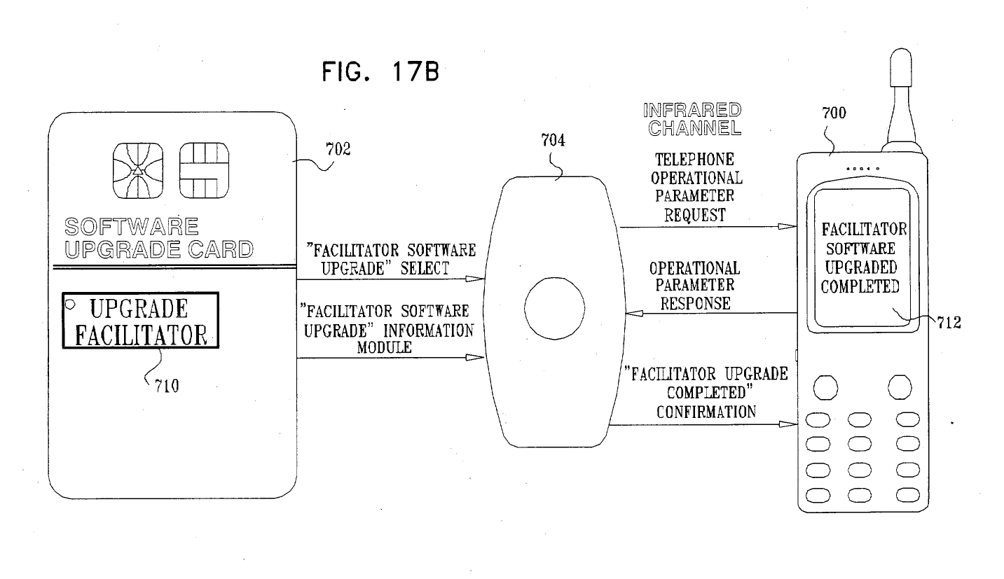

Reference is now made to FIGS. 17A and 17B, which are together a simplified generalized information flow diagram illustration of operation of the selectable functionality mobile communication system of FIGS. 7A-7C. As seen in FIG. 17A, which corresponds to FIG. 7B, in response to a user pressing a “UPGRADE PHONE” button 706, a selected phone upgrade software information module is transmitted from the card 702 to the facilitator 704, causing the facilitator 704 to pull from card 702, a phone upgrade information module containing the selected phone upgrade software.

The facilitator 704, preferably communicating via an infrared channel with telephone 700, requests certain operational parameters regarding the telephone and receives suitable responses. Upon receipt of these responses, the facilitator 704 transmits phone upgrade software information containing the selected phone upgrade in a format suitable for use by telephone 700. This phone upgrade information may be identical to that received from card 702 or may have undergone processing in the facilitator 704 in order to adapt it to telephone 700.

Turning to FIG. 17B, which corresponds to FIG. 7C, in response to a user's pressing on the “UPGRADE FACILITATOR” button 710, a selected facilitator upgrade software information module is transmitted from the card 702 to the facilitator 704, causing the facilitator 704 to pull from card 702, a facilitator upgrade information module containing the selected facilitator upgrade software.

The facilitator 704, preferably communicating via an infrared channel with telephone 700, requests certain operational parameters regarding the telephone and receives suitable responses. Upon receipt of these responses, the card 702 transmits facilitator upgrade software information containing the selected facilitator upgrade in a format suitable for use by the facilitator 704. Upon completion of the facilitator software upgrade, the facilitator 704 transmits a confirmation of completion of facilitator software upgrade to the telephone 700. A facilitator software upgrade confirmation is displayed on the telephone screen, as designated in reference number 712.

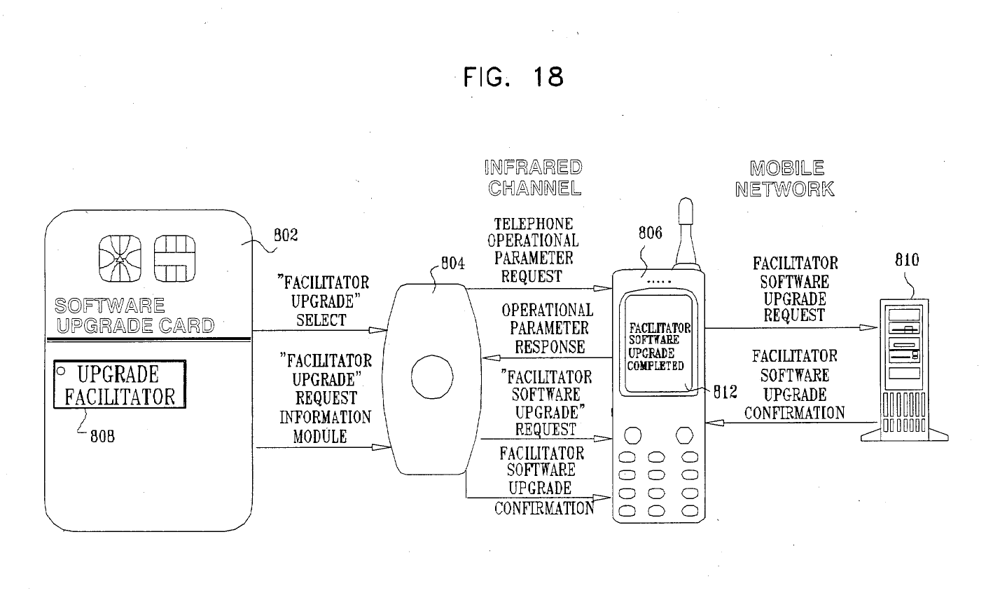

Reference is now made to FIG. 18, which is a simplified generalized information flow diagram illustration of operation of the selectable functionality mobile communication system of FIGS. 8A & 8B and corresponds to FIG. 8B. In response to a user pressing on the “UPGRADE FACILITATOR” button 808, a selected facilitator software upgrade information module is transmitted from the card 802 to the facilitator 804, causing the facilitator 804 to pull from card 802, a facilitator software upgrade request information module containing the selected facilitator upgrade software.

The facilitator 804, preferably communicating via an infrared channel with telephone 806, requests certain operational parameters regarding the telephone and receives suitable responses. Upon receipt of these responses, the facilitator 804 transmits facilitator software upgrade information containing the selected facilitator software upgrade request in a format suitable for use by telephone 806, causing the telephone 806, in turn, to communicate via a mobile network a facilitator software upgrade request to server 810. The server 810 provides the requested facilitator software upgrade via a mobile network to the telephone 806.The telephone, in turn, transmits to the facilitator 804, the facilitator software upgrade software information in a format suitable for use by the facilitator 804. Upon completion of the facilitator software upgrade, the facilitator 804 transmits a confirmation of completion of facilitator software upgrade to the telephone 806. A facilitator software upgrade confirmation is displayed on the telephone screen, as designated in reference number 812.

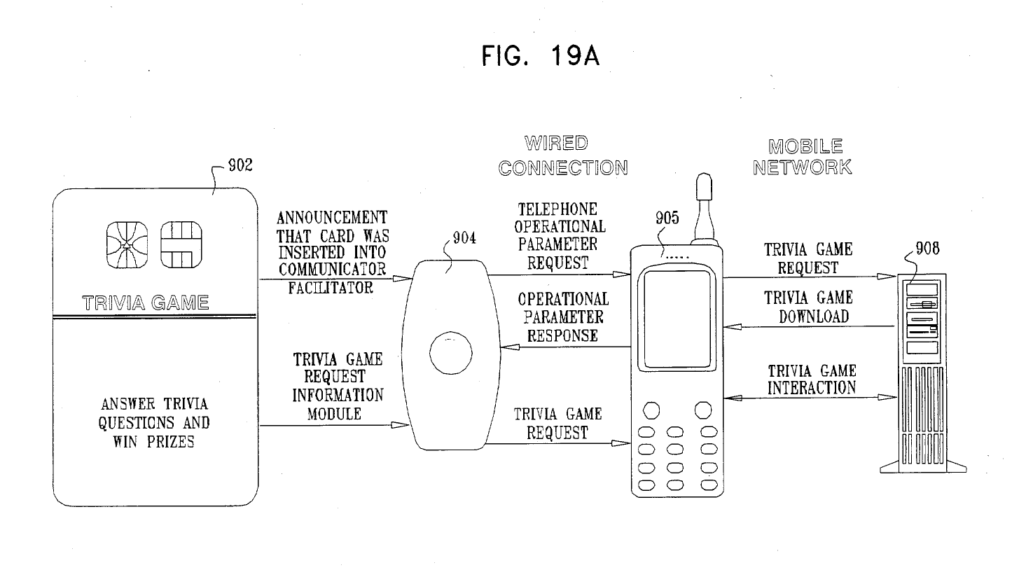

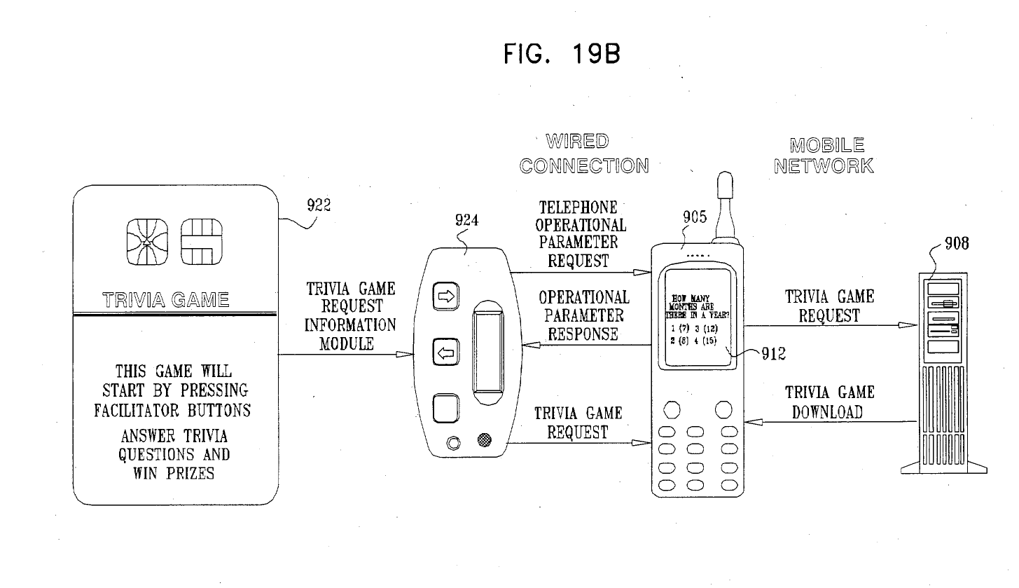

Reference is now made to FIG. 19A, which is a simplified generalized information flow diagram illustration of operation of the selectable functionality mobile communication system of FIGS. 9A and 9B and corresponds to FIG. 9B. It is seen that in response to a user inserting a trivia game card 902 into a facilitator 904 a selected information module is transmitted from the card 902 to the facilitator 904, causing the facilitator 904 to pull from card 902, a “TRIVIA GAME” request information module and notification that the card 902 was inserted into the interface card/mobile telephone communication facilitator 904.

The facilitator 904, preferably communicating via wired connection with telephone, 905, requests certain operational parameters regarding the telephone and receives suitable responses. Upon receipt of these responses, the facilitator 904 transmits a “TRIVIA GAME” request to the telephone 905 in a format suitable for the telephone, causing the telephone 905, in turn, to communicates via a mobile network, a “TRIVIA GAME ” request to server 908. The server downloads the requested “TRIVIA GAME”, an initial screen of which is displayed on the telephone 905, as designated by reference number 910. In response to a user's input via the telephone 905, the trivia game may be played interactively as indicated by reference number 912.

Reference is now made to FIGS. 19B which is a simplified generalized information flow diagram illustration of operation of the selectable functionality mobile communication system of FIGS. 9A, 9C and 9D and which corresponds to FIGS. 9C and 9D. It is seen that in response to a user pressing a button on facilitator 904, a selected information module is transmitted from the card 902 to the facilitator 904, causing the facilitator 904 to pull from card 902, a “TRIVIA GAME” request information module.

The facilitator 904, preferably communicating via a wired connection with telephone 905, requests certain operational parameters regarding the telephone and receives suitable responses. Upon receipt of these responses, the facilitator 904 transmits a “TRIVIA GAME” request to the telephone 905 in a format suitable for the telephone, causing the telephone 905, in turn, to communicates via a mobile network, a “TRIVIA GAME” request to server 908. The server downloads the requested “TRIVIA GAME”.

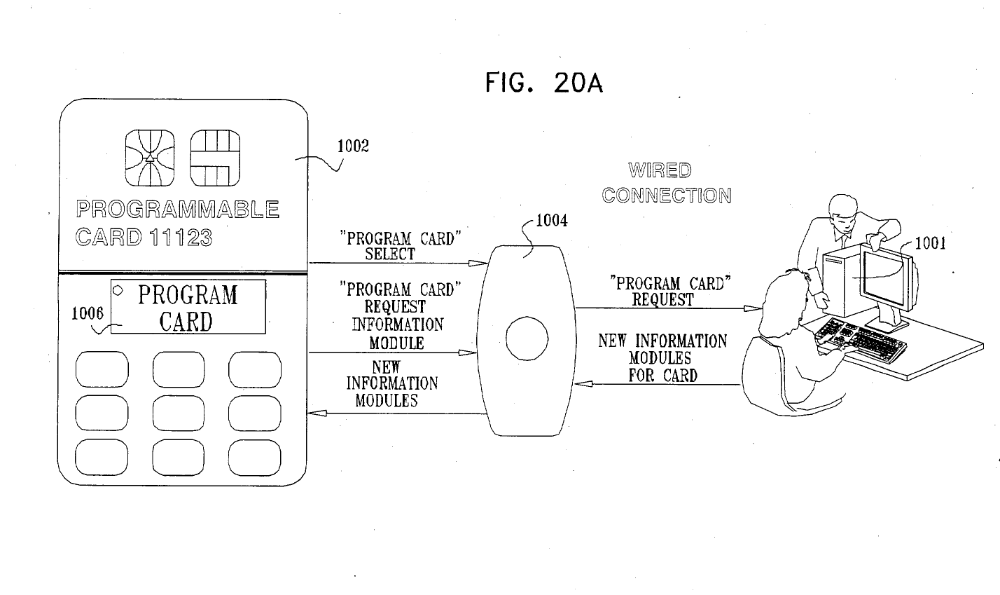

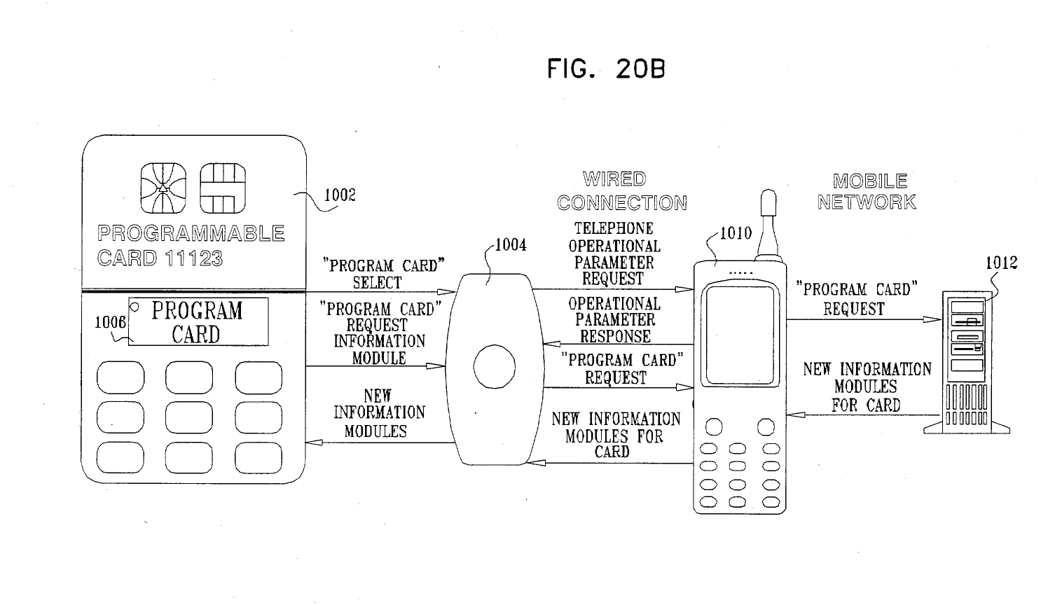

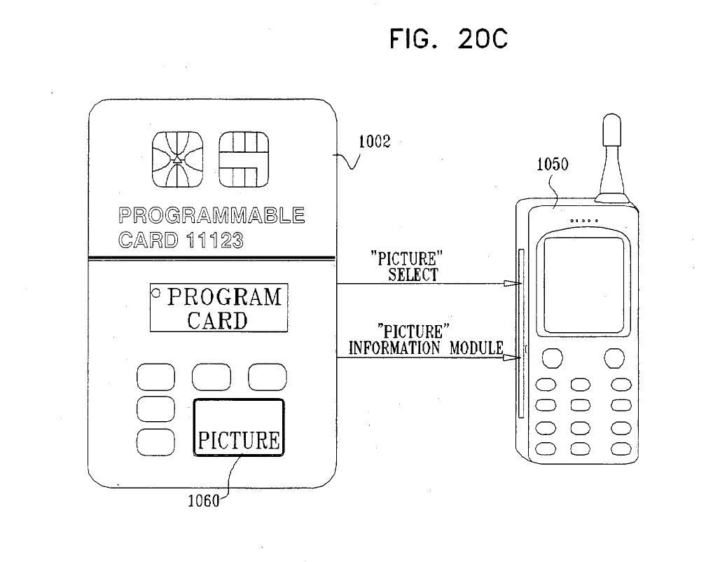

Reference is now made to FIGS. 20A and 20B, which are a simplified generalized information flow diagram illustrations of operation of the selectable functionality communication system of FIGS. 10A-10C. As seen in FIG. 20A, which corresponds to FIG. 10B, in response to a user's pressing on the “PROGRAM CARD” button 1006, a PROGRAM CARD request information module is transmitted from the card 1002 to the facilitator 1004, causing the facilitator 1004 to pull from card 1002, a “PROGRAM CARD” request information module specifying one or more selected information modules.

The facilitator 1004, preferably communicating via a physical connection with the computer 1010, requests programming of the card 1002 with one or more new information modules. Upon receipt of this request, the computer 1001 transmits software information containing the selected information modules, in a format suitable for use by the card 1002. Upon completion of the programming of new information modules the computer 1001 displays a confirmation of completion of the card programming on the screen of computer 1001, as designated by reference numeral 1008.

Turning to FIG. 20B, which corresponds to FIG. 10C, in response to a user's pressing on the PROGRAM CARD button 1006, a PROGRAM CARD request information module is transmitted from the card 1002 to the facilitator 1004, causing the facilitator 1004 to pull from card 1002, a “PROGRAM CARD” request information module specifying one or more selected information modules.

The facilitator 1004, preferably communicating via a wired connection with telephone 1010, requests certain operational parameters regarding the telephone and receives suitable responses. Upon receipt of these responses, the facilitator 1004 transmits the PROGRAM CARD request information module in a format suitable for use by telephone 1010, causing the telephone 1010, in turn, to communicate via a mobile network a card programming request to the server 1012. The server 1012 provides the requested new information modules, which may be downloaded to or via server 1012 from the Internet site that has simulated programmable cards. The server 1012 transmits the new information modules via a mobile network to the telephone 1010. The telephone, in turn, transmits the requested new information modules in a format suitable for use by card 1002. Upon completion of the card programming, the card 1002 transmits a confirmation of completion of card programming to the telephone 1010. A card programming confirmation is displayed on the telephone screen, as designated in reference number 1014.

Reference is now made to FIG. 20C, which is a simplified generalized information flow diagram illustration of operation of the selectable functionality mobile communication system of FIGS. 10D and 10E. As seen in FIG. 20C, which corresponds to FIG. 10E, in response to a user's pressing on the “PICTURE” button 1060, a image select information module is transmitted from the card 1002 to the telephone 1058, causing the telephone to pull from card 1002, an image information module containing the selected image.

The card 1002 transmits visual information containing the selected image in a format suitable for use by telephone 1058 including display and further transmission.

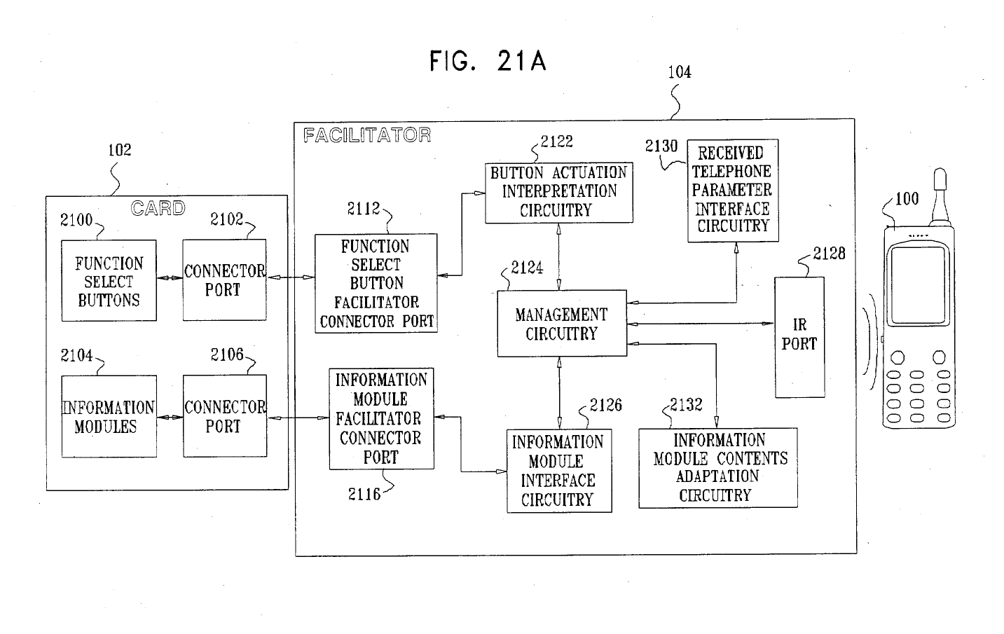

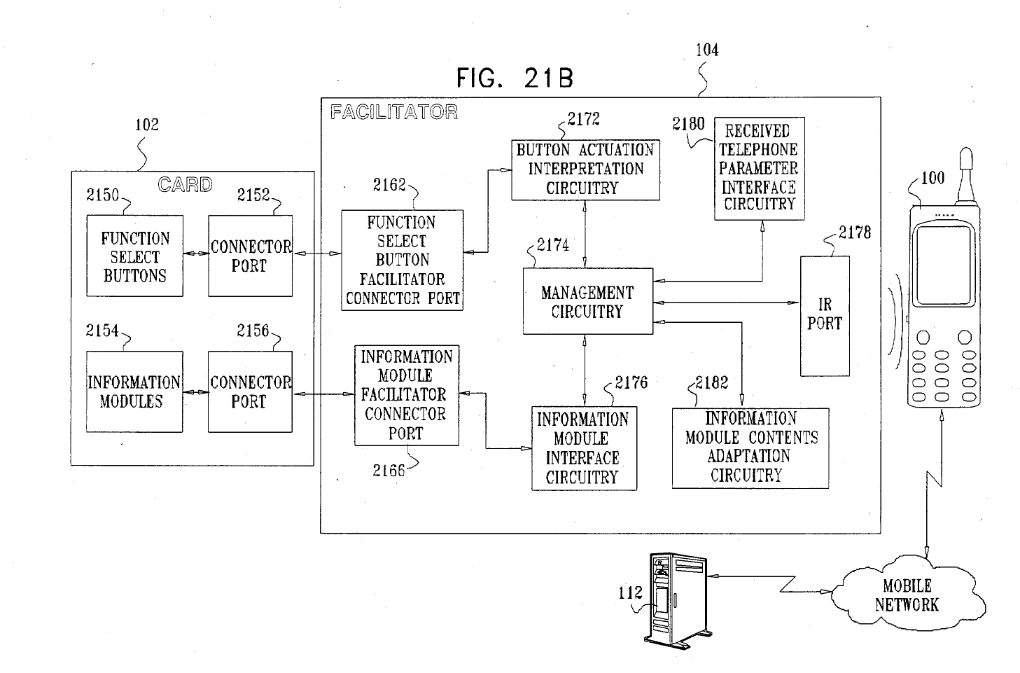

Reference is now made to FIG. 21A, which is a simplified generalized functional block diagram illustration of operation of the selectable functionality mobile communication system of FIGS. 1A, 1B and 11A. As seen in FIG. 21A, which corresponds to FIG. 1B, card 102 preferably comprises function select buttons 2100 which communicate with a connector port 2102 and a plurality of information modules 2104, which separately communicate with a connector port 2106.

Facilitator 104 correspondingly includes a function select button facilitator connector port 2112 and an information module facilitator connector port 2116. Port 2112 communicates with connector port 2102 on card 102 and with button actuation interpretation circuitry 2122, which in turn communicates with management circuitry 2124. A preferred functionality of facilitator 104 is for management circuitry 2124 to intermittently trigger button actuation interpretation circuitry 2122 to intermittently inquire as to whether any button has been actuated. In practice, where electrical connections between the function select buttons 2100 and the connector port 2102 in the card 102 are arranged in a matrix, this may be achieved by applying voltage to one or more of the electrical contacts in connector port 2102 and sensing the voltage on one or more other electrical contacts in connector port 2102, thereby indicating which button was actuated. Button actuation interpretation circuitry 2122 also typically applies long and short duration thresholds to valid button actuation

When a valid button actuation takes place, button actuation interpretation circuitry 2122 informs management circuitry 2124 of the identity of the actuated button. Management circuitry 2124, in turn, instructs information module interface circuitry 2126 to retrieve a corresponding information module from information modules 2104 in card 102, via ports 2106 and 2116. The retrieved information module is typically decompressed and appropriately formatted by information module interface circuitry 2126, which typically also verifies authenticity of the card 102.

Management circuitry 2124 communicates with telephone 100 via an IR port 2128 and requests and receives information relating to specific telephone parameters which affect the form of information uploaded to the telephone. Management circuitry 2124 communicates the received specific telephone parameters to received telephone parameter interface circuitry 2130, which employs the received specific telephone parameters to provide instructions for adaptation of the contents of the retrieved information module to the given telephone. Circuitry 2130 preferably outputs to management circuitry 2124, which provides appropriate instructions to information module contents adaptation circuitry 2132, enabling circuitry 2132 to adapt the contents of the retrieved information module for upload to specific telephone 100.

The output of circuitry 2132 is supplied to management circuitry 2124 which uploads it to telephone 100 via IR port 2128.

In the embodiment of FIGS. 1A, 1B and 11A, actuation of the button 106 causes a selected ringtone to be uploaded to the telephone 100.

Reference is now made to FIG. 21B, which is a simplified generalized functional block diagram illustration of operation of the selectable functionality mobile communication system of FIGS. 1A, 1C, 1D, 11B and 11C. As seen in FIG. 21B, which corresponds to FIGS. 1C & 1D, card 102 preferably comprises function select buttons 2100 which communicate with a connector port 2102 and a plurality of information modules 2104, which separately communicate with a connector port 2106.

Facilitator 104 correspondingly includes a function select button facilitator connector port 2112 and an information module facilitator connector port 2116. Port 2112 communicates with connector port 2102 on card 102 and with button actuation interpretation circuitry 2122, which in turn communicates with management circuitry 2124. A preferred functionality of facilitator 104 is for management circuitry 2124 to intermittently trigger button actuation interpretation circuitry 2122 to intermittently inquire as to whether any button has been actuated. In practice, where electrical connections between the function select buttons 2100 and the connector port 2102 in the card 102 are arranged in a matrix, this may be achieved by applying voltage to one or more of the electrical contacts in connector port 2102 and sensing the voltage on one or more other electrical contacts in connector port 2102, thereby indicating which button was actuated. Button actuation interpretation circuitry 2122 also typically applies long and short duration thresholds to valid button actuation.

When a valid button actuation takes place, button actuation interpretation circuitry 2122 informs management circuitry 2124 of the identity of the actuated button. Management circuitry 2124, in turn, instructs information module interface circuitry 2126 to retrieve a corresponding information module from information modules 2104 in card 102, via ports 2106 and 2116. The retrieved information module is typically decompressed and appropriately formatted by information module interface circuitry 2126, which typically also verifies authenticity of the card 102.

Management circuitry 2124 communicates with telephone 100 via an IR port 2128 and requests and receives information relating to specific telephone parameters which affect the form of information uploaded to the telephone. Management circuitry 2124 communicates the received specific telephone parameters to received telephone parameter interface circuitry 2130, which employs the received specific telephone parameters to provide instructions for adaptation of the contents of the retrieved information module to the given telephone. Circuitry 2130 preferably outputs to management circuitry 2124, which provides appropriate instructions to information module contents adaptation circuitry 2132, enabling circuitry 2132 to adapt the contents of the retrieved information module for upload to specific telephone 100 in the form of a request to be communicated via the telephone 100 to a remote server 112. The request is intended to cause the remote server 112 to download content to telephone 100. The output of circuitry 2132 is supplied to management circuitry 2124, which uploads it to telephone 100 via IR port 2128.

In the embodiment of FIGS. 1A, 1C and 11B, actuation of the button 114 causes a selected video clip to be downloaded to the telephone 100 from remote server 112.

In the embodiment of FIGS. 1A & 1D and 11C, actuation of the button 120 causes selected sports information clip to be downloaded to the telephone 100 from remote server 112.

It is a particular feature of this embodiment of the present invention that only a relatively small amount of information need be stored in an information module on the card 102 in order to produce download of a potentially large amount of information from a remote server. It is appreciated that the content to be downloaded to the telephone from the remote server may thus be dynamic and need not even exist at the time that the card is distributed to users.

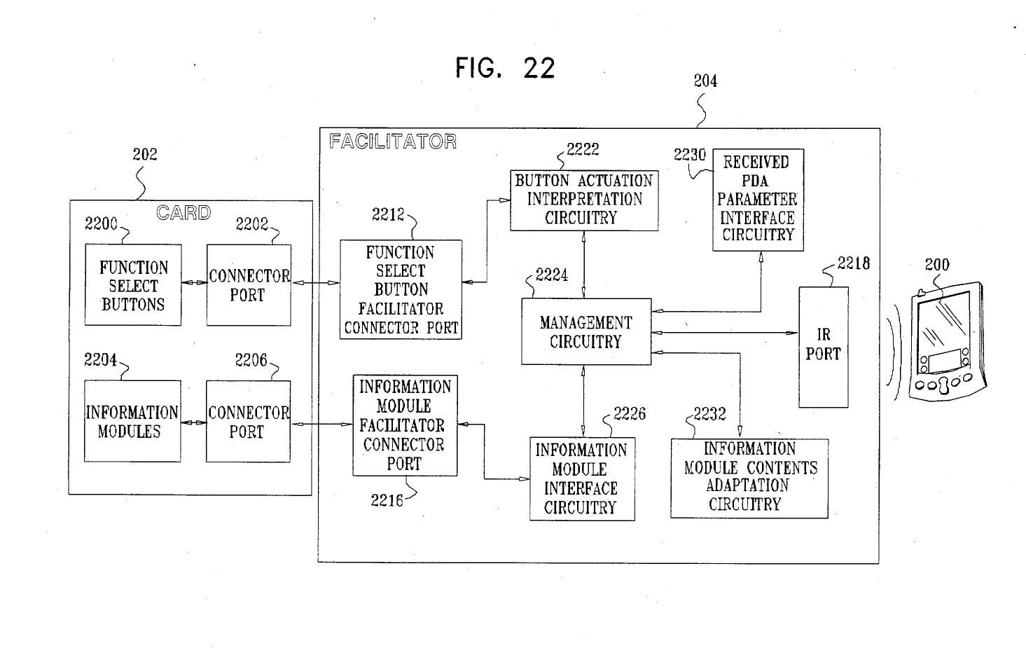

Reference is now made to FIG. 22, which is a simplified generalized functional block diagram illustration of operation of the selectable functionality mobile communication system of FIGS. 2A & 2B and 12. As seen in FIG. 22, which corresponds to FIG. 2B, card 202 preferably comprises function select buttons 2200 which communicate with a connector port 2202 and a plurality of information modules 2204, which separately communicate with a connector port 2206.

Facilitator 204 correspondingly includes a function select button facilitator connector port 2212 and an information module facilitator connector port 2216. Port 2212 communicates with connector port 2202 on card 202 and with button actuation interpretation circuitry 2222, which in turn communicates with management circuitry 2224. A preferred functionality of facilitator 204 is for management circuitry 2224 to intermittently trigger button actuation interpretation circuitry 2222 to intermittently inquire as to whether any button has been actuated. In practice, where electrical connections between the function select buttons 2200 and the connector port 2202 in the card 202 are arranged in a matrix, this may be achieved by applying voltage to one or more of the electrical contacts in connector port 2202 and sensing the voltage on one or more other electrical contacts in connector port 2202, thereby indicating which button was actuated. Button actuation interpretation circuitry 2222 also typically applies long and short duration thresholds to valid button actuation

When a valid button actuation takes place, button actuation interpretation circuitry 2222 informs management circuitry 2224 of the identity of the actuated button. Management circuitry 2224, in turn, instructs information module interface circuitry 2226 to retrieve a corresponding information module from information modules 2204 in card 202, via ports 2206 and 2216. The retrieved information module is typically decompressed and appropriately formatted by information module interface circuitry 2226, which typically also verifies authenticity of the card 202.

Management circuitry 2224 communicates with PDA 200 via an RF port, or a BlueTooth port 2228 and requests and receives information relating to specific PDA parameters which affect the form of information uploaded to the telephone. Management circuitry 2224 communicates the received specific PDA parameters to received telephone parameter interface circuitry 2230, which employs the received specific telephone parameters to provide instructions for adaptation of the contents of the retrieved information module to the given PDA. Circuitry 2230 preferably outputs to management circuitry 2224, which provides appropriate instructions to information module contents adaptation circuitry 2232, enabling circuitry 2232 to adapt the contents of the retrieved information module for upload to specific PDA 200.

The output of circuitry 2232 is supplied to management circuitry 2224 which uploads it to PDA 200 via RF port 2128.

In the embodiment of FIGS. 2A & 2B and 12, actuation of the button 206 causes a selected game to be uploaded to the telephone 200.

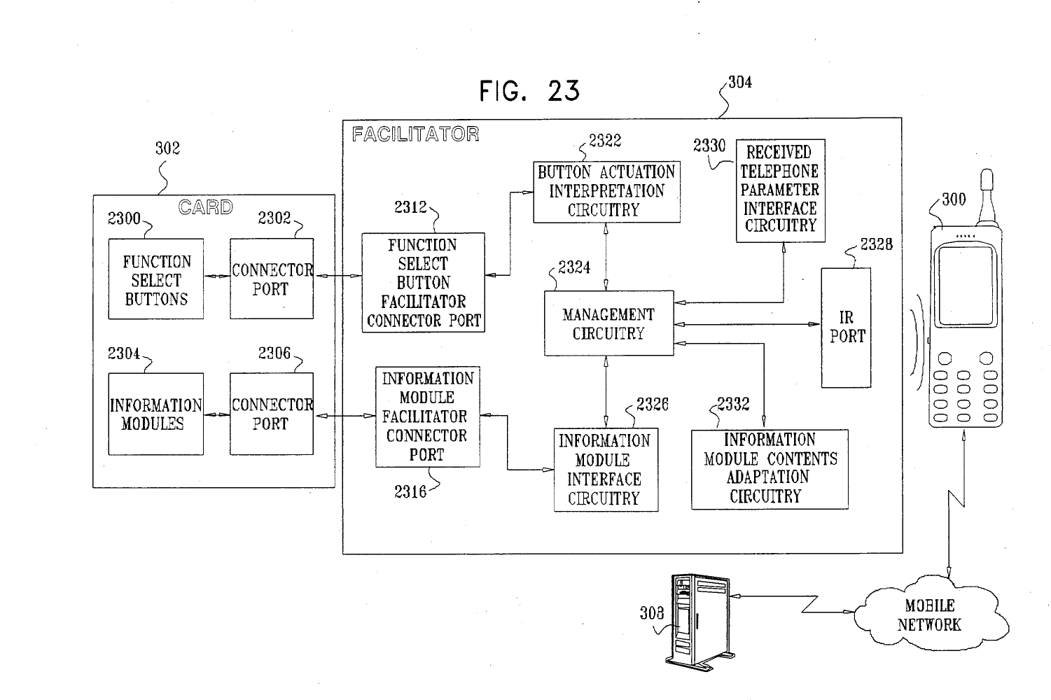

Reference is now made to FIG. 23, which is a simplified generalized functional block diagram illustration of operation of the selectable functionality mobile communication system of FIGS. 3A, 3B, 3C, 13A & 13B. As seen in FIG. 23, which corresponds to FIGS. 3B & 3C, card 302 preferably comprises function select buttons 2300 which communicate with a connector port 2302 and a plurality of information modules 2304, which separately communicate with a connector port 2306.

Facilitator 304 correspondingly includes a function select button facilitator connector port 2312 and an information module facilitator connector port 2316. Port 2312 communicates with connector port 2302 on card 302 and with button actuation interpretation circuitry 2322, which in turn communicates with management circuitry 2324. A preferred functionality of facilitator 304 is for management circuitry 2324 to intermittently trigger button actuation interpretation circuitry 2322 to intermittently inquire as to whether any button has been actuated. In practice, where electrical connections between the function select buttons 2300 and the connector port 2302 in the card 302 are arranged in a matrix, this may be achieved by applying voltage to one or more of the electrical contacts in connector port 2302 and sensing the voltage on one or more other electrical contacts in connector port 2302, thereby indicating which button was actuated. Button actuation interpretation circuitry 2322 also typically applies long and short duration thresholds to valid button actuation

When a valid button actuation takes place, button actuation interpretation circuitry 2322 informs management circuitry 2324 of the identity of the actuated button. Management circuitry 2324, in turn, instructs information module interface circuitry 2326 to retrieve a corresponding information module from information modules 2304 in card 302, via ports 2306 and 2316. The retrieved information module is typically decompressed and appropriately formatted by information module interface circuitry 2326, which typically also verifies authenticity of the card 302.

Management circuitry 2324 communicates with telephone 300 via a wired connection 2328 and requests and receives information relating to specific telephone parameters which affect the form of information uploaded to the telephone. Management circuitry 2124 communicates the received specific telephone parameters to received telephone parameter interface circuitry 2330, which employs the received specific telephone parameters to provide instructions for adaptation of the contents of the retrieved information module to the given telephone. Circuitry 2330 preferably outputs to management circuitry 2324, which provides appropriate instructions to information module contents adaptation circuitry 2332, enabling circuitry 2332 to adapt the contents of the retrieved information module for upload to specific telephone 300 in the the form of a request to be communicated via the telephone 300 to a remote server 308 The request is intended to cause the remote server 308 to download content to telephone 300. The output of circuitry 2332 is supplied to management circuitry 2324 which uploads it to telephone 300 via wired connection 2328.

In the embodiment of FIGS. 3A, 3B and 13A, actuation of the button 306 causes a selected image to be downloaded to the telephone 300 from remote server 308.

In the embodiment of FIGS. 3A, 3C and 13B, actuation of the button 312 causes information to be downloaded to the telephone 300 from remote server 308.

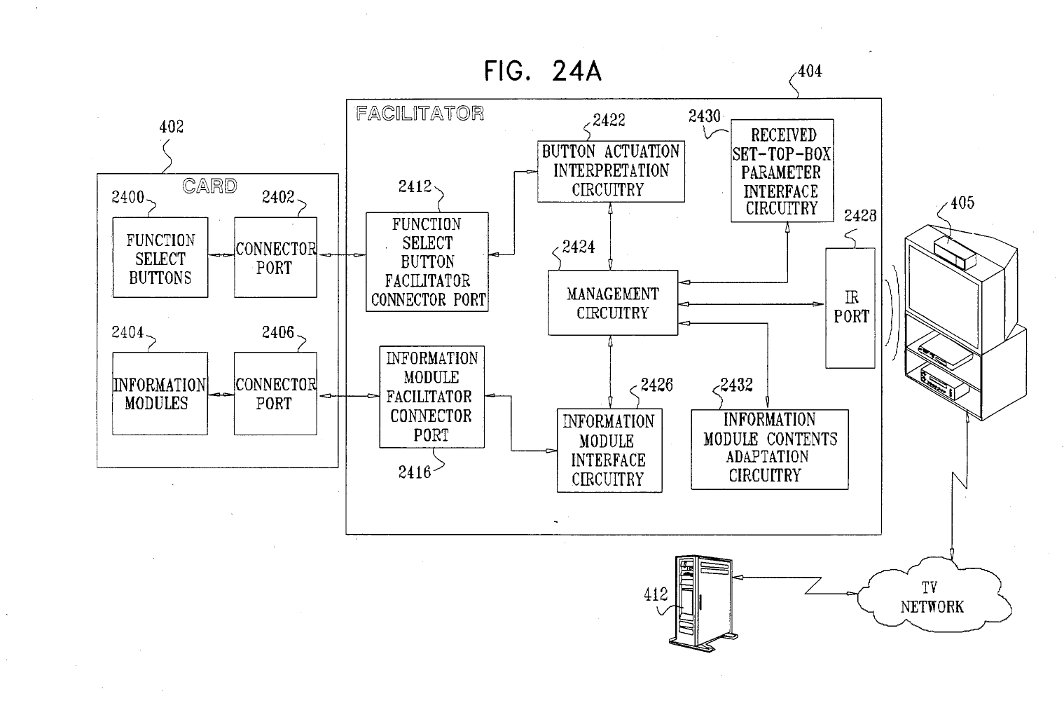

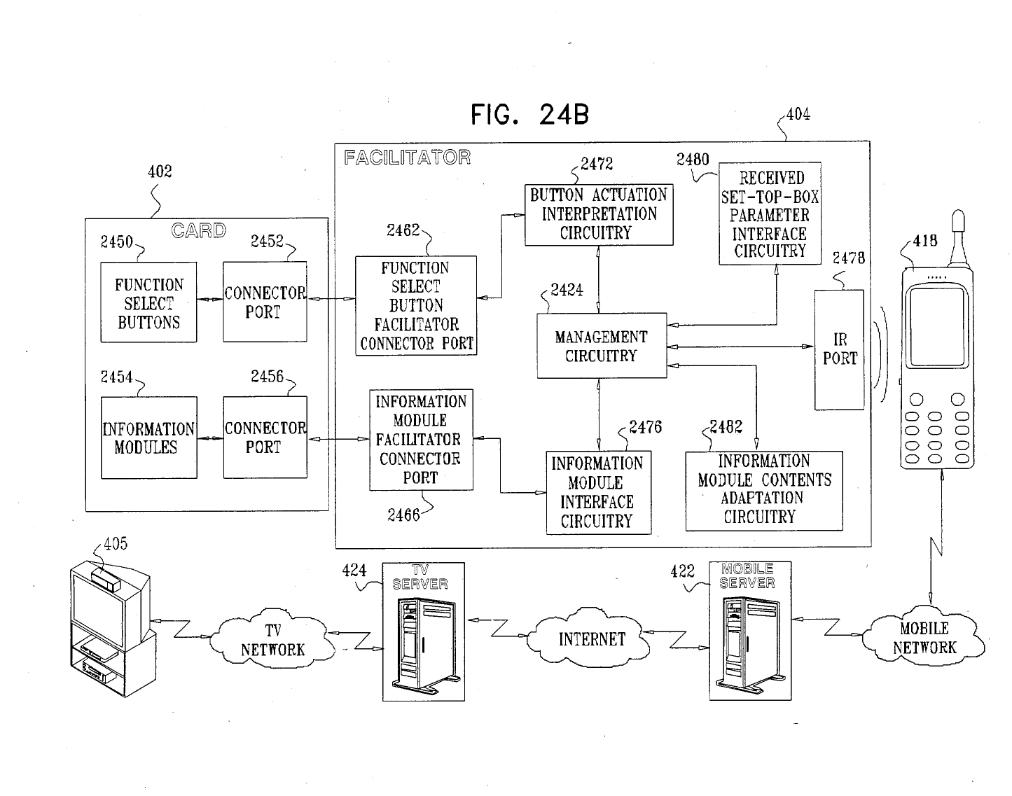

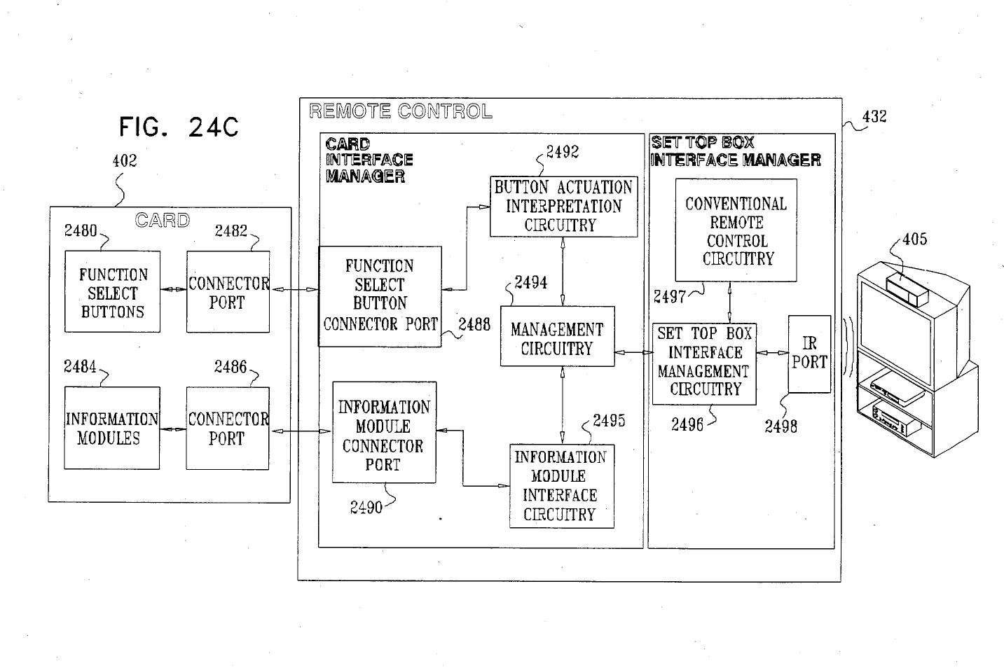

Reference is now made to FIG. 24A, which is a simplified generalized functional block diagram illustration of operation of the selectable functionality mobile communication system of FIGS. 4A, 4B, & 14A. As seen in FIG. 24A, which corresponds to FIG. 4B, card 402 preferably comprises function select buttons 2400 which communicate with a connector port 2402 and a plurality of information modules 2404, which separately communicate with a connector port 2406.

Facilitator 404 correspondingly includes a function select button facilitator connector port 2412 and an information module facilitator connector port 2416. Port 2412 communicates with connector port 2402 on card 402 and with button actuation interpretation circuitry 2422, which in turn communicates with management circuitry 2424. A preferred functionality of facilitator 404 is for management circuitry 2424 to intermittently trigger button actuation interpretation circuitry 2422 to intermittently inquire as to whether any button has been actuated. In practice, where electrical connections between the function select buttons 2400 and the connector port 2402 in the card 402 are arranged in a matrix, this may be achieved by applying voltage to one or more of the electrical contacts in connector port 2402 and sensing the voltage on one or more other electrical contacts in connector port 2402, thereby indicating which button was actuated. Button actuation interpretation circuitry 2422 also typically applies long and short duration thresholds to valid button actuation.

When a valid button actuation takes place, button actuation interpretation circuitry 2422 informs management circuitry 2424 of the identity of the actuated button. Management circuitry 2424, in turn, instructs information module interface circuitry 2426 to retrieve a corresponding information module from information modules 2404 in card 402, via ports 2406 and 2416. The retrieved information module is typically decompressed and appropriately formatted by information module interface circuitry 2426, which typically also verifies authenticity of the card 402.

Management circuitry 2424 communicates with set top box 405 via an IR port 2428 and requests and receives information relating to specific set top box parameters which affect the form of information uploaded to the set top box. Management circuitry 2424 communicates the received specific set top box parameters to received telephone parameter interface circuitry 2430, which employs the received specific set top box parameters to provide instructions for adaptation of the contents of the retrieved information module to the given telephone. Circuitry 2430 preferably outputs to management circuitry 2424, which provides appropriate instructions to information module contents adaptation circuitry 2432, enabling circuitry 2432 to adapt the contents of the retrieved information module for upload to specific set top box 405 in the form of a request to be communicated via the set top box 405 to a remote server 412. The request is intended to cause the remote server 412 to download content to set top box 405. The output of circuitry 2432 is supplied to management circuitry 2424, which uploads it to set top box 405 via IR or RF port 2428.

In the embodiment of FIGS. 4A & 4B and 14A, actuation of the button 406 causes a selected video clip to be displayed on the television screen, via the set top box 405 from remote server 412.

In the embodiment of FIGS. 4A & 4B and 14A, actuation of the button 410 causes a selected video clip purchase order to be placed, via the set top box 405 from remote server 412.

Reference is now made to FIG. 24B, which is a simplified generalized functional block diagram illustration of operation of the selectable functionality mobile communication system of FIGS. 4A, 4C & 14B. As seen in FIG. 24B, which corresponds to FIG. 4C, card 402 preferably comprises function select buttons 2440 which communicate with a connector port 2442 and a plurality of information modules 2444, which separately communicate with a connector port 2446.

Facilitator 404 correspondingly includes a function select button facilitator connector port 2452 and an information module facilitator connector port 2456. Port 2452 communicates with connector port 2442 on card 402 and with button actuation interpretation circuitry 2462, which in turn communicates with management circuitry 2464. A preferred functionality of facilitator 404 is for management circuitry 2464 to intermittently trigger button actuation interpretation circuitry 2462 to intermittently inquire as to whether any button has been actuated. In practice, where electrical connections between the function select buttons 2440 and the connector port 2442 in the card 402 are arranged in a matrix, this may be achieved by applying voltage to one or more of the electrical contacts in connector port 2442 and sensing the voltage on one or more other electrical contacts in connector port 2442, thereby indicating which button was actuated. Button actuation interpretation circuitry 2462 also typically applies long and short duration thresholds to valid button actuation

When a valid button actuation takes place, button actuation interpretation circuitry 2472 informs management circuitry 2464 of the identity of the actuated button. Management circuitry 2464, in turn, instructs information module interface circuitry 2466 to retrieve a corresponding information module from information modules 2444 in card 402, via ports 2446 and 2456. The retrieved information module is typically decompressed and appropriately formatted by information module interface circuitry 2466, which typically also verifies authenticity of the card 402.

Management circuitry 2464 communicates with telephone 418 via an IR port 2468 and requests and receives information relating to specific telephone parameters which affect the form of information uploaded to the set top box. Management circuitry 2464 communicates the received specific telephone parameters to received telephone parameter interface circuitry 2470, which employs the received specific telephone parameters to provide instructions for adaptation of the contents of the retrieved information module to the given telephone. Circuitry 2470 preferably outputs to management circuitry 2464, which provides appropriate instructions to information module contents adaptation circuitry 2472, enabling circuitry 2472 to adapt the contents of the retrieved information module for upload to specific telephone 418 in the form of a request to be communicated via telephone to a remote server 422. The request is intended to cause the remote server 422 to download content to the telephone 418. The output of circuitry 2472 is supplied to management circuitry 2464 which uploads it to the telephone 418 via IR or RF port 2468.

In the embodiment of FIGS. 4A & 4C and 14B, actuation of the button 420 causes a selected video CD purchase order to be placed and a confirmation of the purchase order to be displayed on the television screen, via the set top box 405 which communicates with a TV server 424 that receives the information from a telephone 418, via a mobile server 422.

Reference is now made to FIG. 24C, which is a simplified generalized functional block diagram illustration of operation of the selectable functionality mobile communication system of FIGS. 4D, 4E & 14C. As seen in FIG. 24C, which corresponds to FIGS. 4D and 4E, card 402 preferably comprises function select buttons 2480 which communicate with a connector port 2482 and a plurality of information modules 2484, which separately communicate with a connector port 2486.

Remote control 432 correspondingly includes a function select button connector port 2488 and an information module facilitator connector port 2490. Port 2488 communicates with connector port 2482 on card 402 and with button actuation interpretation circuitry 2492, which in turn communicates with management circuitry 2494. A preferred functionality of the remote control 432 is for management circuitry 2494 to intermittently trigger button actuation interpretation circuitry 2492 to intermittently inquire as to whether any button has been actuated. In practice, where electrical connections between the function select buttons 2400 and the connector port 2402 in the card 402 are arranged in a matrix, this may be achieved by applying voltage to one or more of the electrical contacts in connector port 2482 and sensing the voltage on one or more other electrical contacts in connector port 2482, thereby indicating which button was actuated. Button actuation interpretation circuitry 2492 also typically applies long and short duration thresholds to valid button actuation.

When a valid button actuation takes place, button actuation interpretation circuitry 2492 informs card management circuitry 2494 of the identity of the actuated button. Management circuitry 2494, in turn, instructs information module interface circuitry 2495 to retrieve a corresponding information module from information modules 2484 in card 402, via ports 2486 and 2490. The retrieved information module is typically decompressed and appropriately formatted by information module interface circuitry 2495, which typically also verifies authenticity of the card 402.

Management circuitry 2494 of the card interface manager communicates the information containing the information modules with set top box interface manager via set top box command encoder 2496 on the set top box interface manager. Conventional remote control circuitry 2497 typically also forms part of the set top box interface manager. In the present embodiment the set top box command encoder 2496 does not communicate with the conventional remote control circuitry 2497. The information modules received by the set top box interface management circuitry 2496 are transmitted to set top box 405 via IR transmitter 2498 and cause the set top box to display the music video clip on the display screen 434. The output of management circuitry 2496 is transmitted to set top box 405 via IR transmitter 2498.

In the embodiment of FIGS. 4E & 4D and 14B, actuation of the button 416 causes a selected video clip to be displayed on the television screen 434, via the set top box 405.

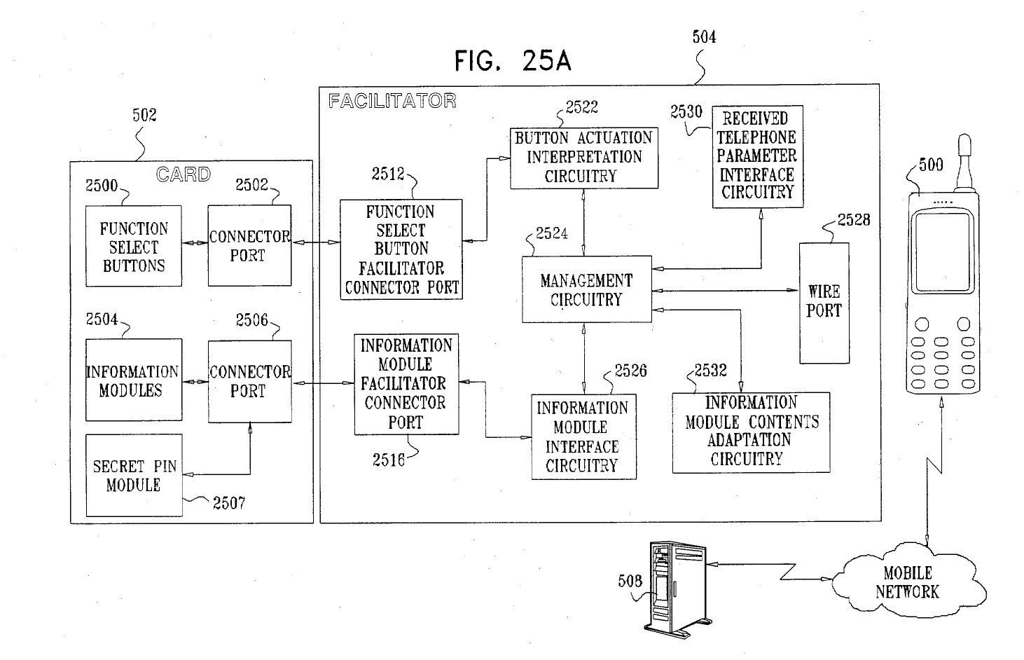

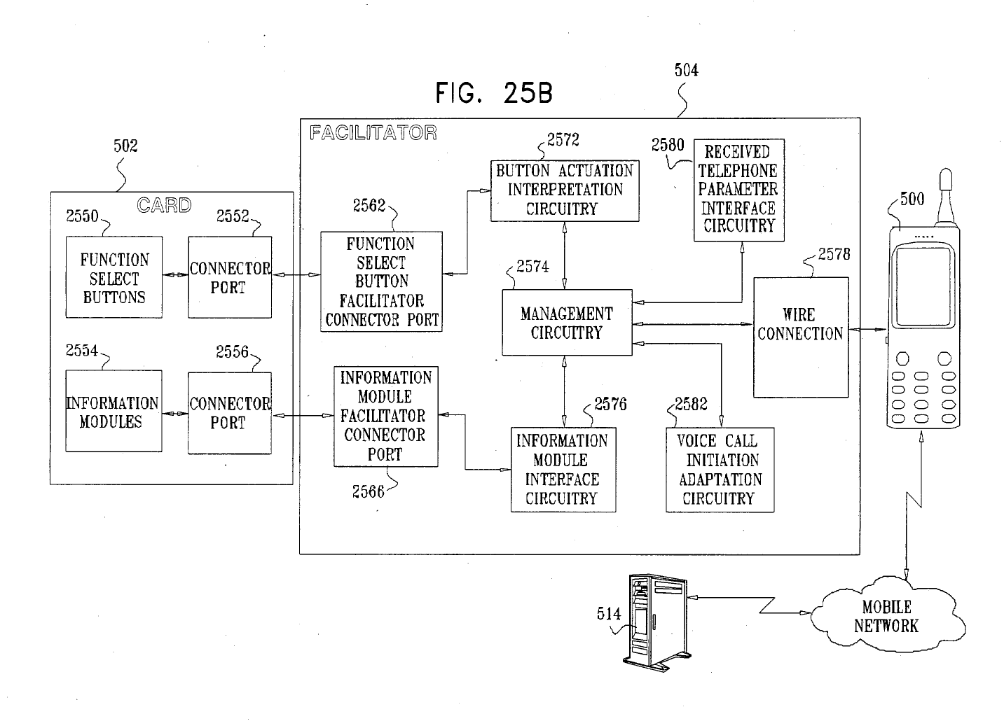

Reference is now made to FIG. 25A, which is a simplified generalized functional block diagram illustration of operation of the selectable functionality mobile communication system of FIGS. 5A, 5B& 15A. As seen in FIG. 25A, which corresponds to FIGS. 5B, card 502 preferably comprises function select buttons 2500 which communicate with a connector port 2502, a plurality of information modules 2504, which separately communicate with a connector port 2506 and a secret PIN module 2507 which communicates with the connector port 2506.

Facilitator 504 correspondingly includes a function select button facilitator connector port 2512 and an information module facilitator connector port 2516. Port 2512 communicates with connector port 2502 on card 502 and with button actuation interpretation circuitry 2522, which in turn communicates with management circuitry 2524. A preferred functionality of facilitator 504 is for management circuitry 2524 to intermittently trigger button actuation interpretation circuitry 2522 to intermittently inquire as to whether any button has been actuated. In practice, where electrical connections between the function select buttons 2500 and the connector port 2502 in the card 502 are arranged in a matrix, this may be achieved by applying voltage to one or more of the electrical contacts in connector port 2502 and sensing the voltage on one or more other electrical contacts in connector port 2502, thereby indicating which button was actuated. Button actuation interpretation circuitry 2522 also typically applies long and short duration thresholds to valid button actuation

When a valid button actuation takes place, button actuation interpretation circuitry 2522 informs management circuitry 2524 of the identity of the actuated button. Management circuitry 2524, in turn, instructs information module interface circuitry 2526 to retrieve a corresponding information module from information modules 2504 in card 502, via ports 2506 and 2516. The retrieved information module is typically decompressed and appropriately formatted by information module interface circuitry 2526, which typically also verifies authenticity of the card 502.

Management circuitry 2524 communicates with telephone 500 via a wired connection 2528 and requests and receives information relating to specific telephone parameters which affect the form of information uploaded to the telephone. Management circuitry 2524 communicates the received specific telephone parameters to received telephone parameter interface circuitry 2530, which employs the received specific telephone parameters to provide instructions for adaptation of the contents of the retrieved information module to the given telephone. Circuitry 2530 preferably outputs to management circuitry 2524, which provides appropriate instructions to information module contents adaptation circuitry 2532, enabling circuitry 2532 to adapt the contents of the retrieved information module for upload to specific telephone 500 in the form of a request to be communicated via the telephone 500 to a remote server 508. The request is intended to cause the remote server 508 to download content to telephone 500. The output of circuitry 2532 is supplied to management circuitry 2524 which uploads it to telephone 500 via wired connection 2528.

In the embodiment of FIGS. 5A & 5B and 15A, actuation of the button 506 causes a balance increase in a prepaid account and a confirmation to be displayed on the telephone screen.

Reference is now made to FIG. 25B, which is a simplified generalized functional block diagram illustration of operation of the selectable functionality mobile communication system of FIGS. 5A, 5C & 15B. As seen in FIG. 25B, which corresponds to FIGS. 5C, card 502 preferably comprises function select buttons 2550 which communicate with a connector port 2552 and a plurality of information modules 2554, which separately communicate with a connector port 2556.

Facilitator 504 correspondingly includes a function select button facilitator connector port 2562 and an information module facilitator connector port 2566. Port 2562 communicates with connector port 2552 on card 502 and with button actuation interpretation circuitry 2572, which in turn communicates with management circuitry 2574. A preferred functionality of facilitator 504 is for management circuitry 2574 to intermittently trigger button actuation interpretation circuitry 2572 to intermittently inquire as to whether any button has been actuated. In practice, where electrical connections between the function select buttons 2550 and the connector port 2552 in the card 502 are arranged in a matrix, this may be achieved by applying voltage to one or more of the electrical contacts in connector port 2552 and sensing the voltage on one or more other electrical contacts in connector port 2552, thereby indicating which button was actuated. Button actuation interpretation circuitry 2572 also typically applies long and short duration thresholds to valid button actuation.

When a valid button actuation takes place, button actuation interpretation circuitry 2572 informs management circuitry 2574 of the identity of the actuated button. Management circuitry 2574, in turn, instructs information module interface circuitry 2576 to retrieve a corresponding information module from information modules 2554 in card 502, via ports 2556 and 2566. The retrieved information module is typically decompressed and appropriately formatted by information module interface circuitry 2576, which typically also verifies authenticity of the card 502.

Management circuitry 2574 communicates with telephone 500 via a wired connection 2578 and requests and receives information relating to specific telephone parameters which affect the form of information uploaded to the telephone. Management circuitry 2574 communicates the received specific telephone parameters to received telephone parameter interface circuitry 2580, which employs the received specific telephone parameters to provide instructions for adaptation of the contents of the retrieved information module to the given telephone. Circuitry 2580 preferably outputs to management circuitry 2574, which provides appropriate instructions to telephone voice call initiation adaptation circuitry 2582, enabling circuitry 2582 to adapt the contents of the retrieved information module for upload to specific telephone 500 in the form of a request to be communicated via the telephone 500 to a remote server 514. The request is intended to cause the remote server 514 to download content to telephone 500. The output of circuitry 2582 is supplied to management circuitry 2574 which uploads it to telephone 500 via wired connection 2578.

In the embodiment of FIGS. 5A & 5B and 15A, actuation of the button 512 causes a telephone voice call to be placed from telephone 500 via remote server 514.

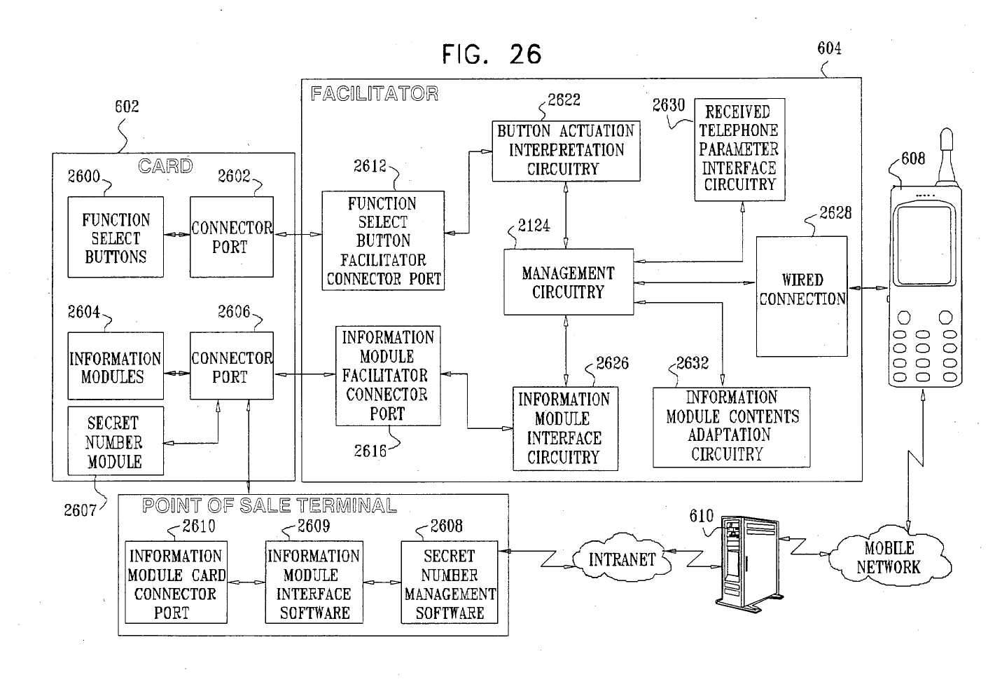

Reference is now made to FIG. 26, which is a simplified generalized functional block diagram illustration of operation of the selectable functionality mobile communication system of FIGS. 6A, 6B, 16A & 16B. As seen in FIG. 26, which corresponds to FIGS. 16A & 16B, card 602 preferably comprises function select buttons 2600 which communicate with a connector port 2602, a plurality of information modules 2604 and a secret number module 2607, which separately communicate with a connector port 2606.

Point-of-sale terminal 603 correspondingly comprises information module card connector port 2608 secret number management software 2608 which communicate with information module interface software 2609 which communicate, in turn, with a information module card connector port 2610. Information module card connector port 2610 communicates with connector port 2606 on card 602.

Facilitator 604 correspondingly includes a function select button facilitator connector port 2612 and an information module facilitator connector port 2616. Port 2612 communicates with connector port 2602 on card 602 and with button actuation interpretation circuitry 2622, which in turn communicates with management circuitry 2624. A preferred functionality of facilitator 604 is for management circuitry 2624 to intermittently trigger button actuation interpretation circuitry 2122 to intermittently inquire as to whether any button has been actuated. In practice, where electrical connections between the function select buttons 2100 and the connector port 2602 in the card 602 are arranged in a matrix, this may be achieved by applying voltage to one or more of the electrical contacts in connector port 2602 and sensing the voltage on one or more other electrical contacts in connector port 2602, thereby indicating which button was actuated. Button actuation interpretation circuitry 2622 also typically applies long and short duration thresholds to valid button actuation.

When a valid button actuation takes place, button actuation interpretation circuitry 2622 informs management circuitry 2624 of the identity of the actuated button. Management circuitry 2624, in turn, instructs information module interface circuitry 2626 to retrieve a corresponding information module from information modules 2604 in card 602, via ports 2606 and 2616. The retrieved information module is typically decompressed and appropriately formatted by information module interface circuitry 2626, which typically also verifies authenticity of the card 602.

Management circuitry 2624 communicates with telephone 608 via wired port 2628 and requests and receives information relating to specific telephone parameters which affect the form of information uploaded to the telephone. Management circuitry 2624 communicates the received specific telephone parameters to received telephone parameter interface circuitry 2630, which employs the received specific telephone parameters to provide instructions for adaptation of the contents of the retrieved information module to the given telephone. Circuitry 2630 preferably outputs to management circuitry 2624, which provides appropriate instructions to information module contents adaptation circuitry 2632, enabling circuitry 2632 to adapt the contents of the retrieved information module for upload to specific telephone 608 in the form of a request to be communicated via the telephone 608 to a remote server 610. The request is intended to cause the remote server 610 to issue the request and display request results on the telephone screen 612. The output of circuitry 2632 is supplied to management circuitry 2624 which uploads it to telephone 608 via wired port 2628.

In the embodiment of FIGS. 6A & 6B and 16A, actuation of the button 606 enables entrance to a lottery game, causes the lottery results to be displayed on the telephone screen 612 and causes the remote server 610 to send a new secret number to the point-of-sale terminal 603.

In the embodiment of FIGS. 6A & 6B and 16B, actuation of the button 606 enables entrance to a lottery game, causes the lottery results to be displayed on the telephone screen 612 and causes the point-of-sale 603 to activate a new secret lottery number at the remote server 610.

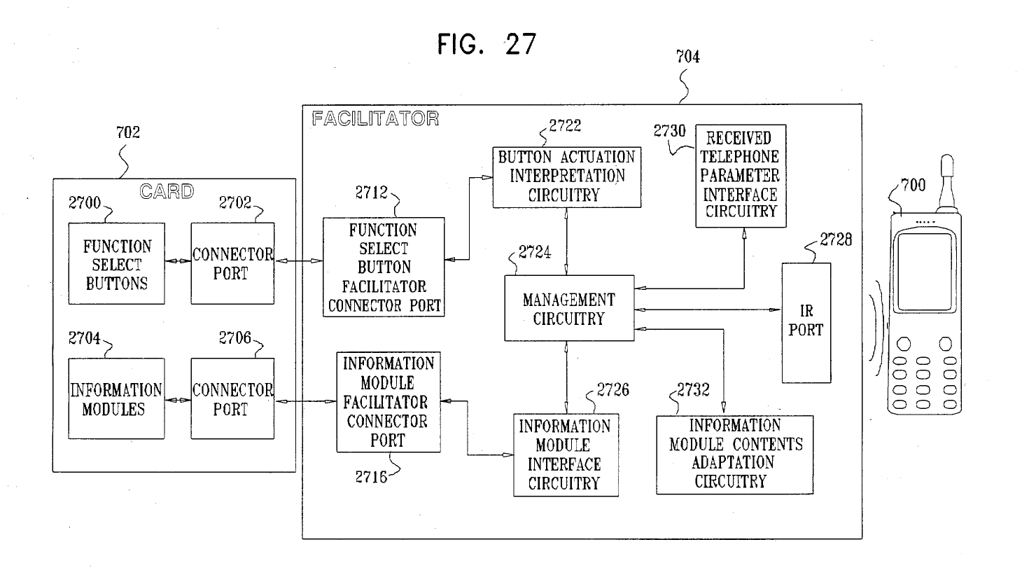

Reference is now made to FIG. 27 which is a simplified generalized functional block diagram illustration of operation of the selectable functionality mobile communication system of FIGS. 7A, 7B, 7C and 17A&17B. As seen in FIG. 27, which corresponds to FIG. 7B & 7C, card 702 preferably comprises function select buttons 2700 which communicate with a connector port 2702 and a plurality of information modules 2704, which separately communicate with a connector port 2706.

Facilitator 704 correspondingly includes a function select button facilitator connector port 2712 and an information module facilitator connector port 2716. Port 2712 communicates with connector port 2702 on card 702 and with button actuation interpretation circuitry 2722, which in turn communicates with management circuitry 2724. A preferred functionality of facilitator 704 is for management circuitry 2724 to intermittently trigger button actuation interpretation circuitry 2722 to intermittently inquire as to whether any button has been actuated. In practice, where electrical connections between the function select buttons 2700 and the connector port 2702 in the card 702 are arranged in a matrix, this may be achieved by applying voltage to one or more of the electrical contacts in connector port 2702 and sensing the voltage on one or more other electrical contacts in connector port 2702, thereby indicating which button was actuated. Button actuation interpretation circuitry 2722 also typically applies long and short duration thresholds to valid button actuation

When a valid button actuation takes place, button actuation interpretation circuitry 2722 informs management circuitry 2724 of the identity of the actuated button. Management circuitry 2724, in turn, instructs information module interface circuitry 2726 to retrieve a corresponding information module from information modules 2704 in card 702, via ports 2706 and 2716. The retrieved information module is typically decompressed and appropriately formatted by information module interface circuitry 2726, which typically also verifies authenticity of the card 702.

Management circuitry 2724 communicates with telephone 700 via an IR port 2728 and requests and receives information relating to specific telephone parameters which affect the form of information uploaded to the telephone. Management circuitry 2724 communicates the received specific telephone parameters to received telephone parameter interface circuitry 2730, which employs the received specific telephone parameters to provide instructions for adaptation of the contents of the retrieved information module to the given telephone. Circuitry 2730 preferably outputs to management circuitry 2724, which provides appropriate instructions to information module contents adaptation circuitry 2732, enabling circuitry 2732 to adapt the contents of the retrieved information module for upload to specific telephone 700.

The output of circuitry 2732 is supplied to management circuitry 2724 which uploads it to telephone 700 via IR port 2728.

In the embodiment of FIGS. 7A & 7B and 17A, actuation of the button 706 causes a selected phone software upgrade to be uploaded to the telephone 700.

In the embodiment of FIGS. 7A & 7C and 17B, actuation of the button 710 causes a selected facilitator software upgrade to be uploaded to the facilitator 704.

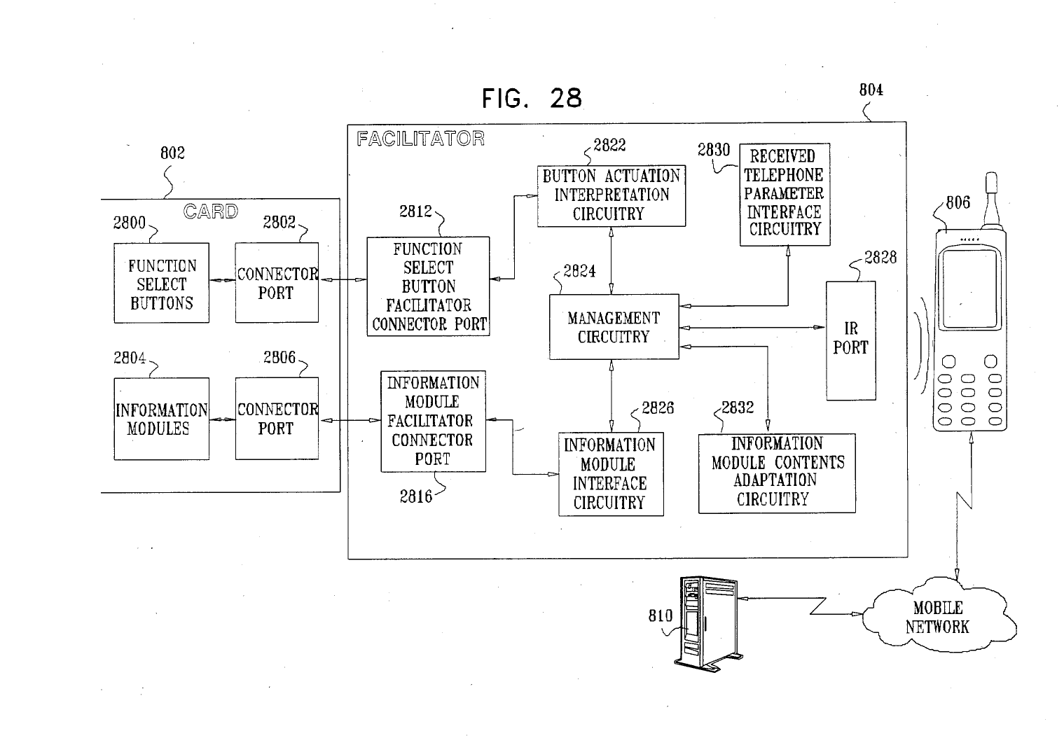

Reference is now made to FIG. 28A, which is a simplified generalized functional block diagram illustration of operation of the selectable functionality mobile communication system of FIGS. 8A, 8B and 18. As seen in FIG. 28B, which corresponds to FIG. 8B, card 802 preferably comprises function select buttons 2800 which communicate with a connector port 2802 and a plurality of information modules 2804, which separately communicate with a connector port 2806.

Facilitator 804 correspondingly includes a function select button facilitator connector port 2812 and an information module facilitator connector port 2816. Port 2812 communicates with connector port 2802 on card 802 and with button actuation interpretation circuitry 2822, which in turn communicates with management circuitry 2824. A preferred functionality of facilitator 804 is for management circuitry 2824 to intermittently trigger button actuation interpretation circuitry 2822 to intermittently inquire as to whether any button has been actuated. In practice, where electrical connections between the function select buttons 2800 and the connector port 2802 in the card 802 are arranged in a matrix, this may be achieved by applying voltage to one or more of the electrical contacts in connector port 2802 and sensing the voltage on one or more other electrical contacts in connector port 2802, thereby indicating which button was actuated. Button actuation interpretation circuitry 2822 also typically applies long and short duration thresholds to valid button actuation.

When a valid button actuation takes place, button actuation interpretation circuitry 2822 informs management circuitry 2824 of the identity of the actuated button. Management circuitry 2824, in turn, instructs information module interface circuitry 2826 to retrieve a corresponding information module from information modules 2804 in card 802, via ports 2806 and 2816. The retrieved information module is typically decompressed and appropriately formatted by information module interface circuitry 2826, which typically also verifies authenticity of the card 802.

Management circuitry 2824 communicates with telephone 806 via an IR port 2828 and requests and receives information relating to specific telephone parameters which affect the form of information uploaded to the telephone. Management circuitry 2824 communicates the received specific telephone parameters to received telephone parameter interface circuitry 2830, which employs the received specific telephone parameters to provide instructions for adaptation of the contents of the retrieved information module to the given telephone. Circuitry 2830 preferably outputs to management circuitry 2824, which provides appropriate instructions to information module contents adaptation circuitry 2832, enabling circuitry 2832 to adapt the contents of the retrieved information module for upload to specific telephone 806 in the form of a request to be communicated via the telephone 806 to a remote server 810. The request is intended to cause the remote server 810 to download content to telephone 806. The output of circuitry 2832 is supplied to management circuitry 2824 which uploads it to telephone 806 via IR port 2828.

In the embodiment of FIGS. 8A & 8B and 18, actuation of the button 802 causes facilitator software upgrade to be downloaded from remote server 810.

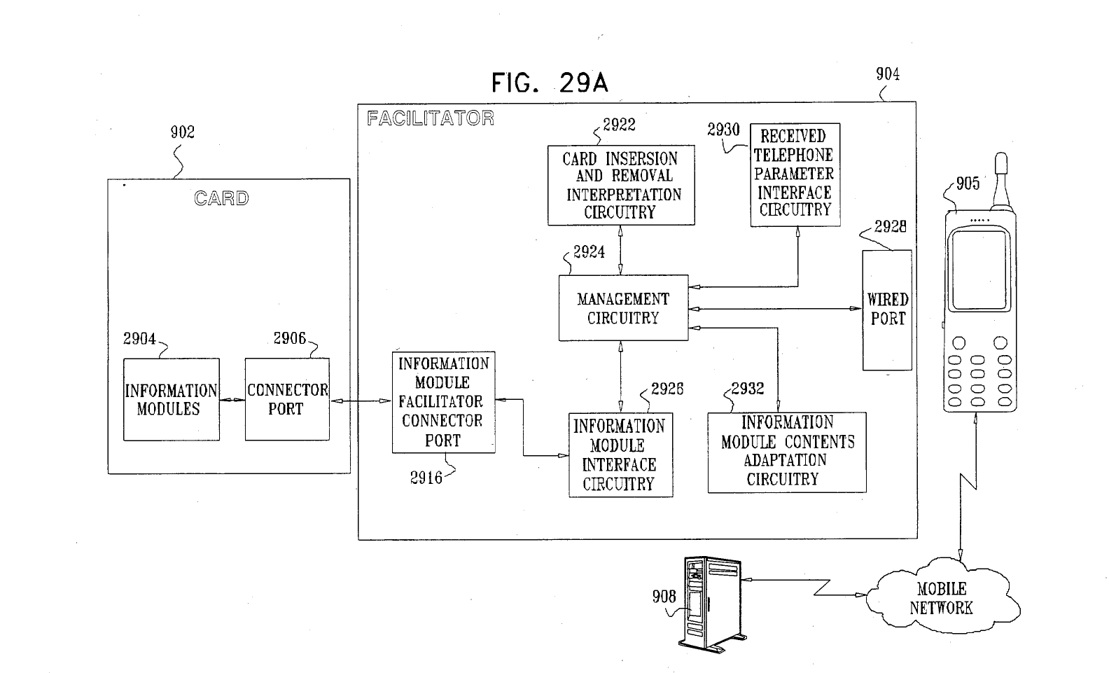

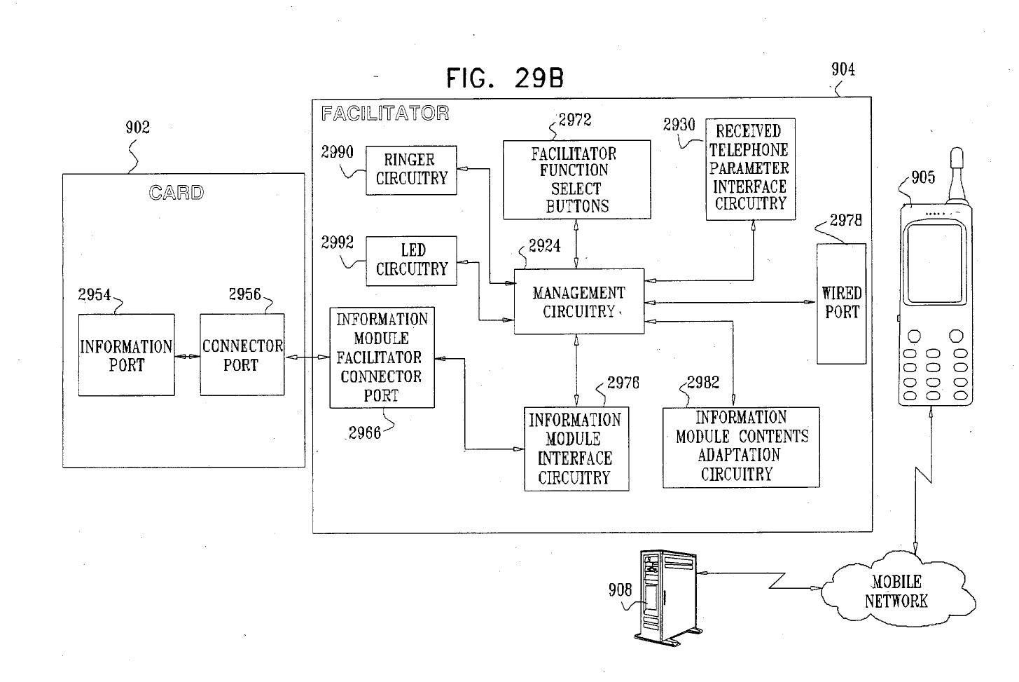

Reference is now made to FIG. 29A, which is a simplified generalized functional block diagram illustration of operation of the selectable functionality mobile communication system of FIGS. 9A, 9B and 19A. As seen in FIG. 29A, which corresponds to FIG. 9B, card 902 preferably comprises a plurality of information modules 2904, which separately communicate with a connector port 2906.

Facilitator 904 correspondingly includes an information module facilitator connector port 2916. Card insertion and removal interpretation circuitry 2922 communicates with management circuitry 2924. A preferred functionality of facilitator 904 is for management circuitry 2924 to intermittently trigger card insertion and removal interpretation circuitry 2922 to intermittently inquire as to whether any card has been inserted or removed. Card insertion and removal interpretation circuitry 2922 also typically applies long and short duration thresholds to valid button actuation

When a the card is inserted, card insertion and removal interpretation circuitry 2922 informs management circuitry 2924 of the identity of the inserted card. Management circuitry 2924, in turn, instructs information module interface circuitry 2926 to retrieve a corresponding information module from information modules 2904 in card 902, via ports 2906 and 2916. The retrieved information module is typically decompressed and appropriately formatted by information module interface circuitry 2926, which typically also verifies authenticity of the card 902.

Management circuitry 2924 communicates with telephone 904 via a wired port 2928 and requests and receives information relating to specific telephone parameters which affect the form of information uploaded to the telephone. Management circuitry 2924 communicates the received specific telephone parameters to received telephone parameter interface circuitry 2930, which employs the received specific telephone parameters to provide instructions for adaptation of the contents of the retrieved information module to the given telephone. Circuitry 2930 preferably outputs to management circuitry 2924, which provides appropriate instructions to information module contents adaptation circuitry 2932, enabling circuitry 2932 to adapt the contents of the retrieved information module for upload to specific telephone 904 in the form of a request to be communicated via the telephone 905 to a remote server 908. The request is intended to cause the remote server 908 to download content to telephone 908. The output of circuitry 2932 is supplied to management circuitry 2924 which uploads it to telephone 904 via IR port 2928.

In the embodiment of FIGS. 9A & 9B and 19A, insertion of card 902 causes a game to be downloaded from remote server 908.

Reference is now made to FIG. 29B, which is a simplified generalized functional block diagram illustration of operation of the selectable functionality mobile communication system of FIGS. 9A, 9C, 9D and 19B. As seen in FIG. 29B, which corresponds to FIGS. 9C and 9D, card 902 preferably comprises a plurality of information modules 2954, which separately communicate with a connector port 2956.

Facilitator 904 correspondingly includes an information module facilitator connector port 2966. Function select buttons 2972 interpretation circuitry 2972 communicates with management circuitry 2974. A preferred functionality of facilitator 904 is for management circuitry 2974 to intermittently trigger function select buttons 2972 to intermittently inquire as to whether any card has been inserted or removed. Function select buttons 2972 also typically applies long and short duration thresholds to valid button actuation.

When a valid button actuation takes place, button actuation interpretation circuitry 2972 informs management circuitry 2974 of the identity of the actuated button. Management circuitry 2974, in turn, instructs information module interface circuitry 2976 to retrieve a corresponding information module from information modules 2954 in card 902, via ports 2956 and 2966. The retrieved information module is typically decompressed and appropriately formatted by information module interface circuitry 2976, which typically also verifies authenticity of the card 902.

Management circuitry 2974 communicates with telephone 904 via a wired port 2978 and requests and receives information relating to specific telephone parameters which affect the form of information uploaded to the telephone. Management circuitry 2974 communicates the received specific telephone parameters to received telephone parameter interface circuitry 2980, which employs the received specific telephone parameters to provide instructions for adaptation of the contents of the retrieved information module to the given telephone. Circuitry 2980 preferably outputs to management circuitry 2974, which provides appropriate instructions to information module contents adaptation circuitry 2982, enabling circuitry 2982 to adapt the contents of the retrieved information module for upload to specific telephone 904 in the form of a request to be communicated via the telephone 905 to a remote server 908. The request is intended to cause the remote server 908 to download content to telephone 908. The output of circuitry 2982 is supplied to management circuitry 2974 which uploads it to telephone 904 via IR port 2978. In the present embodiment which comprises a ringer and or a LED, once the telephone is uploaded management circuitry 2974 triggers the ringer circuitry 2990 and or the LED circuitry 2992.

In the embodiment of FIGS. 9A, 9C & 9D and 19B, actuation of the button 930 causes a game to be downloaded from remote server 908.

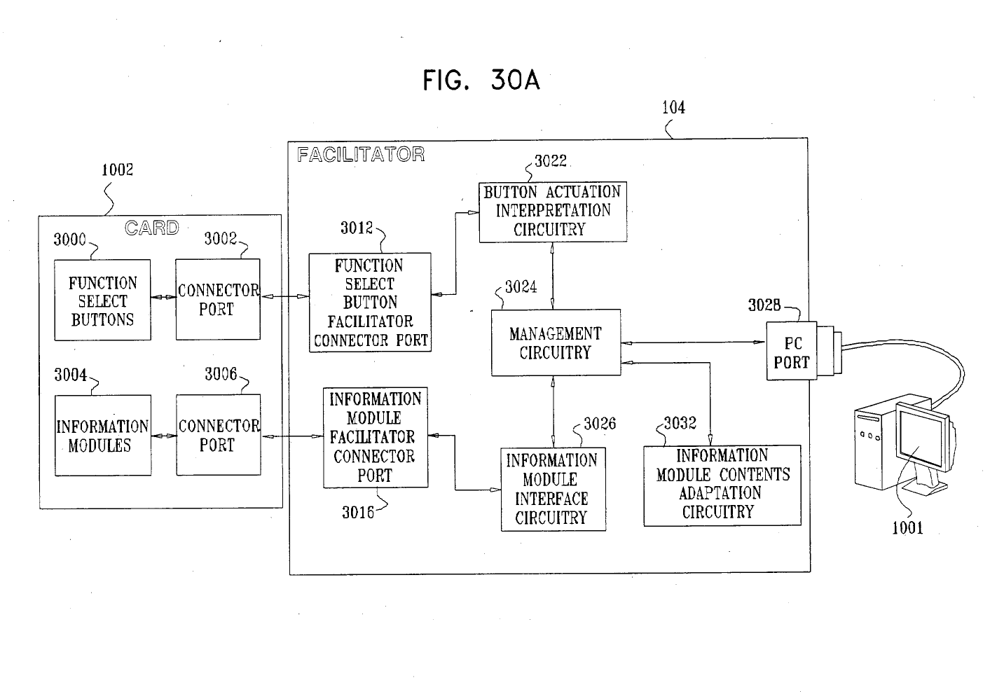

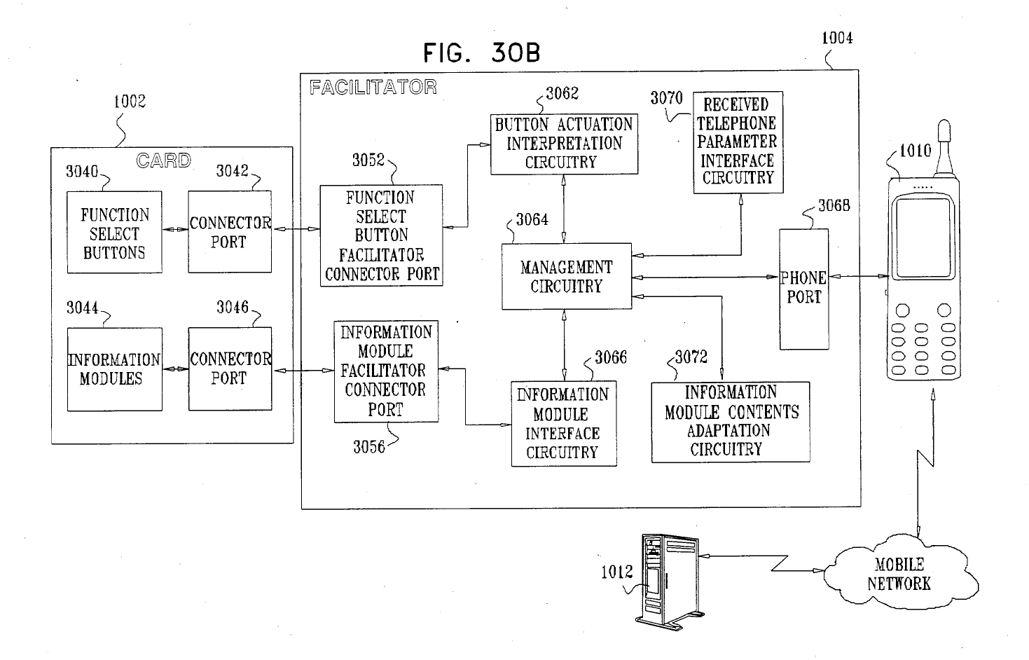

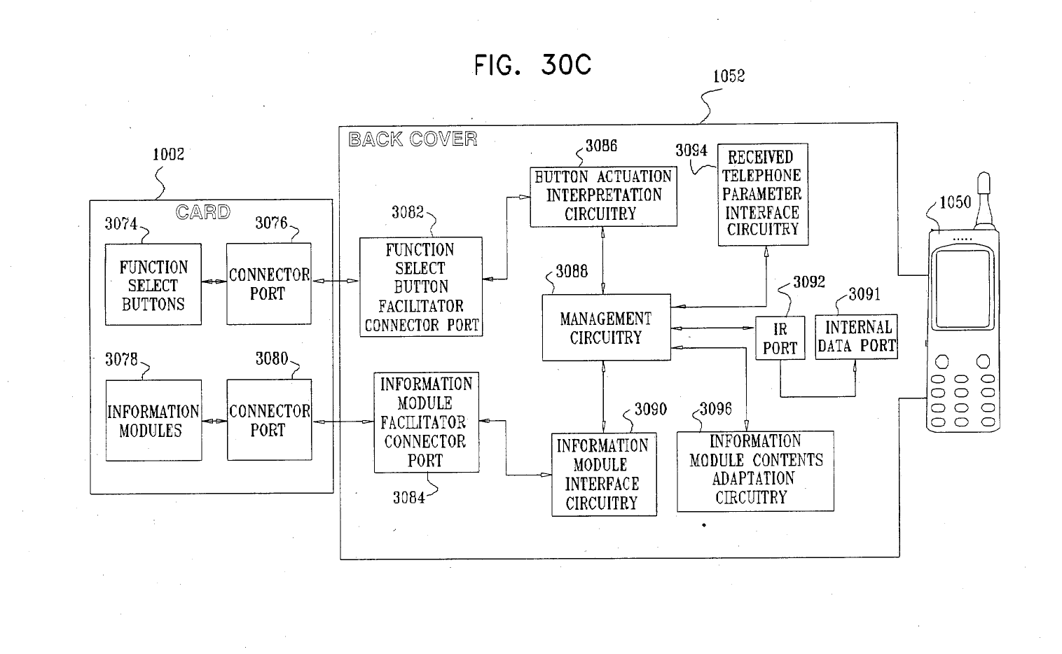

Reference is now made to FIG. 30A, which is a simplified generalized functional block diagram illustration of operation of the selectable functionality mobile communication system of FIGS. 10A, 10B and 20A. As seen in FIG. 30A, which corresponds to FIG. 10B, card 1002 preferably comprises function select buttons 3000 which communicate with a connector port 3002 and a plurality of information modules 3004, which separately communicate with a connector port 3006.

Facilitator 1004 correspondingly includes a function select button facilitator connector port 3012 and an information module facilitator connector port 3016. Port 3012 communicates with connector port 3002 on card 1002 and with button actuation interpretation circuitry 3022, which in turn communicates with management circuitry 3024. A preferred functionality of facilitator 1004 is for management circuitry 3024 to intermittently trigger button actuation interpretation circuitry 3022 to intermittently inquire as to whether any button has been actuated. In practice, where electrical connections between the function select buttons 3000 and the connector port 3002 in the card 102 are arranged in a matrix, this may be achieved by applying voltage to one or more of the electrical contacts in connector port 3002 and sensing the voltage on one or more other electrical contacts in connector port 3002, thereby indicating which button was actuated. Button actuation interpretation circuitry 3022 also typically applies long and short duration thresholds to valid button actuation

When a valid button actuation takes place, button actuation interpretation circuitry 3022 informs management circuitry 3024 of the identity of the actuated button. Management circuitry 3024, in turn, instructs information module interface circuitry 3026 to retrieve a corresponding information module from information modules 3004 in card 1002, via ports 3006 and 3016. The retrieved information module is typically decompressed and appropriately formatted by information module interface circuitry 3026, which typically also verifies authenticity of the card 1002.

Management circuitry 3024, which provides appropriate instructions to information module contents adaptation circuitry 3032, enabling circuitry 3032 to adapt the contents of the retrieved information module for upload to specific PC 1001.

The output of circuitry 3032 is supplied to management circuitry 3024 which uploads it to PC 1001 via PC port 3028.

In the embodiment of FIGS. 10A & 10B and 20A, actuation of the button 1006 causes an information module to be downloaded onto the card 1002.

Reference is now made to FIG. 30B, which is a simplified generalized functional block diagram illustration of operation of the selectable functionality mobile communication system of FIGS. 10A, 10C & 20B. As seen in FIG. 30B, which corresponds to FIGS. 10C, card 1002 preferably comprises function select buttons 3040 which communicate with a connector port 3042 and a plurality of information modules 3044, which separately communicate with a connector port 3046.

Facilitator 1004 correspondingly includes a function select button facilitator connector port 3052 and an information module facilitator connector port 3056. Port 3052 communicates with connector port 3046 on card 1002 and with button actuation interpretation circuitry 3062, which in turn communicates with management circuitry 3064. A preferred functionality of facilitator 1004 is for management circuitry 3064 to intermittently trigger button actuation interpretation circuitry 3062 to intermittently inquire as to whether any button has been actuated. In practice, where electrical connections between the function select buttons 3040 and the connector port 3042 in the card 1002 are arranged in a matrix, this may be achieved by applying voltage to one or more of the electrical contacts in connector port 3042 and sensing the voltage on one or more other electrical contacts in connector port 3042, thereby indicating which button was actuated. Button actuation interpretation circuitry 3052 also typically applies long and short duration thresholds to valid button actuation

When a valid button actuation takes place, button actuation interpretation circuitry 3052 informs management circuitry 3064 of the identity of the actuated button. Management circuitry 3064, in turn, instructs information module interface circuitry 3066 to retrieve a corresponding information module from information modules 3004 in card 1002, via ports 3046 and 3056. The retrieved information module is typically decompressed and appropriately formatted by information module interface circuitry 3056, which typically also verifies authenticity of the card 1002.

Management circuitry 3064 communicates with telephone 1010 via an phone port 3068 and requests and receives information relating to specific telephone parameters which affect the form of information uploaded to the telephone. Management circuitry 3064 communicates the received specific telephone parameters to received telephone parameter interface circuitry 3070, which employs the received specific telephone parameters to provide instructions for adaptation of the contents of the retrieved information module to the given telephone. Circuitry 3070 preferably outputs to management circuitry 3064, which provides appropriate instructions to information module contents adaptation circuitry 3072, enabling circuitry 3072 to adapt the contents of the retrieved information module for upload to specific telephone 1010 in the form of a request to be communicated via the telephone 1010 to a remote server 1012. The request is intended to cause the remote server 1012 to download content to telephone 1010. The output of circuitry 3072 is supplied to management circuitry 3064 which uploads it to telephone 1010 via phone port 3068.

In the embodiment of FIGS. 10A & 10C and 20B, actuation of the button 1006 causes an information module to be downloaded to the telephone 1010 from remote server 1012.

Reference is now made to FIG. 30C, which is a simplified generalized functional block diagram illustration of operation of the selectable functionality mobile communication system of FIGS. 10A, 10D, 10E & 20C. As seen in FIG. 30C, which corresponds to FIGS. 10E, card 1002 preferably comprises function select buttons 3074 which communicate with a connector port 3076 and a plurality of information modules 3078, which separately communicate with a connector port 3080.

Facilitator incorporated into the back cover 1054 correspondingly includes a function select button facilitator connector port 3082 and an information module facilitator connector port 3084. Port 3082 communicates with connector port 3086 on card 1002 and with button actuation interpretation circuitry 3086, which in turn communicates with management circuitry 3088. A preferred functionality of facilitator in back cover 1054 is for management circuitry 3088 to intermittently trigger button actuation interpretation circuitry 3086 to intermittently inquire as to whether any button has been actuated. In practice, where electrical connections between the function select buttons 3074 and the connector port 3076 in the card 1002 are arranged in a matrix, this may be achieved by applying voltage to one or more of the electrical contacts in connector port 3076 and sensing the voltage on one or more other electrical contacts in connector port 3076, thereby indicating which button was actuated. Button actuation interpretation circuitry 3082 also typically applies long and short duration thresholds to valid button actuation

When a valid button actuation takes place, button actuation interpretation circuitry 3086 informs management circuitry 3088 of the identity of the actuated button. Management circuitry 3088, in turn, instructs information module interface circuitry 3090 to retrieve a corresponding information module from information modules 3076 in card 1002, via ports 3076 and 3084. The retrieved information module is typically decompressed and appropriately formatted by information module interface circuitry 3084, which typically also verifies authenticity of the card 1002.

Management circuitry 3088 communicates with telephone 1010 via an Internal data port 3091 that receives the facilitator information modules from the IR port 3092 and requests and receives information relating to specific telephone parameters which affect the form of information uploaded to the telephone. Management circuitry 3088 communicates the received specific telephone parameters to received telephone parameter interface circuitry 3094, which employs the received specific telephone parameters to provide instructions for adaptation of the contents of the retrieved information module to the given telephone. Circuitry 3094 preferably outputs to management circuitry 3088, which provides appropriate instructions to information module contents adaptation circuitry 3096, enabling circuitry 3096 to adapt the contents of the retrieved information module for upload to specific telephone 1050 in the form of a request to be communicated via the telephone 1050 to download content to telephone 1050.

In the embodiment of FIGS. 10D & 10E and 20C, actuation of the button 1006 causes an information module to be downloaded to the telephone 1050.

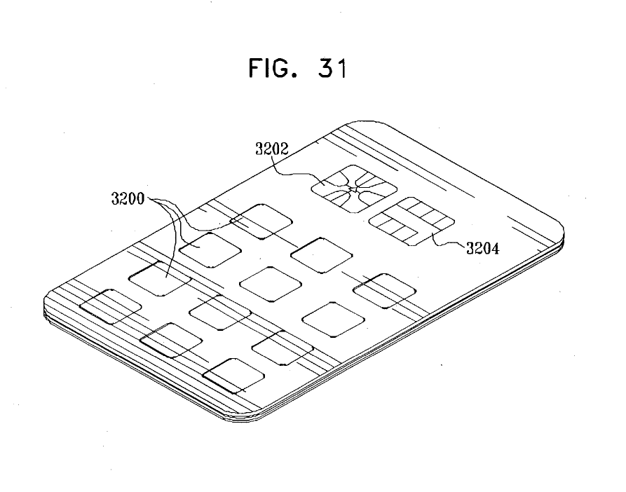

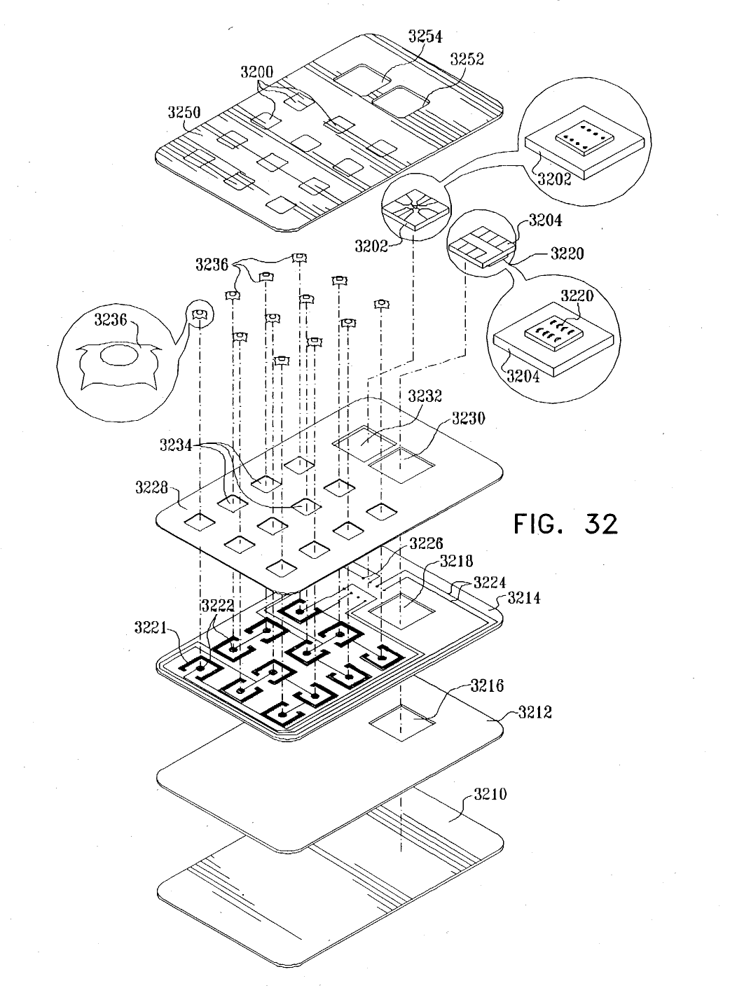

Reference is now made to FIGS. 31 & 32, which are illustrations of a user interface card constructed and operative in accordance with a preferred embodiment of the present invention. As seen in FIGS. 31 and 32, the user interface card is generally characterized in that it includes a number of user-actuable contact locations, preferably in the form of buttons 3200 and a plurality of ports, preferably in the form of a pair of contact assemblies 3202 and 3204.

Turning particularly to FIG. 32, it is seen that a bottom surface is preferably defined by a substrate 3210, preferably formed of transparent polycarbonate. Substrate 3210 is preferably printed on an inside surface thereof to present advertising or other user information on the outside surface thereof. Disposed above substrate 3210 there is preferably provided a stiffener layer 3212, preferably formed of PVC, and thereabove a flexible PCB 3214. Both stiffener layer 3212 and PCB 3214 are formed with apertures, respectively designated 3216 and 3218, in order to accommodate a micromodule 3220 which includes contact assembly 3204. Micromodule 3220 preferably is a conventional micromodule such as that commercially available from Atmel Inc. of 2325 Orchard Parkway San Jose, Calif. 95131 under model number AT 24C04SC.

PCB 3214 preferably defines the user-actuable contact locations by defining a plurality of perimeter contacts 3221 and a plurality of inner contacts 3222. Each cooperating pair of one perimeter contact 3221 and an inner contact 3222 disposed therewithin defines electrical connections to a single button 3200. A circuit comprising multiple PCB conductors 3224 interconnects the peripheral and inner contacts 3221 and 3222 of each button in a matrix arrangement to preferably seven electrical contact pads 3226.

Disposed over PCB 3214 there is preferably provided a spacer 3228, typically formed of polyester and having an aperture 3230 corresponding in position to apertures 3216 and 3218 and configured to accommodate micromodule 3220. Spacer 3228 also preferably includes an aperture 3232, which is configured to accommodate contact assembly 3202, which is in electrical contact with pads 3226. Spacer 3228 also comprises a plurality of apertures 3234 which overlie perimeter contacts 3221 and inner contacts 3222. Apertures 3234 are each configured to accommodate a conductive button contact 3236, which is operative, while depressed by a finger of a user, to establish electric contact between a perimeter contact 3221 and its corresponding inner contact 3222. Conductive button contacts 3236 are preferably formed as resilient metal domes, which return to their original, non-contact, orientation in the absence of user engagement therewith. Conductive button contacts 3236 provide desired tactile feedback to a user of pressing each given button 3200.

Disposed above spacer 3228 and conductive button contacts 3236 is a top substrate 3250, which is preferably formed of transparent polycarbonate. Top substrate 3250 is preferably printed on an inside surface thereof to present advertising or other user information on the outside surface thereof.

Top substrate 3250 is formed with an aperture 3252 which corresponds in position with apertures 3230, 3218 and 3216 and is somewhat smaller in size than those apertures, such that top substrate 3250 retains micro-module 3220 within the card, while permitting electrical contact with the contact assembly 3204. Top substrate 3250 also includes an aperture 3254, which corresponds in position with aperture 3232 and is somewhat smaller in size than that aperture, such that top substrate 3250 retains contact assembly 3202 within the card, while permitting electrical contact therewith.

Regions of top substrate 3250 which overlie conductive button contacts 3236 are designated as user-actuable contact locations by suitable graphics printing thereon.

The various layers of the card described above are preferably secured together by means of a suitable adhesive, such as double-stick tapes commercially available from 3M.

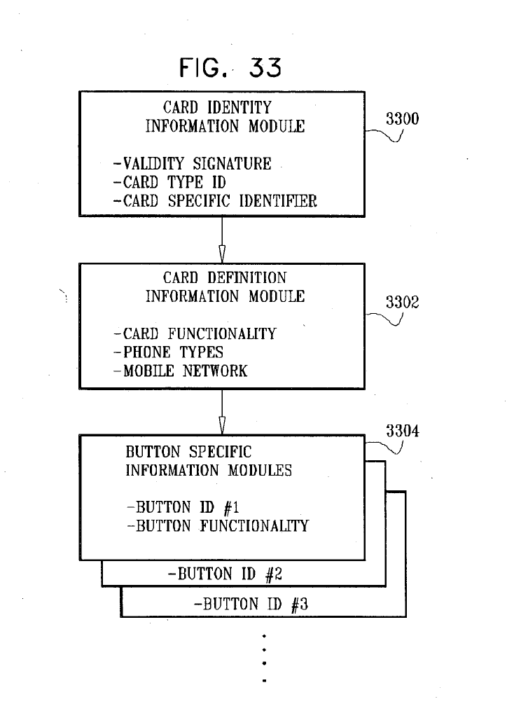

Reference is now made to FIG. 33, which is a diagram illustrating the organization of information in the card of FIGS. 31 & 32. As noted above, information contained in the, card of FIGS. 31 & 32 is preferably organized into information modules, which may be read from the card into or through a facilitator and thence to a wireless communicator. FIG. 33 illustrates three types of information modules, it being appreciated that any other suitable number of different types of information modules may be provided.

Initially, upon operative engagement of the card with a facilitator, either automatically or via a button press, a card identity information module 3300 is read from the card. This module preferably contains a non card-specific card validity signature, a card type-specific ID and a protected card-specific identifier. Typically thereafter, a card definition information module 3302 is read. This module preferably contains information regarding card functionalities and possible interfaces, such as lists of types of mobile communicators and mobile networks with which it operates.

The card preferably also includes a plurality of button specific or button combination specific information modules, each of which preferably contains a distinct and complete functionality, such as, for example, a specific ring tone, a video clip and a greeting. The button or button combination specific information modules may contain all data required to enable a mobile communicator to carry out the desired functionality or may contain instructions enabling the facilitator and/or the mobile communicator to download from a remote source some or all of the data required for the indicated functionality.

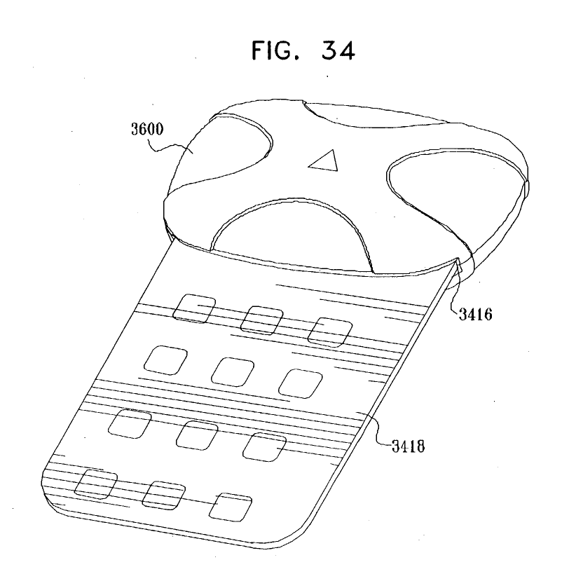

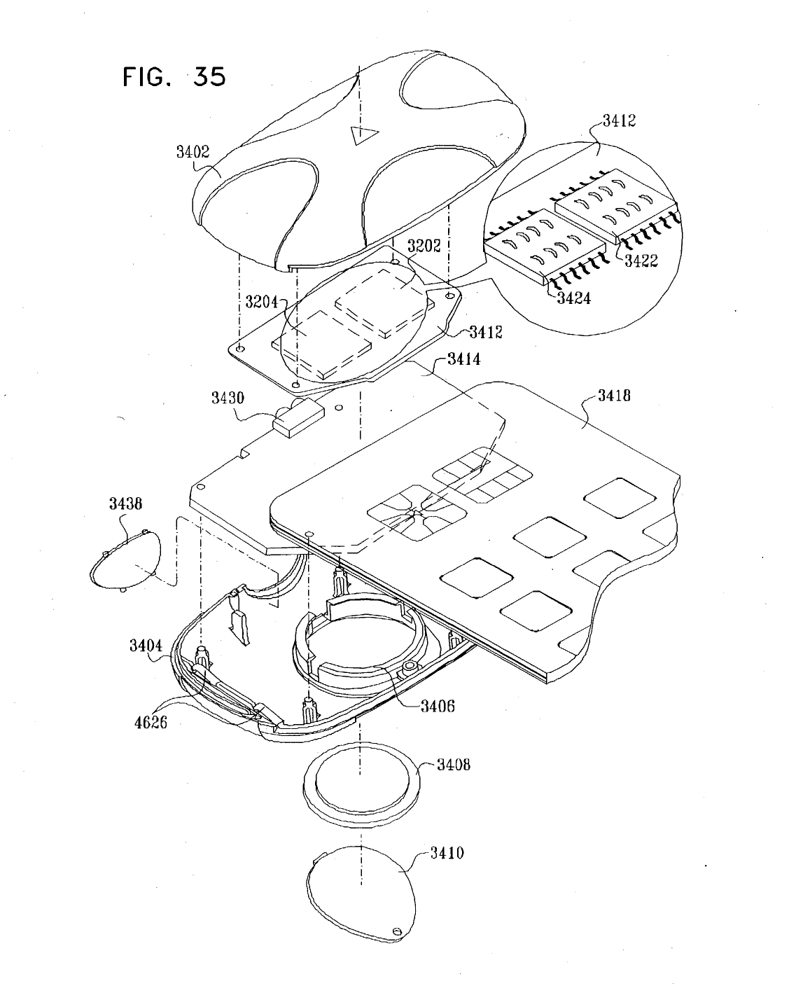

Reference is now made to FIGS. 34 and 35, which are simplified illustrations of a user-interface card intermediary constructed and operative in accordance with a preferred embodiment of the present invention in association with a card of the type described hereinabove. As seen in FIGS. 34 and 35, the intermediary, here shown in the form of a card-receiving facilitator 3400 includes a housing which comprises top and bottom portions 3402 and 3404, typically molded of plastic and ultrasonically welded together. The bottom portion 3402 is formed with a battery receiving recess 3406 in which a conventional disk-type battery 3408 may be retained behind a removable cover 3410.

A pair of spaced PCBs 3412 and 3414 are disposed within the housing and define therebetween a slot 3416 into which a card 3418 may be inserted. When the card 3418 is properly inserted into slot 3416, contact assemblies 3202 and 3204 (FIGS. 31 and 32) of card 3418 are in mechanical and electrical connection with corresponding facilitator contact arrays 3422 and 3424 on PCB 3412. The card 3418, which is typically somewhat wider than PCBs 3412 and 3414 is preferably urged against PCB 3412 by side springs 3426 preferably integrally formed with bottom housing portion 3404. An IR window 3428 is provided between portions of top and bottom housing portions 3402 and 3404 to permit IR communication with an external mobile communicator, by means of an IR transceiver 3430, typically mounted on PCB 3414.

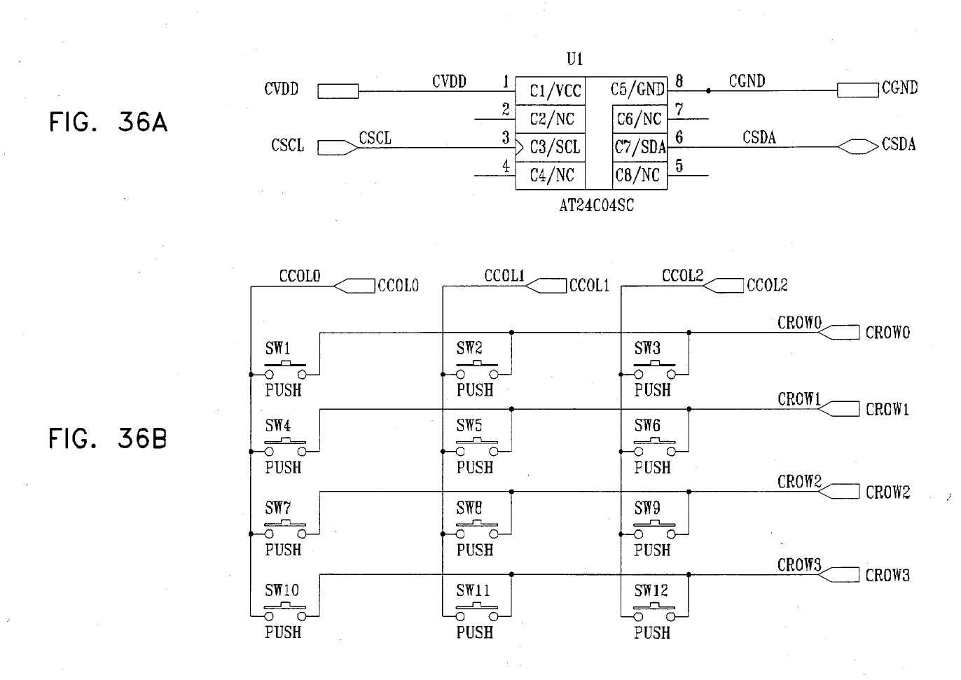

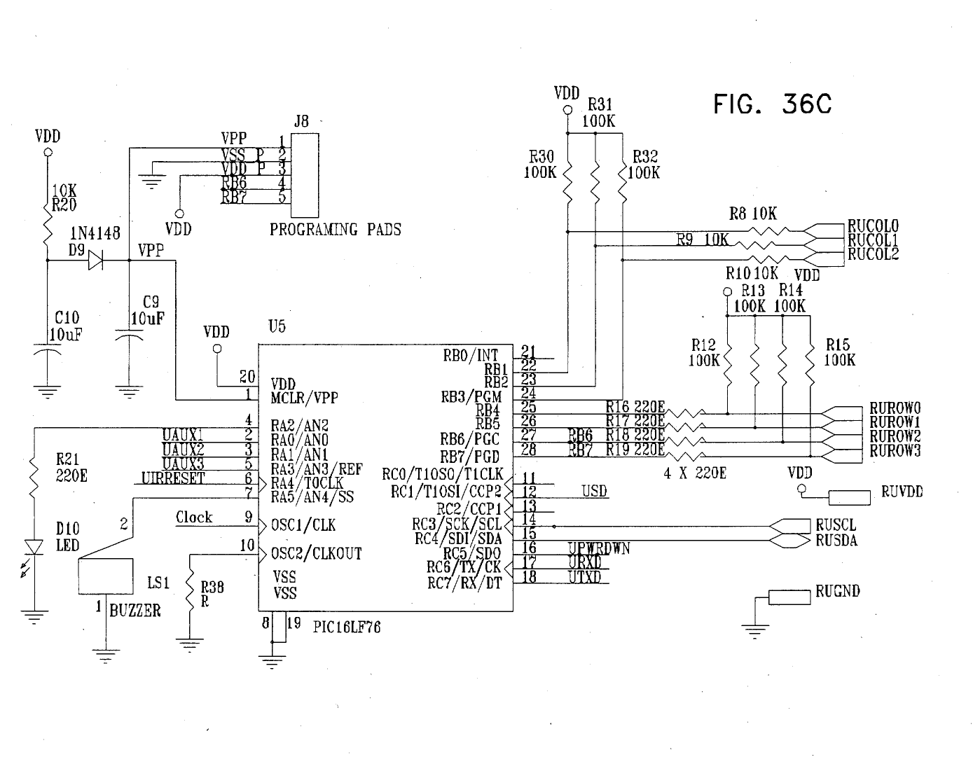

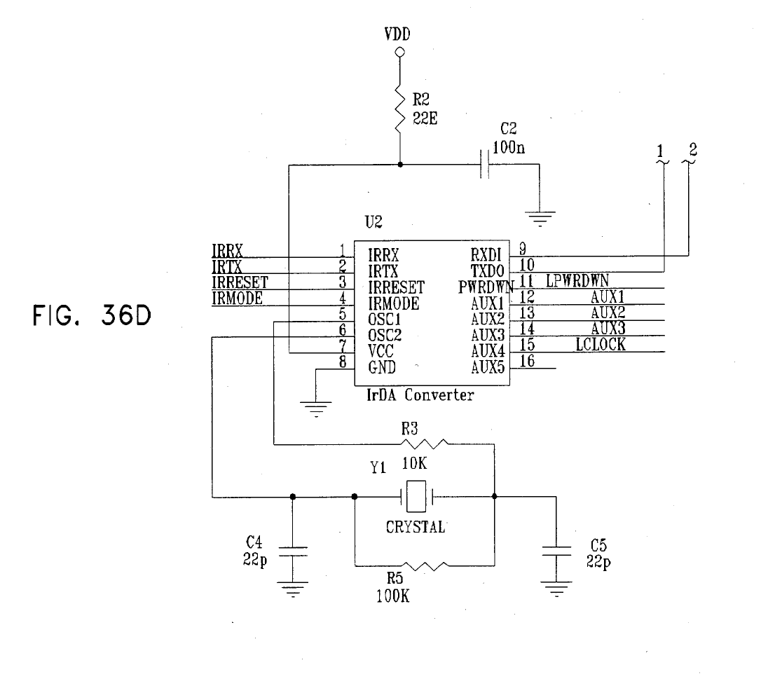

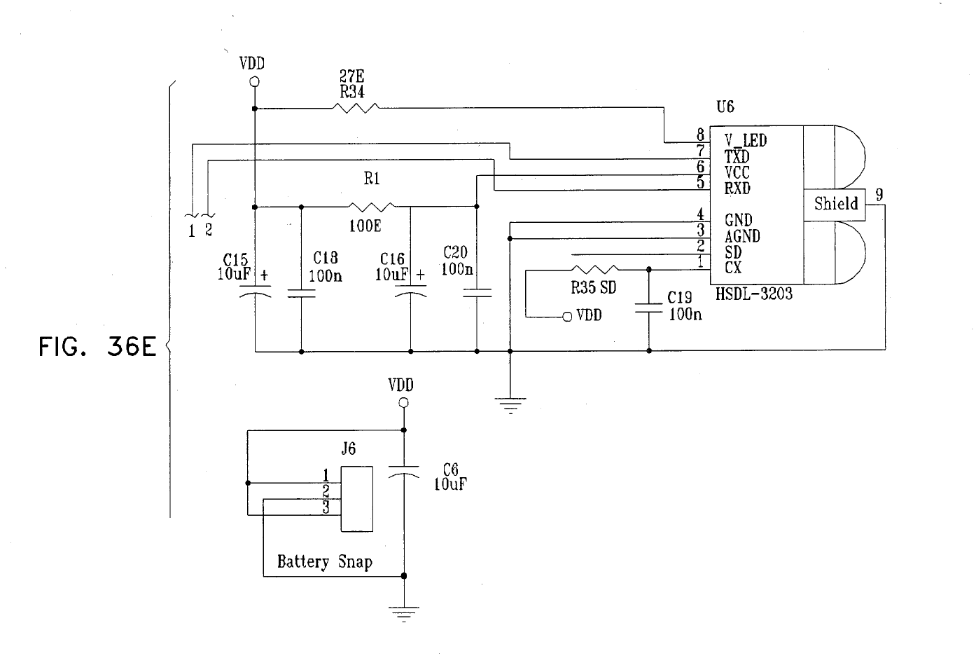

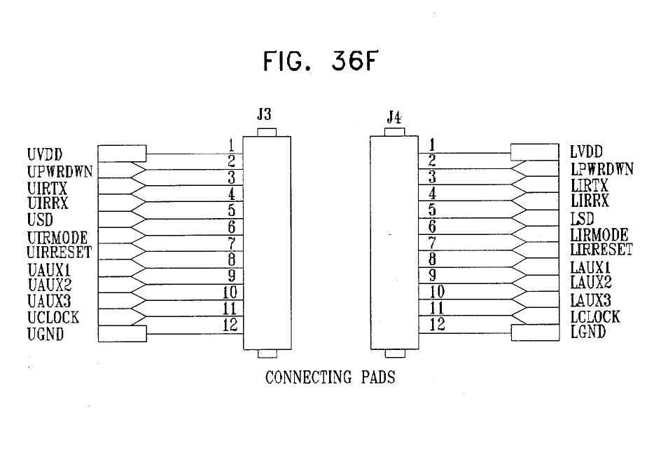

A self-explanatory electrical schematic illustration of the circuitry found on PCBs 3412 and 3414 appears in FIGS. 36A-36F.

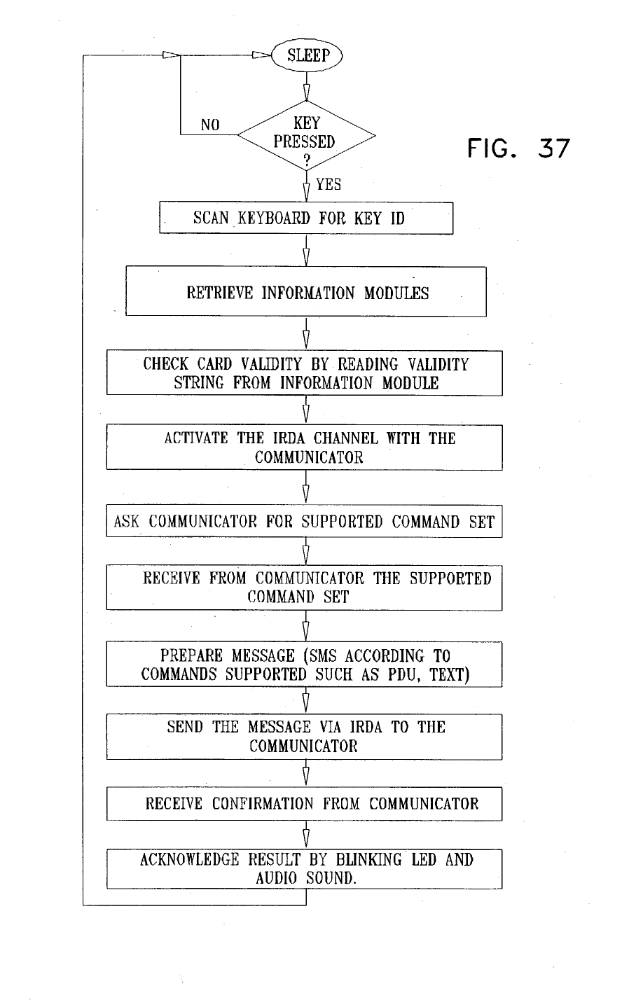

Reference is now made to FIGS. 36A, 36B, 36C, 36D, 36E and 36F, which are drawings of the electrical circuitry in the card of FIGS. 31 & 32 and the intermediary of FIGS. 34 & 35 and to FIG. 37 is a simplified flow chart illustrating the functionality of software incorporated in the circuitry of FIGS. 36A-36F.

The circuitry of FIGS. 36A-36F is believed to be self-explanatory. It is to be appreciated that although in the preferred embodiment, the circuitry of FIGS. 36A and 36B are embodied in the card, and the circuitry of FIGS. 36C-36F is embodied either in the facilitator or in a communicator, alternatively some of the circuitry of FIGS. 36C-36F may be included in the card and all of the circuitry of FIGS. 36C-36F may be included in the communicator, thus obviating the need for the facilitator.

Reference is now made to FIG. 37, which describes the functionality of software embodied in a U5 Microcontroller PIC 16LF76 appearing in FIG. 36C. As seen in FIG. 37, the circuitry of FIGS. 36A-36F is in a sleep mode until a key is pressed. When a key is pressed, the software scans the keyboard in order to identify which key was pressed and retrieves one or more information modules.

Thereafter, the software checks validity of the user interface card by reading a validity string from the retrieved information module and activates a communication channel, such as an IRDA communication channel for communication with a communicator. The supported command set of the communicator is requested and received and a message is prepared in an appropriate format, such as SMS and communicated, such as via IRDA to the communicator. A confirmation is received from the communicator and appropriate user feedback, such as visual or audio feedback is provided.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A user-interface card for use with an interactive communications device, said user-interface card comprising:
a plurality of user-actuable contact locations;
a plurality of information modules selectably accessible in response to actuation by a user of said plurality of user-actuable contact locations; and
a communications interface providing communication of said information modules to said interactive communications device in response to said actuation.

2. A user-interface card according to claim 1 and wherein said communications interface comprises a plurality of ports.

3. A user-interface card according to claim 2 and wherein a first one of said plurality of ports communicates contact location actuation data and a second one of said plurality of ports communicates information module data.

4. A user-interface card according to claim 1 and also comprising a contact location actuation data processor which provides information module selection inputs operative to cause communication of selected information modules via said communications interface.

5. A user-interface card according to claim 1 and also comprising contact location actuation feedback functionality operative to provide feedback to said user in response to said actuation of at least one of said plurality of user-actuable contact locations.

6. A user-interface card according to claim 4 and also comprising contact location actuation feedback functionality operative to provide feedback to said user in response to said actuation of at least one of said plurality of user-actuable contact locations.

7. A user-interface card according to claim 5 and wherein said contact location actuation feedback functionality includes tactile feedback functionality associated with at least some of said plurality of user-actuable contact locations.

8. A user-interface card according to claim 1 and also comprising at least one visually sensible information module indicator associated with each of said plurality of user-actuable contact locations.

9. A user-interface card according to claim 1 and wherein said plurality of information modules includes at least one information string.

10. A user-interface card according to claim 1 and wherein said plurality of information modules includes video content.

11. A user-interface card according to claim 1 and wherein said plurality of information modules includes audio content.

12. A user-interface card according to claim land wherein said plurality of information modules includes computer programs.

13. A user-interface card according to claim 1 and wherein said plurality of information modules includes games.

14. A user-interface card according to claim 1 and wherein said plurality of information modules includes entertainment content.

15. A user-interface card according to claim 1 and wherein said plurality of information modules includes security information.

16. A user-interface card according to claim 1 and wherein said plurality of information modules includes gaming programs.

17. A user-interface card according to claim 1 and wherein said plurality of information modules includes a message.

18. A user-interface card according to claim 1 and wherein said plurality of information modules includes transactional information.

19. A user-interface card according to claim 1 and wherein said plurality of information modules includes a request to be sent by a mobile device to a remote server to download information from said server.

20. A user-interface card according to claim 1 and wherein said plurality of information modules includes mobile commerce data.

21. A user-interface card according to claim 1 and wherein said card does not contain a source of electrical power.

22. A user-interface card according to claim 1 and also including user actuable programming functionality.

23. A user-interface card according to claim 1 and also including user actuable personalization functionality.

24. A user-interface card according to claim 1 and also including functionality which limits the number of times at least one of a plurality of information modules are accessible in response to user actuation of a corresponding at least one of said plurality of user-actuable contact locations.

25. A user-interface card according to claim 1 and also including functionality which changes information modules which are accessible in response to user actuation of at least one of said plurality of user-actuable contact locations.

26. A user-interface card according to claim 1 and also including functionality which changes the content of at least one of said plurality of information modules in response to user actuation of at least one of said plurality of user-actuable contact locations.

27. A user-interface card according to claim 1 and wherein said interactive communications device is a television set-top box.

28. A user-interface card according to claim 27 and wherein said communications interface providing communication in response to said actuation also provides communication to another interactive communications device operating as a back-channel communicator.

29. A user-interface subsystem for use with an interactive communications device, said user-interface subsystem comprising:
a user-interface card comprising:
a plurality of user-actuable contact locations;
a plurality of information modules selectably accessible in response to actuation by a user of said plurality of user-actuable contact locations; and
a communications interface providing communication of said information modules to said interactive communications device in response to said actuation; and
a user-interface card intermediary operative to communicate with said communications interface of said user-interface card and with said interactive communications device.

30. A user-interface subsystem according to claim 29 and wherein said user-interface card intermediary comprises:
an information module receiver operative to receive said information modules from said user-interface card; and
an information module transmitter operative to transmit received information modules to said interactive communications device.

31. A user-interface subsystem according to claim 30 and wherein said user-interface card intermediary also comprises an information module processor for processing at least some of said received information modules.

32. A user-interface subsystem according to claim 29 and wherein said user-interface card intermediary comprises:
an information receiver operative to receive information from said interactive communications device; and
an information transmitter operative to transmit received information to said user-interface card.

33. A user-interface subsystem according to claim 32 and wherein said user-interface card intermediary also comprises an information processor for processing at least some of said received information.

34. A user-interface subsystem according to claim 29 and wherein said communications interface comprises a plurality of card ports.

35. A user-interface subsystem according to claim 34 and wherein a first one of said plurality of card ports communicates contact location actuation data and a second one of said plurality of card ports communicates information module data.

36. A user-interface subsystem according to claim 29 and also comprising a contact location actuation data processor which provides information module selection inputs operative to cause communication of selected information modules via said communications interface.

37. A user-interface subsystem according to claim 29 and also comprising contact location actuation feedback functionality operative to provide feedback to said user in response to said actuation of at least one of said plurality of user-actuable contact locations.

38. A user-interface subsystem according to claim 36 and also comprising contact location actuation feedback functionality operative to provide feedback to said user in response to said actuation of at least one of said plurality of user-actuable contact locations.

39. A user-interface subsystem according to claim 37 and wherein said contact location actuation feedback functionality includes tactile feedback functionality associated with at least some of said plurality of user-actuable contact locations.

40. A user-interface subsystem according to claim 29 and also comprising at least one visually sensible information module indicator associated with each of said plurality of user-actuable contact locations.

41. A user-interface subsystem according to claim 29 and wherein said plurality of information modules includes at least one information string.

42. A user-interface subsystem according to claim 29 and wherein said plurality of information modules includes video content.

43. A user-interface subsystem according to claim 29 and wherein said plurality of information modules includes audio content.

44. A user-interface subsystem according to claim 29 and wherein said plurality of information modules includes computer programs.

45. A user-interface subsystem according to claim 29 and wherein said plurality of information modules includes games.

46. A user-interface subsystem according to claim 29 and wherein said plurality of information modules includes entertainment content.

47. A user-interface subsystem according to claim 29 and wherein said plurality of information modules includes security information.

48. A user-interface subsystem according to claim 29 and wherein said plurality of information modules includes gaming programs.

49. A user-interface subsystem according to claim 29 and wherein said plurality of information modules includes a message.

50. A user-interface subsystem according to claim 29 and wherein said plurality of information modules includes transactional information.

51. A user-interface subsystem according to claim 29 and wherein said plurality of information modules includes a request to be sent by a mobile device to a remote server to download information from said server.

52. A user-interface subsystem according to claim 29 and wherein said plurality of information modules includes mobile commerce data.

53. A user-interface subsystem according to claim 29 and wherein said user-interface card does not contain a source of electrical power.

54. A user-interface subsystem according to claim 29 and also including user actuable programming functionality.

55. A user-interface subsystem according to claim 29 and also including user actuable personalization functionality.

56. A user-interface subsystem according to claim 29 and wherein said user-interface card intermediary comprises at least one wireless communications link.

57. A user-interface subsystem according to claim 29 and wherein said user-interface card intermediary comprises a plurality of intermediary ports.

58. A user-interface subsystem according to claim 57 and wherein a first one of said plurality of intermediary ports communicates contact location actuation data and a second one of said plurality of intermediary ports communicates information module data.

59. A user-interface subsystem according to claim 56 and wherein said at least one wireless link interconnects said intermediary and said interactive communications device.

60. A user-interface subsystem according to claim 29 and also including functionality which limits the number of times at least one of a plurality of information modules are accessible in response to user actuation of a corresponding at least one of said plurality of user-actuable contact locations.

61. A user-interface subsystem according to claim 29 and also including functionality which changes information modules which are accessible in response to user actuation of at least one of said plurality of user-actuable contact locations.

62. A user-interface subsystem according to claim 29 and also including functionality which changes the content of at least one of said plurality of information modules in response to user actuation of at least one of said plurality of user-actuable contact locations.

63. A user-interface subsystem according to claim 29 and wherein said interactive communications device is a television set-top box.

64. A user-interface subsystem according to claim 63 and wherein said communications interface providing communication in response to said actuation also provides communication to another interactive communications device operating as a back-channel communicator.

65. A physical hyperlink system comprising:
a user-selectable function operative device; and
a user-interface card comprising:
a plurality of user-actuable contact locations;
a plurality of information modules selectably accessible in response to actuation by a user of said plurality of user-actuable contact locations; and
a communications interface providing communication of said information modules to said user-selectable function operative device in response to said actuation.

66. A physical hyperlink system according to claim 65 and also comprising an intermediary for communicating with said user-interface card and with said user-selectable function operative device.

67. A physical hyperlink system according to claim 65 and wherein said user-selectable function operative device is operative in response to user actuation of at least one of said plurality of user-actuable contact locations on said user-interface card to cause information to be downloaded to said user-selectable function operative device.

68. A physical hyperlink system according to claim 67 and wherein said information to be downloaded is downloaded from said user-interface card.

69. A physical hyperlink system according to claim 67 and wherein said information to be downloaded is downloaded from an external information source.

70. A physical hyperlink system according to claim 65 and wherein said user-selectable function operative device comprises a communicator.

71. A physical hyperlink system according to claim 65 and wherein said user-selectable function operative device comprises a game device.

72. A physical hyperlink system according to claim 65 and wherein said user-selectable function operative device comprises a television and associated set-top box.

73. A physical hyperlink system according to claim 65 and wherein said user-selectable function operative device comprises a communicator connected to a communications network.

74. A physical hyperlink system according to claim 66 and wherein said intermediary comprises:
an information module receiver operative to receive said information modules from said user-interface card; and
an information module transmitter operative to transmit received information modules to said user-selectable function operative device.

75. A physical hyperlink system according to claim 74 and wherein said intermediary also comprises an information module processor for processing at least some of said received information modules.

76. A physical hyperlink system according to claim 66 and wherein said intermediary comprises:
an information receiver operative to receive information from said user-selectable function operative device; and
an information transmitter operative to transmit received information to said user-interface card.

77. A physical hyperlink system according to claim 76 and wherein said intermediary also comprises an information processor for processing at least some of said received information.

78. A physical hyperlink system according to claim 65 and wherein said communications interface comprises a plurality of card ports.

79. A physical hyperlink system according to claim 78 and wherein a first one of said plurality of card ports communicates contact location actuation data and a second one of said plurality of card ports communicates information module data.

80. A physical hyperlink system according to claim 65 and also comprising a contact location actuation data processor which provides information module selection inputs operative to cause communication of selected information modules via said communications interface.

81. A physical hyperlink system according to claim 65 and also comprising contact location actuation feedback functionality operative to provide feedback to said user in response to said actuation of at least one of said plurality of user-actuable contact locations.

82. A physical hyperlink system according to claim 80 and also comprising contact location actuation feedback functionality operative to provide feedback to said user in response to said actuation of at least one of said plurality of user-actuable contact locations.

83. A physical hyperlink system according to claim 81 and wherein said contact location actuation feedback functionality includes tactile feedback functionality associated with at least some of said plurality of user-actuable contact locations.

84. A physical hyperlink system according to claim 65 and also comprising at least one visually sensible information module indicator associated with each of said plurality of user-actuable contact locations.

85. A physical hyperlink system according to claim 65 and wherein said plurality of information modules includes at least one information string.

86. A physical hyperlink system according to claim 65 and wherein said plurality of information modules includes video content.

87. A physical hyperlink system according to claim 65 and wherein said plurality of information modules includes audio content.

88. A physical hyperlink system according to claim 65 and wherein said plurality of information modules includes computer programs.

89. A physical hyperlink system according to claim 65 and wherein said plurality of information modules includes games.

90. A physical hyperlink system according to claim 65 and wherein said plurality of information modules includes entertainment content.

91. A physical hyperlink system according to claim 65 and wherein said plurality of information modules includes security information.

92. A physical hyperlink system according to claim 65 and wherein said plurality of information modules includes gaming programs.

93. A physical hyperlink system according to claim 65 and wherein said plurality of information modules includes a message.

94. A physical hyperlink system according to claim 65 and wherein said plurality of information modules includes transactional information.

95. A physical hyperlink system according to claim 65 and wherein said plurality of information modules includes a request to be sent by a mobile device to a remote server to download information from said server.

96. A physical hyperlink system according to claim 65 and wherein said plurality of information modules includes mobile commerce data.

97. A physical hyperlink system according to claim 65 and wherein said user-interface card does not contain a source of electrical power.

98. A physical hyperlink system according to claim 65 and also including user actuable programming functionality.

99. A physical hyperlink system according to claim 65 and also including user actuable personalization functionality.

100. A physical hyperlink system according to claim 66 and wherein said intermediary comprises at least one wireless communications link.

101. A physical hyperlink system according to claim 66 and wherein said intermediary comprises a plurality of intermediary ports.

102. A physical hyperlink system according to claim 101 and wherein a first one of said plurality of intermediary ports communicates contact location actuation data and a second one of said plurality of intermediary ports communicates information module data.

103. A physical hyperlink system according to claim 100 and wherein said at least one wireless link interconnects said intermediary and said user-selectable function operative device.

104. A physical hyperlink system according to claim 65 and also including functionality which limits the number of times at least one of a plurality of information modules are accessible in response to user actuation of a corresponding at least one of said plurality of user-actuable contact locations.

105. A physical hyperlink system according to claim 65 and also including functionality which changes information modules which are accessible in response to user actuation of at least one of said plurality of user-actuable contact locations.

106. A physical hyperlink system according to claim 65 and also including functionality which changes the content of at least one of said plurality of information modules in response to user actuation of at least one of said plurality of user-actuable contact locations.

107. A physical hyperlink system according to claim 65 and wherein said user-selectable function operating device is a television set-top box.

108. A physical hyperlink system according to claim 107 and wherein said communications interface providing communication in response to said actuation also provides communication to another user-selectable function operating device operating as a back-channel communicator.

109. A selectable functionality mobile communication system comprising:
a function actuation card;
a function actuation card/mobile device intermediary; and
a function selectable mobile device,
said function actuation card containing at least one audio-visual information module which interacts with at least one of said intermediary and said mobile device.

110. A selectable functionality mobile communication system according to claim 109 and wherein said function actuation card comprises:
a plurality of user-actuable contact locations;
a plurality of information modules selectably accessible in response to actuation by a user of said plurality of user-actuable contact locations; and
a communications interface providing communication of said information modules to said function selectable mobile device in response to said actuation.

111. A selectable functionality mobile communication system according to claim 109 and wherein said intermediary and said mobile device communicate with each other in a wireless manner.

112. A selectable functionality mobile communication system according to claim 109 and wherein said intermediary and said mobile device communicate with each other in a bi-directional communications manner.

113. A selectable functionality mobile communication system according to claim 109 and wherein said at least one information module is modifiable through communication between said function actuation card and at least one of said intermediary and said mobile device.

114. A selectable functionality mobile communication system according to claim 109 and wherein said intermediary includes a user interface.

115. A selectable functionality mobile communication system according to claim 114 and wherein said user interface includes selection buttons.

116. A selectable functionality mobile communication system according to claim 114 and wherein said user interface includes a ringer.

117. A selectable functionality mobile communication system according to claim 114 and wherein said user interface includes an LED.

118. A selectable functionality mobile communication system according to claim 110 and wherein said intermediary comprises:
an information module receiver operative to receive said information modules from said function actuation card; and
an information module transmitter operative to transmit received information modules to said function selectable mobile device.

119. A selectable functionality mobile communication system according to claim 118 and wherein said intermediary also comprises an information module processor for processing at least some of said received information modules.

120. A selectable functionality mobile communication system according to claim 110 and wherein said intermediary comprises:
an information receiver operative to receive information from said function selectable mobile device; and
an information transmitter operative to transmit received information to said function actuation card.

121. A selectable functionality mobile communication system according to claim 120 and wherein said intermediary also comprises an information processor for processing at least some of said received information.

122. A selectable functionality mobile communication system according to claim 110 and wherein said communications interface comprises a plurality of card ports.

123. A selectable functionality mobile communication system according to claim 122 and wherein a first one of said plurality of card ports communicates contact location actuation data and a second one of said plurality of card ports communicates information module data.

124. A selectable functionality mobile communication system according to claim 110 and also comprising a contact location actuation data processor which provides information module selection inputs operative to cause communication of selected information modules via said communications interface.

125. A selectable functionality mobile communication system according to claim 110 and also comprising contact location actuation feedback functionality operative to provide feedback to said user in response to said actuation of said plurality of user-actuable contact locations.

126. A selectable functionality mobile communication system according to claim 124 and also comprising contact location actuation feedback functionality operative to provide feedback to said user in response to said actuation of said plurality of user-actuable contact locations.

127. A selectable functionality mobile communication system according to claim 125 and wherein said contact location actuation feedback functionality includes tactile feedback functionality associated with at least some of said plurality of user-actuable contact locations.

128. A selectable functionality mobile communication system according to claim 110 and also comprising at least one visually sensible information module indicator associated with each of said plurality of user-actuable contact locations.

129. A selectable functionality mobile communication system according to claim 110 and wherein said plurality of information modules includes at least one information string.

130. A selectable functionality mobile communication system according to claim 110 and wherein said plurality of information modules includes computer programs.

131. A selectable functionality mobile communication system according to claim 110 and wherein said plurality of information modules includes games.

132. A selectable functionality mobile communication system according to claim 110 and wherein said plurality of information modules includes entertainment content.

133. A selectable functionality mobile communication system according to claim 110 and wherein said plurality of information modules includes security information.

134. A selectable functionality mobile communication system according to claim 110 and wherein said plurality of information modules includes gaming programs.

135. A selectable functionality mobile communication system according to claim 110 and wherein said plurality of information modules includes a message.

136. A selectable functionality mobile communication system according to claim 110 and wherein said plurality of information modules includes transactional information.

137. A selectable functionality mobile communication system according to claim 110 and wherein said plurality of information modules includes a request to be sent by a mobile device to a remote server to download information from said server.

138. A selectable functionality mobile communication system according to claim 110 and wherein said plurality of information modules includes mobile commerce data.

139. A selectable functionality mobile communication system according to claim 109 and wherein said function actuation card does not contain a source of electrical power.

140. A selectable functionality mobile communication system according to claim 109 and also including user actuable programming functionality.

141. A selectable functionality mobile communication system according to claim 109 and also including user actuable personalization functionality.

142. A selectable functionality mobile communication system according to claim 109 and wherein said intermediary comprises at least one wireless communications link.

143. A selectable functionality mobile communication system according to claim 109 and wherein said intermediary comprises a plurality of intermediary ports.

144. A selectable functionality mobile communication system according to claim 143 and wherein a first one of said plurality of intermediary ports communicates contact location actuation data and a second one of said plurality of intermediary ports communicates information module data.

145. A selectable functionality mobile communication system according to claim 142 and wherein said at least one wireless link interconnects said intermediary and said function selectable mobile device.

146. A selectable functionality mobile communication system according to claim 110 and also including functionality which limits the number of times at least one of a plurality of information modules are accessible in response to user actuation of a corresponding at least one of said plurality of user-actuable contact locations.

147. A selectable functionality mobile communication-system according to claim 110 and also including functionality which changes information modules which are accessible in response to user actuation of at least one of said plurality of user-actuable contact locations.

148. A selectable functionality mobile communication system according to claim 110 and also including functionality which changes the content of at least one of said plurality of information modules in response to user actuation of at least one of said plurality of user-actuable contact locations.

149. A selectable functionality mobile communication system comprising:
a function actuation card;
a function actuation card/mobile device intermediary; and
a function selectable mobile device,
said function actuation card containing at least one information module which interacts with at least one of said intermediary and said mobile device and causes said at least one of said intermediary and said mobile device to download information from an external source.

150. A selectable functionality mobile communication system according to claim 149 and wherein said function actuation card comprises:
a plurality of user-actuable contact locations;
a plurality of information modules selectably accessible in response to actuation by a user of said plurality of user-actuable contact locations; and
a communications interface providing communication of said information modules to said function selectable mobile device in response to said actuation.

151. A selectable functionality mobile communication system according to claim 149 and wherein said intermediary and said mobile device communicate with each other in a wireless manner.

152. A selectable functionality mobile communication system according to claim 149 and wherein said intermediary and said mobile device communicate with each other in a bi-directional communications manner.

153. A selectable functionality mobile communication system according to claim 149 and wherein said at least one information module is modifiable through communication between said function actuation card and at least one of said intermediary and said mobile device.

154. A selectable functionality mobile communication system according to claim 149 and wherein said intermediary includes a user interface.

155. A selectable functionality mobile communication system according to claim 154 and wherein said user interface includes selection buttons.

156. A selectable functionality mobile communication system according to claim 154 and wherein said user interface includes a ringer.

157. A selectable functionality mobile communication system according to claim 154 and wherein said user interface includes an LED.

158. A selectable functionality mobile communication system according to claim 149 and wherein said function actuation card contains at least one information module actuating functionality of said mobile device.

159. A selectable functionality mobile communication system according to claim 149 and wherein said function actuation card contains at least one information module providing a mobile device ring tone.

160. A selectable functionality mobile communication system according to claim 149 and wherein said function actuation card contains at least one information module providing at least one information string.

161. A selectable functionality mobile communication system according to claim 149 and wherein said function actuation card contains at least one information module providing video content.

162. A selectable functionality mobile communication system according to claim 149 and wherein said function actuation card contains at least one information module providing audio content.

163. A selectable functionality mobile communication system according to claim 149 and wherein said function actuation card contains at least one information module providing computer programs.

164. A selectable functionality mobile communication system according to claim 149 and wherein said function actuation card contains at least one information module providing games.

165. A selectable functionality mobile communication system according to claim 149 and wherein said function actuation card contains at least one information module providing entertainment content.

166. A selectable functionality mobile communication system according to claim 149 and wherein said function actuation card contains at least one information module providing security information.

167. A selectable functionality mobile communication system according to claim 149 and wherein said function actuation card contains at least one information module providing gaming programs.

168. A selectable functionality mobile communication system according to claim 149 and wherein said function actuation card contains at least one information module providing a message.

169. A selectable functionality mobile communication system according to claim 149 and wherein said function actuation card contains at least one information module providing transactional information.

170. A selectable functionality mobile communication system according to claim 149 and wherein said function actuation card contains at least one information module providing a request to be sent by a mobile device to a remote server to download information from said server.

171. A selectable functionality mobile communication system according to claim 149 and wherein said said function actuation card contains at least one information module providing mobile commerce data.

172. A selectable functionality mobile communication system according to claim 149 and wherein said function actuation card contains at least one information module providing electrical power.

173. A selectable functionality mobile communication system according to claim 149 and wherein said function actuation card contains at least one information module providing user actuable programming functionality.

174. A selectable functionality mobile communication system according to claim 149 and wherein said function actuation card contains at least one information module providing user actuable personalization functionality.

175. A selectable functionality mobile communication system according to claim 149 and wherein said intermediary comprises:
an information module receiver operative to receive said information modules from said function actuation card; and
an information module transmitter operative to transmit received information modules to said mobile device.

176. A selectable functionality mobile communication system according to claim 175 and wherein said intermediary also comprises an information module processor for processing at least some of said received information modules.

177. A selectable functionality mobile communication system according to claim 149 and wherein said intermediary comprises:
an information receiver operative to receive information from said mobile device; and
an information transmitter operative to transmit received information to said function actuation card.

178. A selectable functionality mobile communication system according to claim 177 and wherein said intermediary also comprises an information processor for processing at least some of said received information.

179. A selectable functionality mobile communication system according to claim 150 and wherein said communications interface comprises a plurality of card ports.

180. A selectable functionality mobile communication system according to claim 179 and wherein a first one of said plurality of card ports communicates contact location actuation data and a second one of said plurality of card ports communicates information module data.

181. A selectable functionality mobile communication system according to claim 150 and also comprising a contact location actuation data processor which provides information module selection inputs operative to cause communication of selected information modules via said communications interface.

182. A selectable functionality mobile communication system according to claim 150 and also comprising contact location actuation feedback functionality operative to provide feedback to said user in response to said actuation of said plurality of user-actuable contact locations.

183. A selectable functionality mobile communication system according to claim 181 and also comprising contact location actuation feedback functionality operative to provide feedback to said user in response to said actuation of said plurality of user-actuable contact locations.

184. A selectable functionality mobile communication system according to claim 182 and wherein said contact location actuation feedback functionality includes tactile feedback functionality associated with at least some of said plurality of user-actuable contact locations.

185. A selectable functionality mobile communication system according to claim 150 and also comprising at least one visually sensible information module indicator associated with each of said plurality of user-actuable contact locations.

186. A selectable functionality mobile communication system according to claim 149 and wherein said intermediary comprises at least one wireless communications link.

187. A selectable functionality mobile communication system according to claim 149 and wherein said intermediary comprises a plurality of intermediary ports.

188. A selectable functionality mobile communication system according to claim 187 and wherein a first one of said plurality of intermediary ports communicates contact location actuation data and a second one of said plurality of intermediary ports communicates information module data.

189. A selectable functionality mobile communication system according to claim 186 and wherein said at least one wireless link interconnects said intermediary and said mobile device.

190. A selectable functionality mobile communication system according to claim 150 and also including functionality which limits the number of times at least one of a plurality of information modules are accessible in response to user actuation of a corresponding at least one of said plurality of user-actuable contact locations.

191. A selectable functionality mobile communication system according to claim 150 and also including functionality which changes information modules which are accessible in response to user actuation of at least one of said plurality of user-actuable contact locations.

192. A selectable functionality mobile communication system according to claim 150 and also including functionality which changes the content of at least one of said plurality of information modules in response to user actuation of at least one of said plurality of user-actuable contact locations.

193. A selectable functionality mobile communication system comprising:
a function actuation card;
a function actuation card/mobile device intermediary; and
a television set-top box,
said function actuation card containing at least one information module which interacts with at least one of said intermediary and said set-top box and causes said at least one of said intermediary and said set-top box to download information from an external source.

194. A selectable functionality mobile communication system according to claim 193 and wherein said function actuation card also contains at least one information module which interacts with a communications device providing back-channel functionality in association with said set-top box.

195. A selectable functionality mobile communication system according to claim 193 and wherein said function actuation card comprising:
a plurality of user-actuable contact locations;
a plurality of information modules selectably accessible in response to actuation by a user of said plurality of user-actuable contact locations; and
a communications interface providing communication of said information modules to said set-top box in response to said actuation.

196. A selectable functionality mobile communication system according to claim 195 and wherein said intermediary comprises:
an information module receiver operative to receive said information modules from said function actuation card; and
an information module transmitter operative to transmit received information modules to said set-top box.

197. A selectable functionality mobile communication system according to claim 196 and wherein said intermediary also comprises an information module processor for processing at least some of said received information modules.

198. A selectable functionality mobile communication system according to claim 195 and wherein said intermediary comprises:
an information receiver operative to receive information from said set-top box; and
an information transmitter operative to transmit received information to said function actuation card.

199. A selectable functionality mobile communication system according to claim 198 and wherein said intermediary also comprises an information processor for processing at least some of said received information.

200. A selectable functionality mobile communication system according to claim 195 and wherein said communications interface comprises a plurality of card ports.

201. A selectable functionality mobile communication system according to claim 200 and wherein a first one of said plurality of card ports communicates contact location actuation data and a second one of said plurality of card ports communicates information module data.

202. A selectable functionality mobile communication system according to claim 195 and also comprising a contact location actuation data processor which provides information module selection inputs operative to cause communication of selected information modules via said communications interface.

203. A selectable functionality mobile communication system according to claim 195 and also comprising contact location actuation feedback functionality operative to provide feedback to said user in response to said actuation of said plurality of user-actuable contact locations.

204. A selectable functionality mobile communication system according to claim 202 and also comprising contact location actuation feedback functionality operative to provide feedback to said user in response to said actuation of said plurality of user-actuable contact locations.

205. A selectable functionality mobile communication system according to claim 203 and wherein said contact location actuation feedback functionality includes tactile feedback functionality associated with at least some of said plurality of user-actuable contact locations.

206. A selectable functionality mobile communication system according to claim 195 and also comprising at least one visually sensible information module indicator associated with each of said plurality of user-actuable contact locations.

207. A selectable functionality mobile communication system according to claim 195 and wherein said plurality of information modules includes at least one information string.

208. A selectable functionality mobile communication system according to claim 195 and wherein said plurality of information modules includes video content.

209. A selectable functionality mobile communication system according to claim 195 and wherein said plurality of information modules includes audio content.

210. A selectable functionality mobile communication system according to claim 195 and wherein said plurality of information modules includes computer programs.

211. A selectable functionality mobile communication system according to claim 195 and wherein said plurality of information modules includes games.

212. A selectable functionality mobile communication system according to claim 195 and wherein said plurality of information modules includes entertainment content.

213. A selectable functionality mobile communication system according to claim 195 and wherein said plurality of information modules includes security information.

214. A selectable functionality mobile communication system according to claim 195 and wherein said plurality of information modules includes gaming programs.

215. A selectable functionality mobile communication system according to claim 195 and wherein said plurality of information modules includes a message.

216. A selectable functionality mobile communication system according to claim 195 and wherein said plurality of information modules includes transactional information.

217. A selectable functionality mobile communication system according to claim 195 and wherein said plurality of information modules includes a request to be sent by a mobile device to a remote server to download information from said server.

218. A selectable functionality mobile communication system according to claim 195 and wherein said plurality of information modules includes mobile commerce data.

219. A selectable functionality mobile communication system according to claim 195 and wherein said subsystem does not contain a source of electrical power.

220. A selectable functionality mobile communication system according to claim 195 and also including user actuable programming functionality.

221. A selectable functionality mobile communication system according to claim 195 and also including user actuable personalization functionality.

222. A selectable functionality mobile communication system according to claim 195 and wherein said intermediary comprises at least one wireless communications link.

223. A selectable functionality mobile communication system according to claim 195 and wherein said intermediary comprises a plurality of intermediary ports.

224. A selectable functionality mobile communication system according to claim 223 and wherein a first one of said plurality of intermediary ports communicates contact location actuation data and a second one of said plurality of intermediary ports communicates information module data.

225. A selectable functionality mobile communication system according to claim 222 and wherein said at least one wireless link interconnects said intermediary and said set-top box.

226. A selectable functionality mobile communication system according to claim 195 and also including functionality which limits the number of times at least one of a plurality of information modules are accessible in response to user actuation of a corresponding at least one of said plurality of user-actuable contact locations.

227. A selectable functionality mobile communication system according to claim 195 and also including functionality which changes information modules which are accessible in response to user actuation of at least one of said plurality of user-actuable contact locations.

228. A selectable functionality mobile communication system according to claim 195 and also including functionality which changes the content of at least one of said plurality of information modules in response to user actuation of at least one of said plurality of user-actuable contact locations.

229. A communication method comprising:
providing a user-selectable function operative device and a user-interface card comprising:
a plurality of user-actuable contact locations; and
a plurality of information modules;
actuating, by user selection, at least one of said plurality of user-actuable contact locations; and
communicating at least one of said plurality of information modules from said user interface card to said user-selectable function operative device.

230. A communication method according to claim 229 and also comprising communicating information between said user-interface card and said user-selectable function operative device.

231. A communication method according to claim 229 and also comprising downloading information to said user-selectable function operative device.

232. A communication method according to claim 231 and wherein said downloading comprises downloading information from said user-interface card.

233. A communication method according to claim 231 and wherein said downloading comprises downloading information from an external information source.

234. A communication method according to claim 229 and wherein said communicating comprises:
receiving said at least one of said plurality of information modules from said user-interface card; and
transmitting received information modules to said user-selectable function operative device.

235. A communication method according to claim 234 and wherein said communicating also comprises processing at least some of said received information modules.

236. A communication method according to claim 230 and wherein said communicating information comprises:
receiving information from said user-selectable function operative device; and
transmitting received information to said user-interface card.

237. A communication method according to claim 236 and wherein said communicating information also comprises processing at least some of said received information.

238. A communication method according to claim 229 and wherein said communicating comprises:
communicating contact location actuation data; and
communicating information module data.

239. A communication method according to claim 229 and also comprising providing feedback to a user in response to said actuating.

240. A communication method according to claim 239 and wherein said providing feedback includes providing tactile feedback.

241. A communication method according to claim 229 and wherein said communicating comprises communicating via a wireless communications link.

242. A communication method according to claim 229 and also including limiting the number of times at least one of said plurality of information modules are accessible in response to user actuation of a corresponding at least one of said plurality of user-actuable contact locations.

243. A communication method according to claim 229 and also including changing information modules which are accessible in response to said actuating.

244. A communication method according to claim 229 and also including changing the content of at least one of said plurality of information modules in response to said actuating.

245. A communication method according to claim 229 and wherein said communicating also includes communicating to another user-selectable function operating device operating as a back-channel communicator.

246. A selectable functionality mobile communication method comprising:
providing a function selectable mobile device, a function actuation card/mobile device intermediary and a function actuation card containing at least one audio-visual information module, and
communicating information from said at least one audio-visual information module to at least one of said intermediary and said mobile device.

247. A communication method according to claim 246 and also comprising downloading information to said function selectable mobile device.

248. A communication method according to claim 247 and wherein said downloading comprises downloading information from said function actuation card.

249. A communication method according to claim 247 and wherein said downloading comprises downloading information from an external information source.

250. A communication method according to claim 246 and wherein said communicating comprises:
communicating contact location actuation data; and
communicating information module data.

251. A communication method according to claim 246 and wherein said communicating comprises communicating via a wireless communications link.

252. A selectable functionality mobile communication method comprising:
providing a function selectable mobile device, a function actuation card/mobile device intermediary and a function actuation card containing at least one information module;
communicating information from said at least one information module to at least one of said intermediary and said mobile device; and
downloading information from an external source to said at least one of said intermediary and said mobile device, in response to said communicating.

253. A communication method according to claim 252 and also comprising communicating information between said function actuation card and said function selectable mobile device.

254. A communication method according to claim 252 and wherein said downloading comprises downloading information from said function actuation card.

255. A communication method according to claim 252 and said communicating comprises:
communicating contact location actuation data; and
communicating information module data.

256. A communication method according to claim 252 and wherein said communicating comprises communicating via a wireless communications link.

257. A selectable functionality mobile communication method comprising:
providing a television set-top box, a function actuation card/mobile device intermediary and a function actuation card containing at least one information module;
communicating information from said at least one information module to at least one of said intermediary and said set-top box; and
downloading information from an external source to said at least one of said intermediary and said set-top box, in response to said communicating.

258. A communication method according to claim 257 and wherein said communicating comprises:
communicating contact location actuation data; and
communicating information module data.

259. A communication method according to claim 257 and wherein said communicating comprises communicating via a wireless communications link.

260. A communication method according to claim 257 and wherein said communicating also includes communicating to a user-selectable function operating device operating as a back-channel communicator.
